(19) United States
(12) Patent Application Publication
(10) Pub. No.: US 2014/0358680 A1
(43) Pub. Date: Dec. 4, 2014

(54) METHOD AND SYSTEM FOR ADVERTISEMENTS IN RESPONSES

(71) Applicant: CHACHA SEARCH, INC., Carmel, IN (US)

(72) Inventor: Scott A. Jones, Carmel, IN (US)

(73) Assignee: CHACHA SEARCH, INC., Carmel, IN (US)

(21) Appl. No.: 14/295,570

(22) Filed: Jun. 4, 2014

Related U.S. Application Data
(60) Provisional application No. 61/830,728, filed on Jun. 4, 2013.
(60) Provisional application No. 61/833,100, filed on Jun. 10, 2013.
(60) Provisional application No. 61/835,687, filed on Jun. 17, 2013.

(51) Int. Cl. G06Q 30/02

(52) U.S. Cl. CPC G06Q 30/0257; G06Q 30/0254; G06Q 30/0256
USPC 705/14.52; 705/14.55; 705/14.54

(57) ABSTRACT

A system and method for management of advertisements is described. Advertised results may be provided based on a ranking and a matching of an advertisement with a sponsored answer and/or an organic result to a query. An advertisement may be provided using a human assistant.

### BACKGROUND

1. Field of the Invention

The present invention is related to use of advertisements and human assisted search.

2. Description of the Related Art

In systems wherein questions are submitted by users and answered by peers, it is desirable to have rapid and accurate responses. Systems such as Aardvark, Mosio and Yahoo! Answers have attempted to user peer-to-peer answering to meet this need. However, such systems have met with limited success. In particular it is difficult to provide answers in a timely manner and to provide accurate information.

One way to overcome the timing limitation is to incentivize a person tasked to respond to a request. Various types of compensation methods have been implemented by companies such as KGB and ChaCha. By paying workers to respond to questions, timeliness of answers and answer quality may be improved. However such systems have higher cost to answer and thus must be able to obtain higher compensation per query than a peer-to-peer system.

As described in the related U.S. application Ser. No. 13/612,377, filed Sep. 12, 2012 entitled METHOD AND SYSTEM OF MANAGEMENT OF SEARCH RESULTS, inventor Eugene M. O'Donnell, a provider of goods and/or services or “vendor” may provide information resources, and/or human assistants which may be used to respond to a user request. However, such a system may have some limitations as well. In particular, a sponsor may wish to provide additional information regarding itself when a result sponsored by a vendor is provided.

For these and other reasons, a method and system for providing variable advertising content in responses would be greatly appreciated.

### SUMMARY

A system is implemented whereby a responder may receive a query from a user. If a responder elects to respond to the query, a response of the responder may include a message determined by the responder. A message determined by the responder may be a general or specific advertising message. If a response is associated with a responder and the responder or answerer is associated with a vendor, a message selected by the vendor may be provided regardless of content of a user request. Likewise, a message delivered with a response may be targeted by a vendor in various ways. For example, if a national brand responded to a request, a locally targeted message such as a coupon, etc. might be delivered based on geographic information associated with a query. So long as an answer is provided by a vendor, the vendor may be permitted to deliver any suitable message and may be able to select appropriate targeting criteria for a message.

A system is provided whereby users may submit a request. A request may be submitted using any suitable device such as a desktop or laptop computer, wireless phone or tablet device, etc. A request may be received by a server, which may store information of a request. A response may be provided by the server in various ways. Information of a request may be directed to a responder or answerer. A responder may be a person and/or an entity such as a business or organization. If a responder provides an answer to a request, a message may be included with an answer. A message of a responder may be provided in addition to a response. A message of a responder may be provided when a stored response associated with a responder is returned as an answer to a request.

A responder may determine a type of response which is provided with an answer. A responder may provide a number of messages or promotional messages or advertisements. A responder may be able to determine targeting information of a message provided with a response. For example, a responder may be able to schedule a message to be provided during a particular time interval, to a predetermined location, to users within a demographic, to a number of requesters, a maximum number of times to a particular user or group of users, based on a subject matter of a response, etc.

A responder may provide a resource which produces a response. For example, a responder may provide a resource which receives a query and provides a potential answer based on the query. If an answerer selects a potential answer, a responder may be able to provide a message with the answer. Should the potential answer be reused, the responder or sponsor may be able to provide a message with the answer. In at least one embodiment, a responder may not provide a message indicated in an answer, but may receive a message from an advertiser and/or sponsor, who may bid based on factors such as reputation of the responder, subject matter of answers provided by the responder, etc. In this way, a responder may act as an agent for advertisers.

Additional aspects and/or advantages will be set forth in part in the description which follows and, in part, will be apparent from the description or may be learned by practice of the invention. These together with other aspects and advantages, which will be subsequently apparent, reside in the details of construction and operation as more fully hereinafter described, reference being had to the accompanying drawings forming a part hereof, wherein like numerals refer to like parts throughout.

### BRIEF DESCRIPTION OF THE DRAWINGS

Aspects and advantages of the disclosure will become apparent and more readily appreciated from the following description of the embodiments, taken in conjunction with the accompanying drawings, of which:

FIG. 1 is a block diagram of an exemplary system embodiment.

FIG. 2 illustrates a database for requests.

FIG. 3 illustrates a database for users.

FIG. 4 illustrates a database for responders.

FIG. 5 illustrates a database for resources.

FIG. 6 illustrates a database for responder messages.

FIG. 7 is a flowchart of processing a query.

FIG. 8 is a flowchart of selecting an advertisement based on a responder.

FIG. 9 is a Graphical User Interface (GUI) for query entry and response reception

FIG. 10 is a GUI for responding to a request

FIG. 11 is a GUI for a responder to select query targeting information.

FIG. 12 is a GUI for advertisers to bid on placements based on responders.

FIG. 13 is a block diagram of an exemplary system embodiment.

FIG. 14 illustrates a database for requests.

FIG. 15 illustrates a database for users.

FIG. 16 illustrates a database for responders.

FIG. 17 illustrates a database for resources.

FIG. 18 illustrates a database for advertisements.

FIG. 19 illustrates a database for advertisers.

FIG. 20 is a flowchart of processing a query.

FIG. 21 is a flowchart of selecting an advertisement based on a responder.

FIG. 22 is a GUI for query entry and response reception.

FIG. 23 is a GUI for query reception and response entry.

FIG. 24 is a GUI for a responder to select targeting information.

FIG. 25 is a GUI for a responder to determine blocking criteria.

FIG. 26 is a GUI for an advertiser to determine targeting of advertisements.

FIG. 27 is a GUI for advertisers to determine blocking criteria.

FIG. 28 is a block diagram of an exemplary system embodiment.

FIG. 29 illustrates a database for requests.

FIG. 30 illustrates a database for users.

FIG. 31 illustrates a database for responders.

FIG. 32 illustrates a database for resources.

FIG. 33 illustrates a database for responder groups.

FIG. 34 is a flowchart of processing a query.

FIG. 35 is a flowchart of determining attribution of a response.

FIG. 36 is a GUI for query entry and response reception.

FIG. 37 is a GUI for query entry and response reception.

FIG. 38 is a GUI for responding to a request.

FIG. 39 is a GUI for responding to a request.

FIG. 40 is a GUI for managing topics of a group.

FIG. 41 is a GUI for managing members of a group

FIG. 42 is a GUI for managing resources of a group.

FIG. 43 is a GUI for managing queries.

FIG. 44 is a GUI for managing a profile.

### DETAILED DESCRIPTION OF THE PREFERRED EMBODIMENTS

Reference will now be made in detail to the present embodiments discussed herein. Examples are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein, words importing the singular shall include the plural and vice versa unless specifically counter indicated.

A system is provided which includes a user system for submitting a query and receiving a response, a search server receiving the query, a database storing information of queries, search results, searchers, users, resources and other information, a responder system receiving a query and providing a response, and an advertiser system providing sponsored content.

A system is implemented to allow a user to submit a query and receive a response. A response may include any type of media such as text, URL's, audio, video, etc. A response may be produced automatically and/or using the assistance of a person. A query may be submitted using any suitable device and/or communication service such as SMS, MMS, voice, Instant Messaging, VoIP, internet packet communication, email, etc.

Processing of a query may be divided into various layers. A first layer may consist of automated processing of a query. Automated processing of a query may include comparison of a query to a database, analysis of a query using semantic techniques, pattern matching, etc. which may be used to determine a response to the query. Results of automated processing such as categorization, spelling correction, named entity extraction, location association, etc. may be stored for later use.

A second layer of processing of a query may include a human assistant who analyzes the query or “expediter”. An expediter uses the human ability to recognize context in order to determine a response to a query. An expediter may be provided with relevant context of a query, and offered various options for responding to the query. In its simplest form, an expediter might be presented with a question and two or more options for responding to the question. An expediter may be provided with a rich toolset which provides a greater depth and breadth of responses which may be interactive. In at least one embodiment, an expediter may be provided with responses from a predetermined set of resources.

A third layer of processing of a query may include a human assistant who responds to the query or “searcher”. A searcher may receive an interpreted query, information of a source of the query, and be provided with resources for performing a search responsive to a query. A searcher may formulate a response based on an interpreted query, and submit the response for delivery to a user responsive to the query. In at least one embodiment, a searcher may receive information of resources which may be used to provide a response, and/or resources which are excluded from providing a response. A user may elect to respond to requests and may be referred to as a “responder”. A responder may perform tasks such as expediter, searcher, transcriber, and/or other roles which might be assigned to a human assistant or guide. A responder may be associated with various items which may be used to determine whether a request, query, task, etc., will be routed to a responder.

A resource may be characterized according to various parameters. A resource may be evaluated based on a number of responses obtained from and/or using the resource. A resource may be evaluated based on a number of times that a response obtained from the resource is reused. A resource may be evaluated based on an affiliate relationship between a provider of the resource and a provider of search services.

As used herein, a “request” means a request for information, products, and/or services. A request or search request or query may include various types of media, and may be provided by any user system which may establish communication with a server and/or other devices associated with a search service. A request may be referred to as a “search request”, “search query”, or “query”.

A “user” is a person who submits a request and may receive any type of information responsive to a request. A user may be any person or entity. A “guide” is a person who assists in processing a request. A guide may be referred to as a “provider”, “searcher”, “human searcher”, “expediter”, “transcriber”, “specialist” or “generalist”. Guides may be assigned various roles. A guide who transcribes a user request from one form to another may be referred to as a transcriber. A guide who reviews a query, determines a most likely response, and may modify a query may be referred to as an expediter or “ambassador”. A guide who performs a search for queries associated with a specific category may be referred to as a specialist. A guide who performs a search for queries regardless of category may be referred to as a generalist. Any guide may perform any role.

An “advertiser” is any person and/or entity which may provide promotional information or “advertisements” to be delivered to a user. An advertisement may take various forms and/or may include media of any sort which can be delivered to a user device. A “result”, “response”, “answer”, or “search result” is any information which has been determined to be a response to a request. A result may include an advertisement. A result may be any information which is provided as a response to a request. A “resource” or “search resource” may be any source of information which may provide a search result and/or other information. A resource may include a search engine, a web server, a software application, an API, printed media, an RSS feed, streaming media, a web page, a database, etc. A “profile” may be any information associated with a person such as demographic data, geographic data, personality data, affiliations, etc. A result may be an “organic” result which is produced by a search which has no intentional bias applied. A result may be a “sponsored” result which is provided and/or approved by a provider with a commercial interest in the response and/or providing the response to a user based on a request for information associated with the sponsored answer or sponsored result.

If a responder responds to a request a responder may provide an advertisement with a response. If a stored answer of a responder is provided a responder may determine an advertisement provided when an answer is presented. If an answer is obtained using a resource provided by a responder, an answer may be accompanied by an advertisement determined by a responder. An advertiser may be able to select targeting information and to bid on targeting of advertisements based on factors such as a number of responders associated with targeting information, a number of queries, etc. A responder may be able to select targeting information for receipt of queries based on information of a number of queries, a number of responders, a bid associated with targeting information, etc.

The terms voice and speech are used interchangeably herein. A user, a guide, a responder and/or a search system may establish a communication session using a voice service, a messaging service such as Short Messaging Service (SMS), Enhanced Messaging Service (EMS), Multi-media Messaging Service (MMS), Instant Messaging (IM), email, an internet portal or web page, an application, regular mail and/or any other suitable type of communication. A connection or communication session may be established using any device which is capable of utilizing a communication service. For example, a wireless device such as a cell phone, PDA, smart phone, etc., might be used to establish a communication session using voice, SMS, IM, email and/or internet protocols. A desktop, laptop or server system might be used to establish a communication session using IM, email, SMS, MMS, etc. A landline phone, a specialized communication terminal, and/or any other communication device might be used to establish a communication session.

Communication between a user, a guide and/or a search system may include conversion of text to speech and speech to text. Any type of media which can be sent and/or received using a communication system may be part of a communication session. A communication session may be conducted using any or all communication services associated with a user, a guide, and/or a search system. Any communication session may include communication via multiple services and/or devices. For example, a request may be submitted as a voice query, which might indicate an image located on a resource accessible to a user. A voice query might be converted to a text message, the image might be processed in order to associate a tag and/or other images with the image, and a response might be provided as a spoken reply to a mobile phone associated with a user, and a video presentation which is accessible via a high-speed connection that might be delivered to a browser functionality of a different user device.

An advertisement may be transmitted, including during any or all communication sessions. A guide, a user, a search result, a resource, a responder, an advertiser and/or a request may be rated. Rating information may be obtained from a user, a guide, an advertiser and/or an administrator of a search system. Rating information may be used to select a user, a guide, a request, a result, a responder, an advertiser, and/or any item based on information associated with an item indicated in a database. A search service may be compensated by advertising revenue. Advertising and/or content may be delivered to a user and/or a guide using any communication service associated with a user and/or a guide. An advertiser may request and obtain information regarding usage, users, demographics, affiliations, etc. associated with queries, keywords, categories, resources etc. and may submit sponsored answers and associate sponsored answers with queries based on information provided.

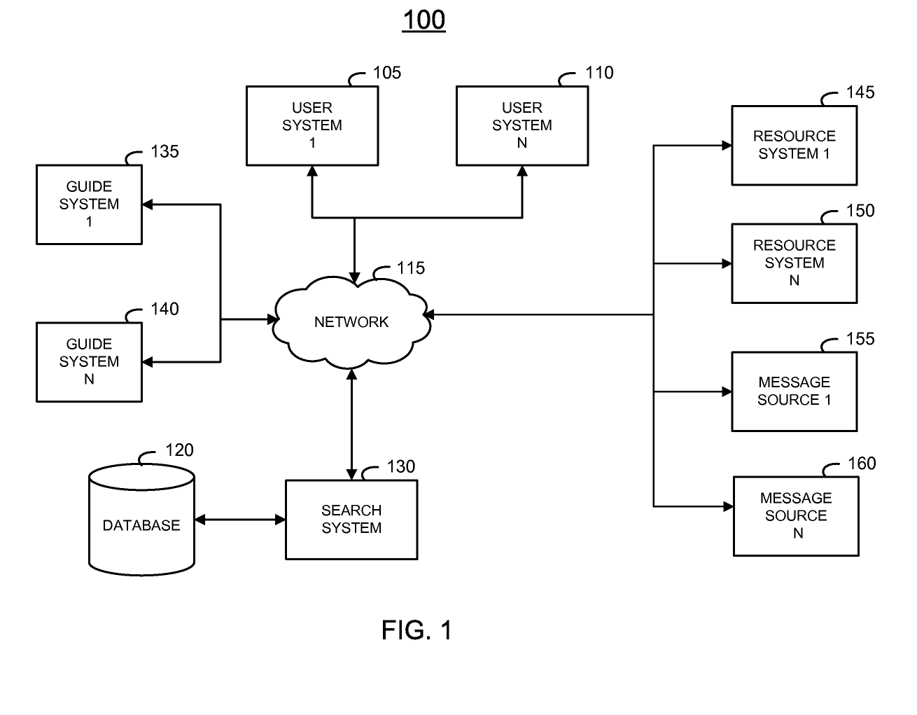

As illustrated in FIG. 1, system 100 includes user systems 105, 110, a network 115 such as the Internet, a search system 130, a database 120, which may comprise various records, guide systems 135, 140, resource systems 145, 150, and message systems 155, 160.

While only a few systems associated with a user, a resource, a message and a guide are depicted in FIG. 1 it is within the scope of the disclosure for multiple systems for a user, resource, message and guide to be utilized. In particular it is envisioned that many user, resource, message and guide systems may be implemented. The search system 130 may be composed of many components as described further herein.

Any user system (e.g. the user system 105) can be used, to submit a request to the search system 130 and/or receive a result and/or other information. Any user system may receive a response, and/or may provide compensation to the search system 130.

The network 115 may be a global public network of networks (i.e., the Internet) and/or may consist in whole or in part of one or more private networks and communicatively couples the user systems 105, 110, the guide systems 135, 140, the resource systems 145, 150 and the message sources 155, 160 with the other components of the system such as the search system 130, and the database 120. The network 115 may include one or more wireless networks which may enable wireless communication between the various elements of the system 100. For example, the search system 130 may receive messages which may be routed via a wireless network controlled by a wireless service to the user systems 105, 110. A wireless service may receive messages from the guide systems 135, 140 via a wireless network which is a part of the network 115, and provide the messages to the search system 130 via an internet connection which is part of the network 115. Similarly a voice communication via wired and/or wireless communication might be established between any elements of the system 100.

The search system 130 allows interaction to occur among the user systems 105, 110, the guide systems 135, 140, the resource systems 145, 150 and the message source 155, 160. For example, a request can be transmitted from the user system 105 to the search system 130, which may provide information obtained from the database 120, which may include an advertisement provided by the message source 155 to the user system 105. Similarly, a search result from a searcher operating the guide system 135 and/or the resource system 145 might be routed to the search system 130, which might process the search result, formulate a response and provide a message to the user system 105. Any type of communication between users, resources, responders, advertisers, sponsors and/or guides may be mediated and/or facilitated by the search system 130, and/or other elements of the system 100.

The search system 130 is communicatively coupled with the database 120. As will be described herein in further detail below, the database 120 includes data that is processed in association with operation of the embodiments. Although FIG. 1 illustrates the database 120 as a separate component of the system, the database 120 may be integrated with the search system 130. Further, the records maintained in the database 120 may be stored in any typical manner, including in a Network Attached Storage (NAS), a Storage Area Network (SAN), RAID, etc., using any typical or proprietary database software such as DB2®, Informix®, Microsoft® SQLServer™, MySQL®, Oracle®, etc., and may also be a distributed database on more than one server. Elements of the database 120 may reside in any suitable elements of the system 100. Any or all elements of the system 100 may include any or the entirety of the database 120.

The user systems 105, 110, the guide systems 135, 140, the resource systems 145, 150, the message sources 155, 160 and the search system 130 may include equipment, software, systems and personnel required to send and/or receive messages between a user system 105, 110, the guide systems 135, 140, the resource systems 145, 150 the message sources 155, 160 and/or the search system 130 using the network 115. The database 120 includes information which may allow the search system 130 to establish communication between any or all of the elements of the system 100.

A user system, a guide system, a resource system, a message system and/or a search system may be a desktop, portable, or tablet PC or Mac®, a mobile phone, a smart phone, a PDA, a server system, a landline phone, a specialized communication terminal, a terminal connected to a mainframe, or any other communication hardware and/or system. The search system 130 may include one or more servers, computers, etc. For example, servers such as the PowerEdge® 2900 by Dell, or the BladeCenterJS22 by IBM, or equivalent systems might be used to implement elements of the search system 130. The search system 130 may utilize an operating system (OS) such as Microsoft Windows XP, or Linux, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, guide systems, message systems and/or to implement the search system 130.

A user may be identified by the search system 130. When a user system, such as the user system 105, establishes a communication session with the search system 130, an identifier of a user system is determined. An identifier of a user system may be associated with other information regarding a user. A user system may be identified using an email address, a telephone number, an IM credential, a username, and/or any other identifier which may be used to associate information with a user. Multiple identifiers of a user may be associated with each other. Using information of communication services associated with a user, a communication session may be established between a user system such as the user system 105 and a resource system, a guide system, a sponsor system and/or the search system 130. Information such as a keyword, a category, a user profile, a request, a result, etc., may be associated with a user. A user may be required to provide profile information to the search system 130. A user may elect to receive requests from the search system 130. Parameters and/or attributes may be associated with a resource as will be further described herein below. Information of a user may be stored in the database 120. A user may be required to register in order to act as a responder. Any type of information associated with a guide may also be associated with a user or responder.

A guide may be required to register with the search system 130. As part of a registration process, at least one communication method is associated with a guide. In at least one embodiment, a guide may register with the search system 130 and establish a username and password which are associated with the guide. A guide may login to the search system 130 using a web browser functionality of the guide system 135 in order to communicate with the search system 130. Multiple communication services may be associated with a guide and may allow a communication session to be established between a guide system such as the guide system 135 and a user system, a resource system, a sponsor system, and/or the search system 130. Multiple identifiers of a guide may be associated with each other. Information such as IM credentials, an email address, a phone number, a URL, a username, etc., of a guide may be identified which may allow the search system 130 to establish a communication session between a guide system and a user system, a resource system, a sponsor system and/or the search system 130.

When a guide registers with the search system 130 the guide may be associated with one or more keywords, categories, profiles, and/or other information. Information associated with a guide may be stored in the database 120 and may be used for various purposes. Information associated with a guide may be used to rank requests, resources, results, advertisements, sponsors and/or other information which may be presented to the guide. In at least one embodiment, payment information is associated with a guide. In at least one embodiment, a guide may be required to undergo testing to determine whether a guide is able to perform any tasks which may be required by the search system 130. For example, a guide may be assigned to a role such as translator, transcriber, expediter, generalist, specialist, auditor, etc. A guide may be registered by a sponsor. A sponsor may provide compensation to a sponsored guide or responder.

A sponsor or provider of messages or advertiser may be required to register with the search system 130. As part of a registration process, at least one communication method is associated with a sponsor. In at least one embodiment, a sponsor may register with the search system 130 and establish a username and password which are associated with the sponsor. A sponsor may login to the search system 130 using a web browser functionality of the message source 155 in order to communicate with the search system 130. Multiple communication services may be associated with a sponsor and may allow a communication session to be established between a sponsor system such as the message source 155 and a user system, a resource system, a guide system, and/or the search system 130. Multiple identifiers of a sponsor may be associated with each other. Information such as IM credentials, an email address, a phone number, a URL, a username, etc., of a sponsor may be identified which may allow the search system 130 to establish a communication session between a sponsor system and a user system, a guide system, a resource system and/or the search system 130.

When a sponsor registers with the search system 130 the sponsor may be associated with one or more keywords, categories, profiles, and/or other information. Information associated with a sponsor may be stored in the database 120 and may be used for various purposes. Information associated with a sponsor may be used to rank requests, resources, results, advertisements, guides and/or other information which may be presented to the sponsor. In at least one embodiment, payment information is associated with a sponsor. A sponsor may provide payment information which may be used to compensate the search system 130 for advertisements and/or sponsored answers provided to a user. A sponsor may designate a guide or responder associated with a sponsor, and may provide registration information associated with the sponsored guide. A sponsor may provide information associated with a resource. A sponsor may designate conditions for accessing a resource provided by the sponsor.

Records may be maintained in the database 120 which may be used to record the status of various items. Such records may be used to aid the processing of requests and production of responses or answers. For example, a user may submit a request, which may describe a desired response, and provide access to information and/or materials needed to produce the response. Information indicated in a record may be combined with information in other records, and may be used to produce tables, as further described herein.

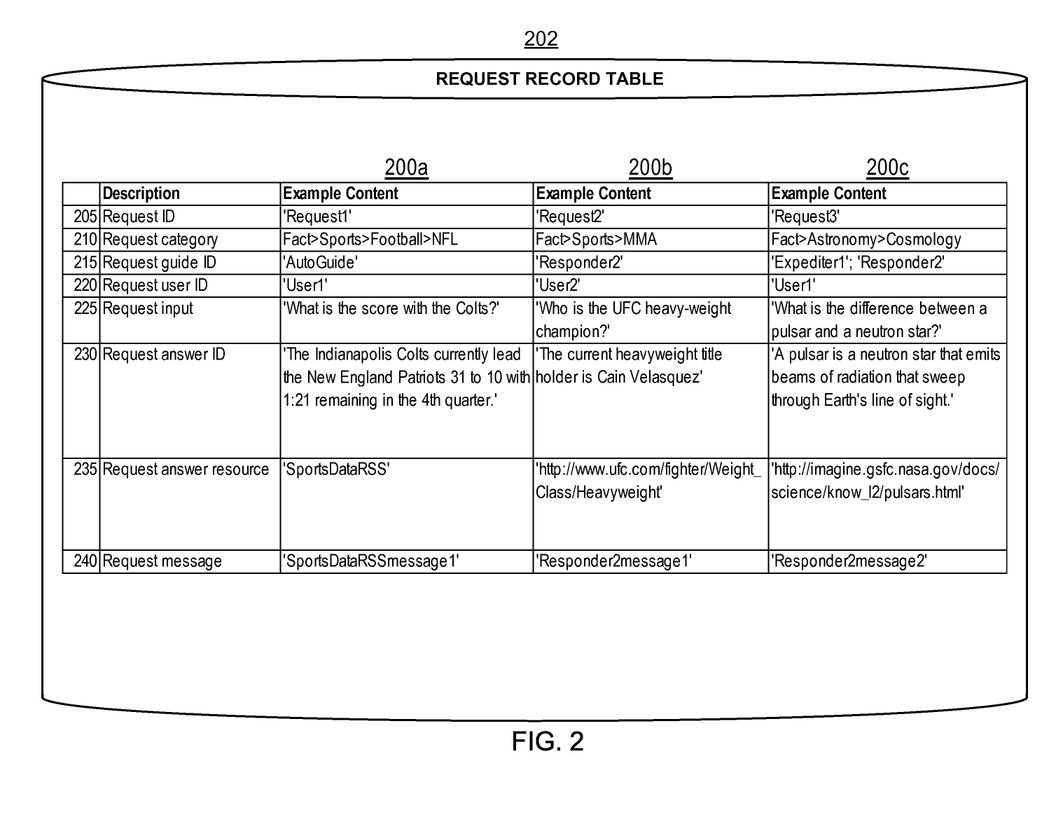

As illustrated in FIG. 2 an exemplary request record table 202 which may comprise a number of request records is provided. One or more request records may be associated with or resident in the database 120 (FIG. 1). The request record table 202 may include information of requests which may be processed. Request records 200a-c may include a request ID field 205, a request category field 210, a request guide ID field 215, a request user ID field 220, a request input field 225, a request answer ID field 230, a request answer resource field 235, and a request message field 240.

The request ID field 205 includes an identifier of a request which is preferably unique and is preferably used consistently. A request ID serves to distinguish a request record associated with a request from a request record associated with other requests. Any number of characters, numbers, and/or other indicators may be used to indicate a request ID. In at least one embodiment, a request ID associated with a request is included in the request ID field 205. In at least one embodiment, a random number is indicated in the request ID field 205. Using the example in FIG. 2, ‘Request1’ is the request ID associated with the request record 200a.

The request category field 210 may include information of a category associated with a request. Information indicated in the request category field 210 may be used to select an item associated with a request. For example, a category associated with a request may be used to rank guides who may be associated with a type of request. Likewise, a category associated with a request may be used to rank requests which may be presented to a guide. A category associated with a request may be determined based on factors such as keywords of a query, a profile of a user, a selection of a guide, a user history, etc. A category associated with a system taxonomy may be indicated in the request category field 210. A category may be associated with a request automatically and/or using the assistance of a person. Using the example in Fig. example in FIG. 2, ‘Request2’ may be categorized as ‘Fact>Sports>MMA’ as indicated in the request record 200b. This may indicate that a person or item associated with the category ‘Fact>Sports>MMA’ may have a higher ranking for responding to ‘Request2’. A category of a request may be associated with a user submitting the request. Content of a request such as a keyword, named entity, etc. may be used to assign a category, topic, tag, or type to a request.

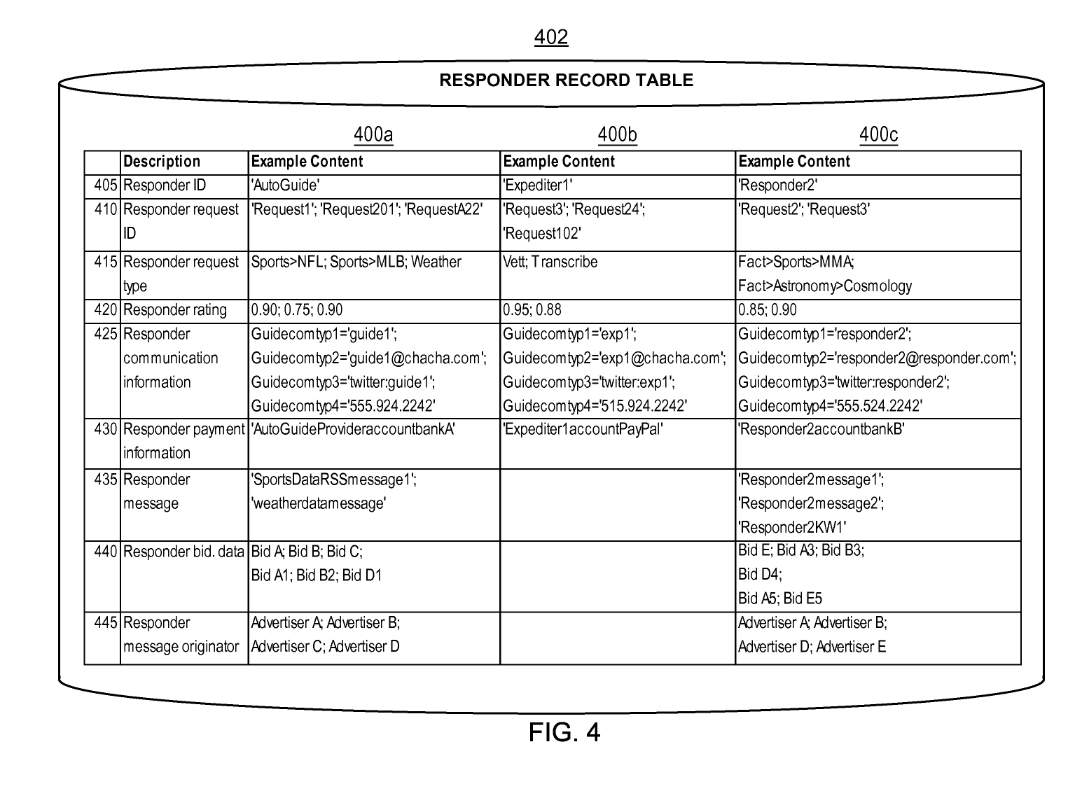

The request guide ID field 215 may include information of a number of guides associated with a request. Content of the request guide ID field 215 may be used to obtain information of a responder using a record such as those depicted in FIG. 4. If a person is selected for a request, elects to receive a request, provides a response to a request, reviews a result of a request and/or completes a request, an identifier of the person may be indicated in the request guide ID field 215. Using the example in FIG. 2, ‘Expediter1’ and ‘Responder2’ are associated with ‘Request3’. This may for example indicate that ‘Request3’ has been processed by ‘Expediter1’ and completed by ‘Responder2’.

The request user ID field 220 may include information of a number of users associated with a request. Content of the request user ID field 220 may be used to obtain information of a user associated with a request. For example, if a request is submitted by a user, an identifier of the user may be indicated in the request user ID field 220. A request may not be associated with a user request. For example, the search system 130 (FIG. 1) may provide requests to persons which are not directly related to a user request. The search system 130 may provide a request to a searcher based on a selection of the request by a sponsor. Using the example in FIG. 2, ‘Used’ is associated with ‘Request1’ and ‘Request3’ and ‘User2’ is associated with ‘Request2’. This may indicate that ‘Request1’ and ‘Request3’ were submitted by ‘User1’ while ‘Request2’ was submitted by ‘User2’.

The request input field 225 may include information of a request. Content of the request input field 225 may be provided to a person who accepts a request. Content of the request input field 225 may include any type of information. For example, a pointer to audio, video, text, and/or other media may be indicated in the request input field 225. As illustrated in FIG. 2, the query ‘Who is the UFC heavy-weight champion?’ is the request input associated with ‘Request2’, as indicated in the request record 200b. In at least one embodiment, the request input field 225 may indicate an original user request, a categorization, and a rewritten user request.

The request answer ID field 230 may include information of a response associated with a request. Content of the request answer ID field 230 may be provided responsive to a request. Content of the request answer ID field 230 may be stored in the database 120 (FIG. 1). Content of the request answer ID field 230 may be reviewed and/or rated by a user, a guide, and/or an administrator. As illustrated in FIG. 2, the response ‘A pulsar is a neutron star that emits beams of radiation that sweep through Earth's line of sight.’ is associated with ‘Request3’ as illustrated in the request record 200c. While a text response to a query is used for the purposes of illustration, any type of media may be indicated in the request answer ID field 230. In at least one embodiment, a text response and a URL associated with a source of the text response may be indicated in the request answer ID field 230.

The request answer resource field 235 may include information of a resource associated with a request. Content of the request answer resource field 235 may be used for various purposes. For example, as illustrated in FIG. 2, the resource <<‘http://imagine.gsfc.nasa.gov/docs/science/know_{—}|2/pulsars.html’>> is associated with ‘Request3’. A resource may be ranked higher for a category if a resource appears in the request answer resource field 235 of a request associated with a category. A resource may be analyzed to determine potential answers for a query associated with a named entity, category, topic, etc., if a resource appears in the request answer resource field of a request associated with a topic, category, named entity, profile, etc.

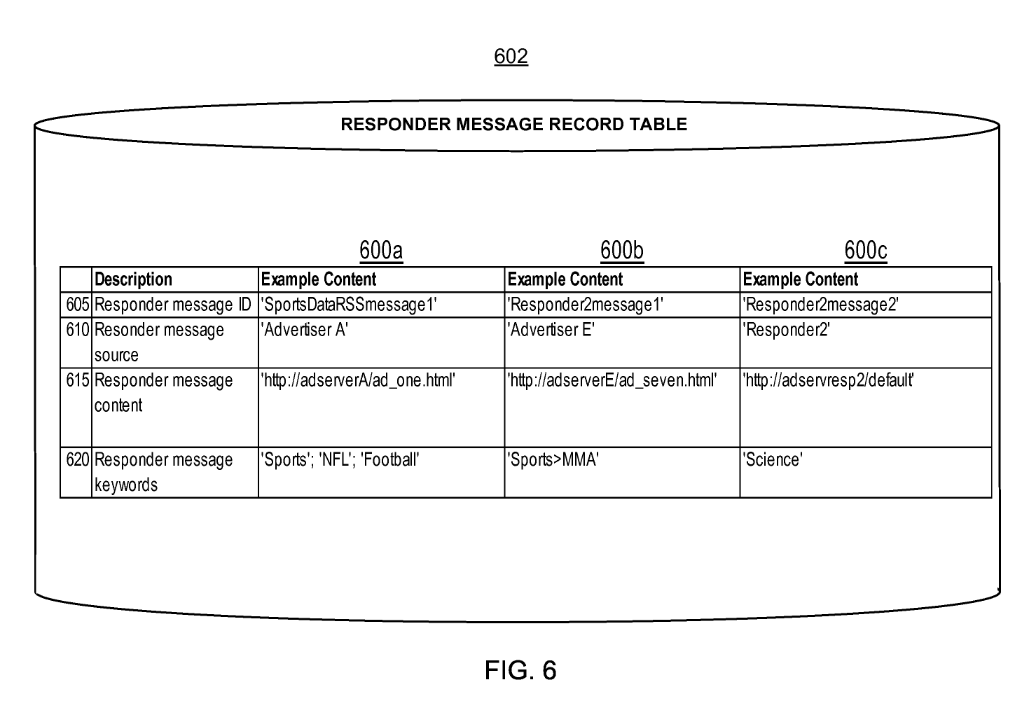

The request message field 240 may include information of a message associated with a request. For example the message ‘SportsDataRSSmessage1’ is indicated in the request message field 240 of the request record 200a. This may indicate that ‘SportsDataRSSmessage1’ was provided responsive to ‘Request1’. A message indicated in the request message field 240 may include a pointer to a record such as a message record as illustrated in FIG. 6. A responder may control content of the request message field 240 based on a response provided. As illustrated in FIG. 2, the message ‘SportsDataRSSmessage1’ may be controlled by a provider of ‘SportsDataRSS’. As indicated in the request answer resource field 235 ‘SportsDataRSS’ may have provided an answer indicated in the request answer ID field 230 of the request record 200a.

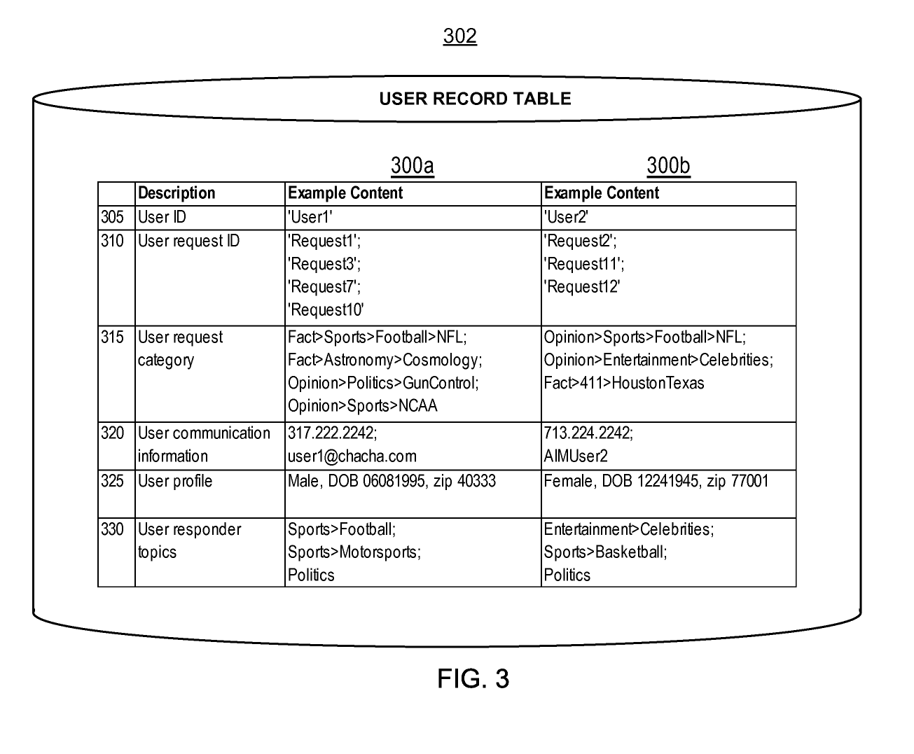

As illustrated in FIG. 3 an exemplary user record table 302, which may comprise a number of user records is provided. One or more user records may be associated with or resident in the database 120 (FIG. 1). The user record table 302 may include information of users. User records 300 may include a user ID field 305, a user request ID field 310, a user request category field 315, a user communication information field 320, a user profile field 325, and a user responder topics field 330.

The user ID field 305 includes an identifier of a user which is preferably unique and is preferably used consistently. A user ID serves to distinguish a user record associated with a user from a user record associated with other users. Any number of characters, numbers, and/or other indicators may be used to indicate a user ID. In at least one embodiment, a random number is indicated in the user ID field 305. Using the example in FIG. 3, ‘User1’ is the user ID associated with the user record 300a.

The user request ID field 310 may include information of a number of requests associated with a user. A user request ID may be for example a pointer to a request record associated with a request submitted by a user. If a user submits a request, a request ID may be added to the user request ID field 310. Using the example illustrated in FIG. 3, ‘Request2’, ‘Request11’ and ‘Request12’ are associated with ‘User2’ as indicated in the user record 300b. This may indicate that ‘User2’ has submitted ‘Request2’, ‘Request11’ and ‘Request12’.

The user request category field 315 may include information regarding a category or type associated with a user request. For example, if a request is directed to a type of processing or a category, etc. a type and/or category associated with the processing may be indicated in the user request category field 315. In at least one embodiment, the user request ID field 310 and the user request category field 315 are linked by for example a pointer. In at least one embodiment, a category associated with a request of a user may affect whether a requester message will be provided. An affiliation of a user may affect a category associated with a request of a user. For example, if a user is a member of a group affiliated with a primary school, a requester message associated with a query may be modified to be appropriate to that membership.

The user communication information field 320 may include information of a number of communication services associated with a user. Any information which may be used to establish communication with a user may be indicated in the user communication information field 320. For example, a telephone number, an email address, an IM credential, a URL, a username, a password, and/or other communication information may be indicated in the user communication information field 320. Using the example in FIG. 3, the phone number ‘317.222.2242’ and the email ‘user1@chacha.com’ are associated with ‘User1’.

The user profile field 325 may include information of a profile associated with a user. For example, demographic, geographic, affiliation, personality, and/or other types of anthropic and/or other characteristic information may be associated with a user. A user may provide profile information as part of a registration process. User profile information may be obtained from a database provided by a third party. User profile information may be determined based on test, polling, query history, peer review, and/or other information associated with a user. Using the example illustrated in FIG. 3, ‘Female, DOB 12241945, zip 77001’ are associated with ‘User2’. Profile information may be used to match information provided by a user to other information. For example, a ranking of a guide for a query of a user may be adjusted based on a profile associated with the user. A responder message might be modified and/or targeted based on geographic, demographic, etc. profile information of a user.

The user responder topics field 330 may include information of targeting data which may be used to direct a query. A user may select topics which a user may be interested in responding to. A user may select a topic which a user may be more likely to respond to because it may be a topic of interest to a user. For example, ‘User1’ may be interested in the topics ‘Sports>Football’, ‘Sports>Motorsports’ and ‘Politics’ as indicated in user record 300a. A user may select responder topics and/or targeting information based on a number of requests expected for a topic and/or target data.

As illustrated in FIG. 4 an exemplary responder record table 402 which may comprise a number of responder records is provided. One or more responder records may be associated with or resident in the database 120 (FIG. 1). The responder record table 402 (FIG. 4) may include information of responders. Responder records 400 may include a responder ID field 405, a responder request ID field 410, a responder request type field 415, a responder rating field 420, a responder communication information field 425, a responder payment information field 430, a responder message field 435, a responder bid data field 440, and a responder message originator field 445.

The responder ID field 405 includes an identifier of a responder which is preferably unique and is preferably used consistently. A responder ID serves to distinguish a responder record associated with a responder from a responder record associated with other responders. Any number of characters, numbers, and/or other indicators may be used to indicate a responder ID. In at least one embodiment, a random number is indicated in the responder ID field 405. In at least one embodiment, a pseudonym selected by a responder may be indicated in the responder ID field 405. A user ID may be indicated in the responder ID field 405. An identifier of a provider of a resource may be indicated in the responder ID field 405. Using the example in FIG. 4, “AutoGuide” is the responder ID associated with the responder record 400a. This may indicate that ‘AutoGuide’ is a provider of an automated answer source such as ‘SportsDataRSS’ and/or other automated and/or human assisted resources.

The responder request ID field 410 may include information of a number of requests associated with a responder. Content of the responder request ID field 410 may be used to obtain information of a request. For example, if a user request has been determined to require a number of requests to be performed, the search system 130 (FIG. 1) may assign a unique ID to the requests and may distribute information of the requests to responders. Using the example in FIG. 4, ‘Request3’, ‘Request24’ and ‘Request102’ are associated with ‘Expediter1’ as indicated in the responder record 400b. This may indicate that ‘Expediter1’ has expedited or handled ‘Request3’, ‘Request24’ and ‘Request102’.

The responder request type field 415 may include information of a number of types of requests which may be processed by a responder. For example, a category and/or keyword associated with a request, a type of request, temporal information associated with a request, etc., which may be used to determine if a responder is to be presented with and/or notified of a request may be indicated in the responder request type field 415. In at least one embodiment, a responder may be assigned to a particular type of request as part of a registration process. A responder may select a type of request which a responder may perform. A responder may be required to pass a test in order to be associated with a type of request. A responder may be assigned to a role such as expediter, searcher, etc., which may be indicated in the responder request type field 415. A request indicating a keyword may be directed to a guide or responder. Using the example in FIG. 4, ‘Responder2’ is associated with the categories ‘Fact>Astronomy>Cosmology’ and ‘Fact>Sports>MMA’. This may for example indicate that ‘Responder2’ may be presented with and/or selected to respond to requests indicating those types or categories.

The responder rating field 420 may include information of a number of ratings associated with a responder. For example, quality, speed, peer review, etc., may be used to determine a rating of a responder. A rating of a responder may be used for purposes such as determining compensation for the responder, selecting a responder to respond to a request, matching a request to a responder, etc. In at least one embodiment, the responder request type field 415 and the responder rating field 420 may be linked by, for example, a pointer. Using the example in FIG. 4, ‘Expediter1’ has a rating of ‘0.95’ associated with ‘Vett’, and a rating of ‘0.88’ associated with ‘Transcribe’ which may be used to rank ‘Expedited’ versus other responders associated with the request types ‘Vett’ and ‘Transcribe’.

The responder communication information field 425 may include information of a number of communication services associated with a responder. For example, a user name and password, an email address, an IM credential, a phone number, a web page, a physical address, etc., may be indicated in the responder communication information field 425. Using the example illustrated in FIG. 4, ‘AutoGuide’ is associated with the login ID ‘guide1’, the email ‘guide1@chacha.com’, the Twitter account ‘twitter.guide1’, and the phone number ‘555.924.2242’. This may indicated that a provider of ‘AutoGuide’ may be contacted using the associated communication services.

The responder payment information field 430 may include information of a payment method associated with a responder. For example, banking information, a PayPal® account, a Western Union® account, etc., may be indicated in the responder payment information field 430. Content of the responder payment information field 430 may be used to provide compensation to a responder. If an advertiser elects to pay a responder for an advertisement message delivered with a response of a responder, payment may be made using information indicated in the responder payment information field 430. A responder may be compensated for an answer provided by a responder and/or a message provided based on a response or answer associated with a responder. For example, payment may be made by Automated Clearing House (ACH), wire transfer, etc., using information indicated in the responder payment information field 430. As illustrated in FIG. 4, the responder ‘Responder2’ is associated with ‘Responder2accountbankB’.

The responder message field 435 may include information of a number of messages of a responder. Information indicated in the responder message field 435 may be used to associate a message with a response and/or a type of response. The responder request type field 415 and the responder message field 435 may be linked by, for example, a pointer. For example, ‘AutoGuide’ is associated with the responder messages ‘SportsDataRSS message1’; and ‘weatherdatamessage’ as indicated in responder record 400a. This may indicate that the message ‘SportsDataRSSmessage1’ should be delivered responsive to a request associated with ‘Sports>NFL’ or ‘Sports>MLB’ which is answered by ‘AutoGuide’ and the message ‘weatherdatamessage’ should be delivered responsive to a request associated with ‘Weather’ which is answered by ‘AutoGuide’.

The responder bid data field 440 may include information concerning a number of bids associated with a responder. A bid may be used by an advertiser to obtain a right to control a message provided when a responder provides an answer. An advertiser may bid to provide a message including an advertisement to a recipient of an answer of a responder. An advertiser might bid for all answers by a particular responder, for a category associated with a responder, for a profile which may match a responder, etc. and/or a combination of criteria associated with a responder. An advertiser may compete with other advertisers based on bidding. For example, ‘Bid E’, ‘Bid A3’ and ‘Bid B3’ are associated with ‘Responder2message1’ as indicated in responder record 400c. This may indicate bids from advertisers for the right to provide an advertisement or message when a response of ‘Responder2’ is provided for a query associated with ‘Fact>Sports>MMA’. The responder message field 435 and the responder bid data field 440 may be linked by, for example, a pointer.

The responder message originator field 445 may include information regarding a number of advertisers or bidders associated with a responder. A responder message may be sent from various advertisers to a responder. As illustrated in FIG. 4, ‘Advertiser A’, ‘Advertiser B’, ‘Advertiser C’ and ‘Advertiser D’ are associated with ‘AutoGuide’. This may indicate that those advertisers have bid to include a message with a response to a request provided by ‘AutoGuide’. A responder may provide a message of a responder as a default message based on various conditions such as when no bid is received, a bid threshold is not met, a responder declines messages of an advertiser, etc.

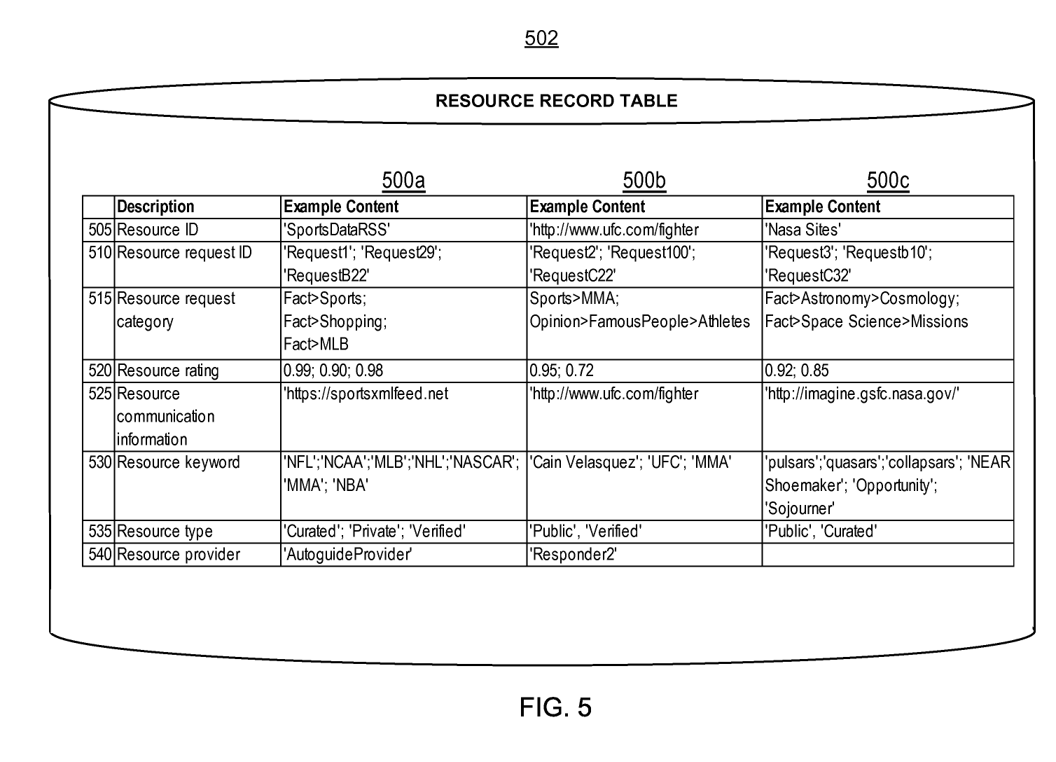

As illustrated in FIG. 5 an exemplary resource record table 502 which may comprise a number of resource records is provided. One or more resource records may be associated with or resident in the database 120 (FIG. 1). The resource record table 502 (FIG. 5) may include information of resources. Resource records 500 may include a resource ID field 505, a resource request ID field 510, a resource request category field 515, a resource rating field 520, a resource communication information field 525, a resource keyword field 530, a resource type field 535, and a resource provider field 540.

The resource ID field 505 includes an identifier of a resource which is preferably unique and is preferably used consistently. A resource ID serves to distinguish a resource record associated with a resource from a resource record associated with other resources. Any number of characters, numbers, and/or other indicators may be used to indicate a resource ID. Using the example in FIG. 5, ‘SportsDataRSS’ is the resource ID associated with the resource record 500a.

The resource request ID field 510 may include information of a number of requests associated with a resource. Content of the resource request ID field 510 may be used to obtain information of a request. For example, if a resource has been used to respond to a request, an identifier of the request may be indicated in the resource request ID field 510. Using the example in FIG. 5, ‘Request2’, ‘Request100’ and ‘RequestC22’ are associated with the resource <<‘http://www.ufc.com/fighter/Weight_Class/Heavyweight’>> as indicated in the resource record 500b. This may indicate that <<‘http://www.ufc.com/fighter/Weight_Class/Heavyweight’>> has been utilized to respond to ‘Request2’, ‘Request100’ and ‘RequestC22’.

The resource request category field 515 may include information of a number of categories of requests which may be processed by a resource. For example, a category and/or keyword associated with a request, a type of request, profile, etc., which may be used to determine if a resource is to be presented to a guide or responder or user for a request may be indicated in the resource request category field 515. In at least one embodiment, a resource may be assigned to a category of request as part of a registration process. A resource may be associated with a user, a group of users, a responder, an access right, an advertiser or sponsor, etc. A provider of a resource may select a type and/or category of request for which the resource may be used and/or required. A resource may be associated with a category based on a selection by an administrator, based on success rates of obtaining or providing answers, etc. Using the example in FIG. 5, ‘NasaSites’ is associated with the categories ‘Fact>Astronomy>Cosmology’ and ‘Fact>Space Science>Missions’ as indicated by the resource record 500c.

The resource rating field 520 may include information of a number of ratings associated with a resource. For example, a rating of a resource may be based on ratings of answers produced using the resource, a contractual agreement, an affiliation, temporal information such as time spent by guides, etc. A rating of a resource may be used to select a resource which is provided to a searcher or guide, to rank a response associated with a resource, etc. In at least one embodiment, the resource request category ID field 515 and the resource rating field 520 may be linked by, for example, a pointer. Using the example in FIG. 5, ‘SportsDataRSS’ has a rating of ‘0.99’ associated with ‘Fact>Sports’ which may indicate that ‘SportsDataRSS’ is more likely to produce an acceptable response for that category. A resource may have a rating corresponding to various categories, types of information, types of tasks, keywords, etc.

The resource communication information field 525 may include information of a number of communication services associated with a resource. For example, a user name and password, an email address, an IM credential, a phone number, a web page, a physical address, etc., may be indicated in the resource communication information field 525. A communication service indicated in the resource communication information field 525 may for example be used to indicate a service by which a resource may be accessed. Using the example illustrated in FIG. 5, the URL <<http://www.ufc.com/fighter>> is associated with the resource <<‘http://www.ufc.com/fighter’>>. This may indicate that a query associated with ‘Sports>MMA’ may be submitted to that URL by for example an API and/or that the resource may be processed to obtain an answer and/or presented to a responder.

The resource keyword field 530 may include information of a number of keywords associated with a resource. A match to a keyword indicated in the resource keyword field 530 may affect a probability that a request will receive a response associated with a resource. For example, a match may prohibit a query from receiving a result from a resource, may increase a ranking of a resource, may be used to associate a category with a request, may identify a resource to be provided to a guide, etc. In at least one embodiment, keywords included in requests for which a resource has provided an answer may be more highly ranked for a category associated with the query and the resource. A responder may select and/or determine a keyword associated with a resource provided by a responder.

The resource type field 535 may include information of a number of types or characteristics associated with a resource. A type may include an indication of an access right, a commercial arrangement, a preference, quality of content, source of content, etc. A searcher or responder may elect to associate a resource with a type. A system administrator may associate a type with a resource. A provider of a resource may designate a type associated with the resource for example as part of a registration process. Using the example in FIG. 5, ‘Nass Sites’ is a ‘Public’, ‘Curated’ resource. This may indicate that content of the resource is available to the general public, and that the content of the resource is verified to be correct.

The resource provider field 540 may include information of a provider of a resource. A resource may be provided by any number of advertisers and/or responders. For example in FIG. 5 AutoguideProvider is associated with the resource ‘SportsDataRSS’ as indicated by the resource record 500a. This may indicate that an answer provided using ‘SportsDataRSS’ may allow AutoguideProvider to control a message delivered in conjunction with an answer.

As illustrated in FIG. 6 an exemplary responder message record table 602 which may comprise a number of responder message records is provided. One or more responder message records may be associated with or resident in the database 120 (FIG. 1). The responder message record table 602 (FIG. 6) may include information of responder messages. Responder message records 600 may include a responder message ID field 605, a responder message source field 610, a responder message content field 615, and a responder message keywords field 620.

The responder message ID field 605 includes an identifier of a message of a responder which is preferably unique and is preferably used consistently. A responder message ID may be used to identify a message of a particular responder from another message. As illustrated in FIG. 6, ‘SportsDataRSSmessage1’ is the responder message ID associated with responder message record 600a.

The responder message source field 610 may include information of a number of sources of a responder message. A responder message source may include an advertiser, a responder, an ad server, etc. In one embodiment a responder message source may be an advertiser and/or a responder which has been determined based on a bidding process. For example the responder message source associated with ‘Responder2message1’ is ‘Advertiser E’ as indicated by the responder message source field 610 of the responder message record 600b. This may indicate that ‘Advertiser E’ has successfully bid to provide ‘Responder2message1’, whereas ‘Responder2’ may be a source of the message ‘Responder2message2’ as indicated in the responder message record 600c.

The responder message content field 615 may include information concerning content of a responder message. The responder message content field 615 may indicate a location from which a responder message is to be obtained. For example, the responder message content field 615 may contain information related to an advertisement, such as an ad server, a resource, etc. As illustrated in FIG. 6, responder message content <<http://adservresp2/default>> is associated with resource record 600c. This may indicate that content associated with that URL is to be obtained when ‘Responder2message2’ is requested. Any type of content may be indicated in the responder message content field 615.

The responder message keywords field 620 includes information about keywords associated with a responder message. A responder message may be associated with keywords in order that an advertiser may target an advertisement to requests associated with a keyword. If a responder has registered to receive queries based on a keyword, category, type, etc. a responder message may be associated with a keyword to which a request was matched and/or used to direct a request to a responder. For example, the keywords ‘Sports’, ‘NFL’, and ‘Football’ are associated with message ID ‘SportsDataRSSmessage1’ as indicated in the responder message record 600a.

While particular groupings, structures and linkages of information have been used for the purposes of illustration of the database structures herein, no limitation is implied. Other equivalent data constructs and structures which would readily occur to one of ordinary skill in the relevant art may be used to implement the records and tables described herein as would be required for the operation of the embodiments disclosed herein.

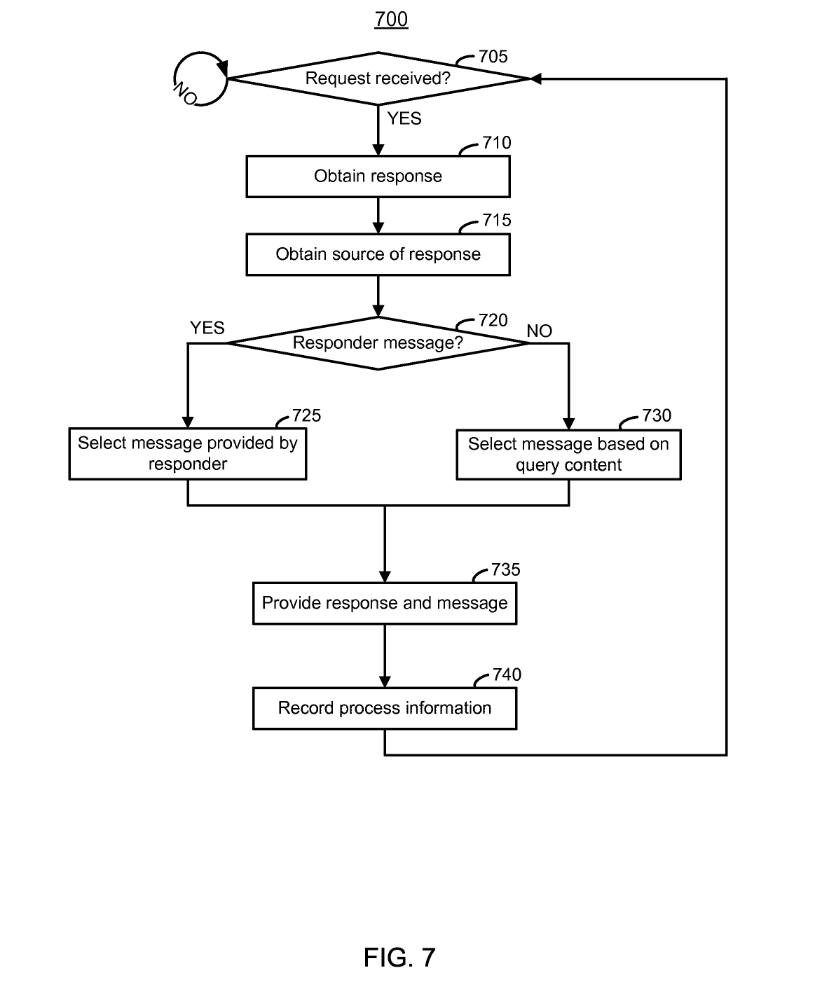

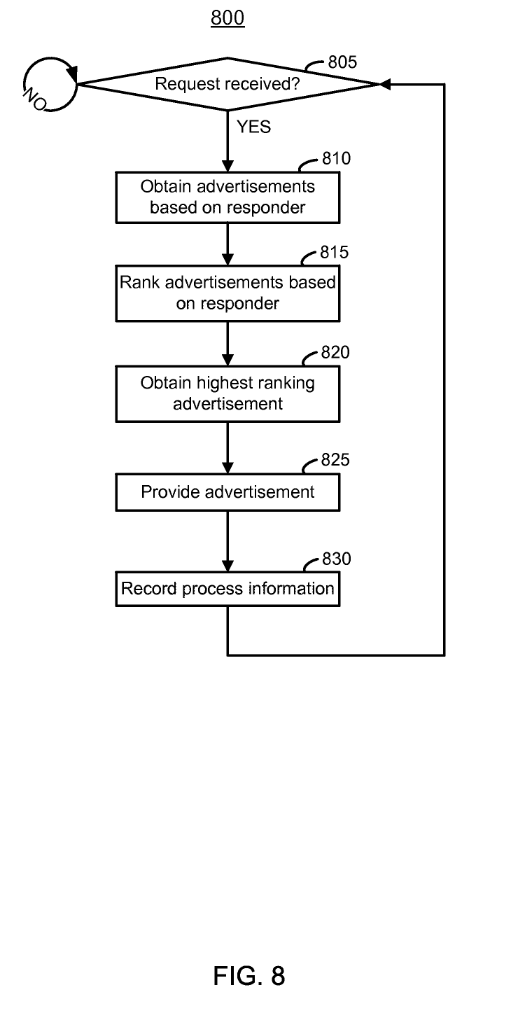

As illustrated in FIG. 7, a process 700 for providing an answer is provided. The process 700 may be performed in whole or in part by any suitable element of the system 100 (FIG. 1). In at least one embodiment, the process 700 is operative on a server associated with the search system 130. A request may be a request for an automated answer, a human assisted answer and/or a combination thereof. The process 700 may be incorporated with a process such as the process 800 (FIG. 8).

In operation 705 (FIG. 7) a determination is made as to whether a request is received. If it is determined in operation 705 that a request is not received, control remains at operation 705 and process 700 continues. If it is determined in operation 705 that a request is received, control is passed to operation 710 and process 700 continues.

The determination in operation 705 may be made using various criteria. In at least one embodiment, if a message is received at a system associated with the search system 130 (FIG. 1), it may be determined that a request is received. For example, if an email message, an SMS, EMS, and/or MMS message, an IM, an IP message, and/or a voice message is received at an address associated with the search system 130, it may be determined that a request is received. If a message is received at a server associated with the search system 130, it may be determined that a request is received.

In operation 710 a response is obtained. A response may be obtained programmatically using a database, software application, stored information, etc. A response may be obtained from a resource. For example, a query may be submitted to a resource, a responder may select media provided by a resource and may obtain a response from a resource, etc. An answer or response may be obtained by directing a task to a guide or responder. Any number of responses may be obtained. Control is passed to operation 715 and process 700 continues.

In operation 715 a source of a response is obtained. For example, a responder providing a response, a resource associated with a response, a guide, a user, an advertiser or sponsor, etc., that has provided an answer may be determined or obtained or determined. Stored information regarding a response may be used to obtain a source of a response. Any number of sources may be associated with a response. Control is passed to operation 720 and process 700 continues.

In operation 720 a determination is made as to whether a responder message is to be provided. If it is determined in operation 720 that a responder message is not to be provided, control is passed to operation 730 and process 700 continues. If it is determined in operation 720 that a responder message is to be provided, control is passed to operation 725 and process 700 continues.

The determination in operation 720 may be made using various criteria. If a responder elects to respond to a query it may be determined that a responder message is to be provided. If a response is associated with a resource provided by a responder, it may be determined that a responder message is to be provided. If a guide selects an answer of a responder, it may be determined that a responder message is to be provided. If an answer of a responder is accepted it may be determined that a responder message is to be provided. If a guide associated with a responder provides a response, it may be determined that a responder message is to be provided. Any suitable criteria may be used to determine whether a responder message is to be provided.

In operation 725 a message provided by a responder is selected. A responder message may be selected based on various criteria. For example, a responder message may be selected based on a ranking of messages provided by advertisers for targeting information associated with a request. Responder messages may be ranked based on a bid of an advertiser, a number of times a responder message has been ‘clicked’ or activated, temporal information, location, demographic variables, etc. Any number of messages from any number of responders may be selected. A ranking of a responder message may be based on a value assigned to a contribution of a responder to a response. For example, if a responder provides a resource from which an answer is obtained, a responder message of a responder may be ranked lower than a responder message of a responder who obtained the answer from the resource. Control is passed to operation 735 and process 700 continues.

In operation 730 a message is selected based on query content. A message may be selected based on any content of a query, including attributes of a source of a query, temporal information, content of a response, etc. For example, a query about cars may specifically relate to an ad by ‘Ford’ and the message endorsed by ‘Ford’ may be selected based on a bid by ‘Ford’ for the keyword ‘cars’. Any number of messages may be selected. Control is passed to operation 735 and process 700 continues.

In operation 735 a response and a message are provided. A combination of responder messages and messages selected based on a query and/or response may be provided. Any number of responses and/or messages may be provided. A ranking of responses and/or messages may be performed. A response and/or message may be provided in any suitable form. A message and/or a response may be null. Any communication medium associated with a request may be used to provide a response and/or a message. For example, a message and a response may be provided as a pointer to a location from which the response and the message may be obtained. Control is passed to operation 740 and process 700 continues.

In operation 740, process information is recorded. Information of a request, an answer, a resource, a user, a sponsor or advertiser, a guide, a responder, a responder message, an advertisement, a rating, a ranking, etc. may be recorded. Usage and compensation associated with a responder message and/or user actions associated with a response and/or message may be recorded. In at least one embodiment, process information is recorded in the database 120 (FIG. 1). Control is passed to operation 705 and process 700 continues.

As illustrated in FIG. 8, a process 800 for providing a message based on a responder is provided. The process 800 may be performed in whole or in part by any suitable element of the system 100 (FIG. 1). In at least one embodiment, the process 800 is operative on a server associated with the search system 130. A request may be a request for any type of content which may include various media. The process 800 may be used in combination with the process 700 (FIG. 7).

In operation 805 (FIG. 8) a determination is made as to whether a request is received. If it is determined in operation 805 that a request is not received, control remains at operation 805 and process 800 continues. If it is determined in operation 805 that a request is received, control is passed to operation 810 and process 800 continues.

The determination in operation 805 may be made using various criteria. In at least one embodiment, if a message is received at a system associated with the search system 130 (FIG. 1), it may be determined that a request is received. For example, if an email message, an SMS, EMS, and/or MMS message, an IM, an IP message, and/or a voice message is received at an address associated with the search system 130, it may be determined that a request is received. If a message is received at a server associated with the search system 130, it may be determined that a request is received.

In operation 810 advertisements are obtained based on a responder. Advertisements may be obtained based on a category associated with a responder when a category is selected by an advertiser. Advertisements may be associated with a responder based on an action by a responder such as a selection of a keyword, topic, tag, etc. An advertisement may be associated with a responder based on a selection of the responder by an advertiser. An advertisement may be associated with a responder based on a location associated with an advertisement and/or a responder. An advertisement may be associated with a responder based on demographic, affiliation, etc. information associated with an advertisement and/or a responder. A responder may be associated with multiple advertisements and/or advertisers. Control is passed to operation 815 and process 800 continues.

In operation 815 advertisements are ranked based on a responder. Advertisements may be ranked based on various items associated with a responder. A bid associated with an advertisement may cause an advertisement to have a higher ranking. A category associated with an advertisement and/or advertiser may affect a ranking of an advertisement for a responder. For example, a responder may identify a category as being undesirable, which may cause a ranking of an advertisement associated with a category to be decreased. A responder may set a minimum bid value and if a bid associated with an advertisement is below a minimum bid, a default message determined by a responder may be ranked highest. Any factor used to select an advertisement associated with a responder may be used to rank an advertisement for a responder. A ranking of an advertisement may be based on a ranking of a responder for an element of a query associated with a request for an advertisement. For example, if a responder has a high ranking for queries associated with NCAA football, advertisements associated with sports might be more highly ranked for responses by a responder. Control is passed to operation 820 and process 800 continues.

In operation 820 a highest ranking advertisement is obtained. Any number of advertisements may be deemed to be a highest ranking advertisement. For example, if three advertisements are requested, three highest ranking advertisements may be provided. Control is passed to operation 825 and process 800 continues.

In operation 825 an advertisement is provided. An advertisement may be provided in any suitable manner. An advertisement may be provided from an ad server such as the message source 155 (FIG. 1). An advertisement may include text, images and/or any suitable media which may be delivered to a device associated with a user. Control is passed to operation 830 and process 800 continues.

In operation 830, process information is recorded. Information of a request, a resource, a user, a sponsor, an advertiser, a responder, a rating, a ranking, etc. may be recorded. Usage and compensation associated with a responder, an advertiser, and/or an advertisement may be recorded. In at least one embodiment, process information is recorded in the database 120 (FIG. 1). Control is passed to operation 805 and process 800 continues.

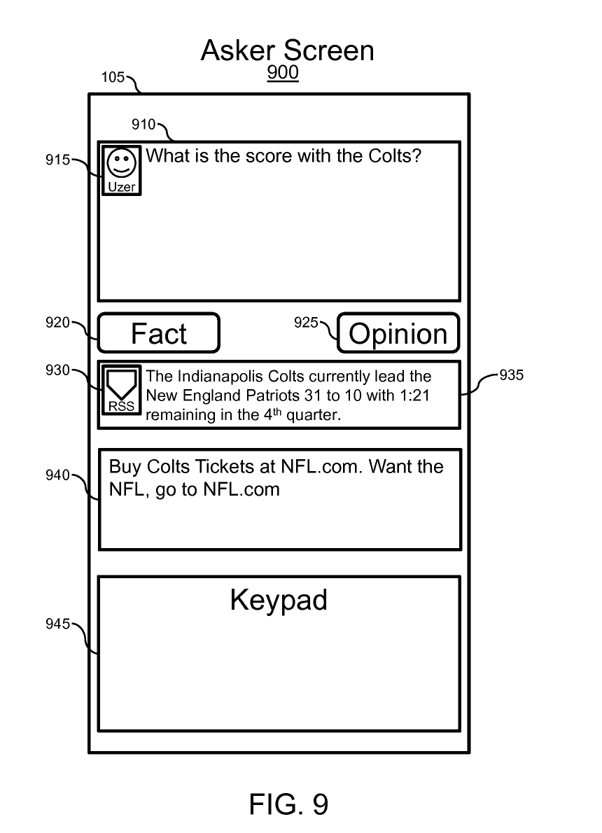

As illustrated in FIG. 9 an exemplary query submission GUI 900 is provided. The query submission GUI 900 may be provided to a user. The GUI 900 may be presented using a system such as the user system 105 (FIG. 1). The GUI 900 may be used to submit any type of request. The GUI 900 may include a query entry area 910, a user identifier 915, a factual query indicator 920, an opinion query indicator 925, a responder indicator 930, a response indicator 935, an advertisement field 940 and a user input control 945.

The request entry area 910 may be used to indicate information of a request. The user identifier 915 may be used to indicate information of a user submitting a request. The factual query indicator 920 may be used to indicate that a request is a request for factual information. The opinion query indicator 925 may be used to indicate that a request is a request for subjective information. The responder indicator 930 may be used to indicate a source of a response. The response indicator 935 may be used to indicate a response associated with a request indicated in the request indicator 910. The advertisement field 940 may be used to provide an advertisement or responder message related to the query in request entry area 910. For example, the advertisement field 940 may include a message selected based on ‘RSS’ as indicated in the responder indicator 930. The user input control 945 may be used to submit a request. While a keypad is used for purposes of illustration, any input device which is well known in the art may be used to implement the user input control 945.

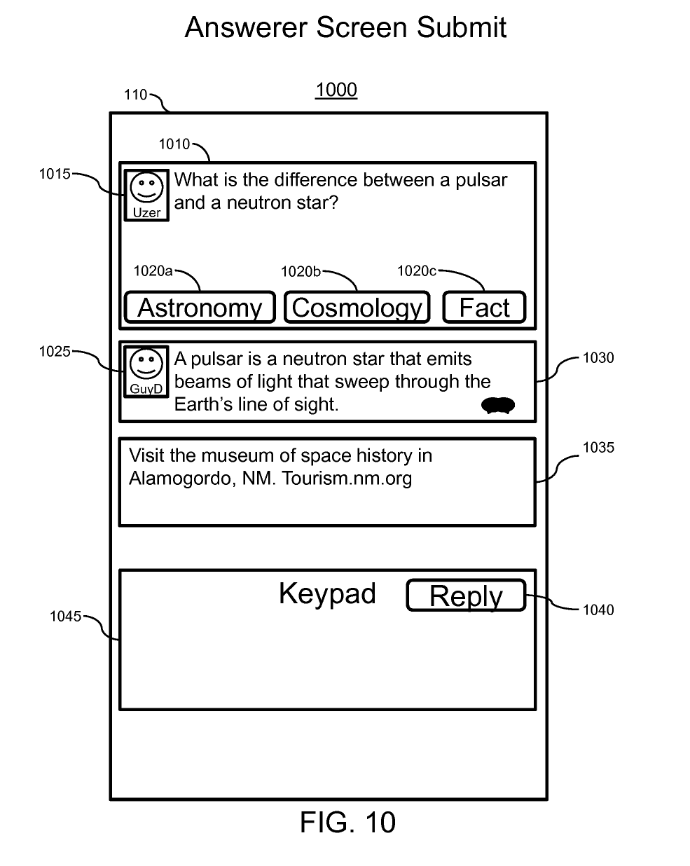

An exemplary GUI 1000 for providing a response to a request is illustrated in FIG. 10. The GUI 1000 may be provided using a device such as the user device 110 (FIG. 1). A responder may be provided with the GUI 1000 at any time. If a responder is provided with a request and accepts to respond, the GUI 1000 may be provided. The GUI 1000 may include a query indicator 1010, a user indicator 1015, category indicators 1020a-1020c, responder indicator 1025, an answer indicator 1030, an advertisement field 1035, an action control 1040, and user controls 1045.

The query indicator 1010 may be used to indicate information of a query to which a responder has chosen to respond. The user indicator 1015 may be used to indicate information of a user associated with a request. The category indicators 1020a-1020c may be used to indicate information of a type or category associated with a request, which may be used to select requests, messages and/or advertisements. The responder indicator 1025 may indicate information of a responder submitting a response. The answer indicator 1030 may be used to indicate a respond provided by a responder indicated by the responder indicator 1025. For example, a responder may use the user controls 1045 to indicate a response. The advertisement field 1035 may indicate an advertisement or responder message which may be presented if a responder activates the answer indicator 1030. The action control 1040 may be used to indicate that a response indicated in the response indicator 1030 is to be provided as a response to a query indicated in the query indicator 1010. Any number of answer indicators and/or advertisement indicators may be provided in the GUI 1000. A responder may select and/or may reject an advertisement provided in the advertisement indicator 1035. For example, a responder may be able to reject an advertisement by ‘swiping’, may be able to accept an advertisement by ‘tapping’, etc. as is well known in the art.

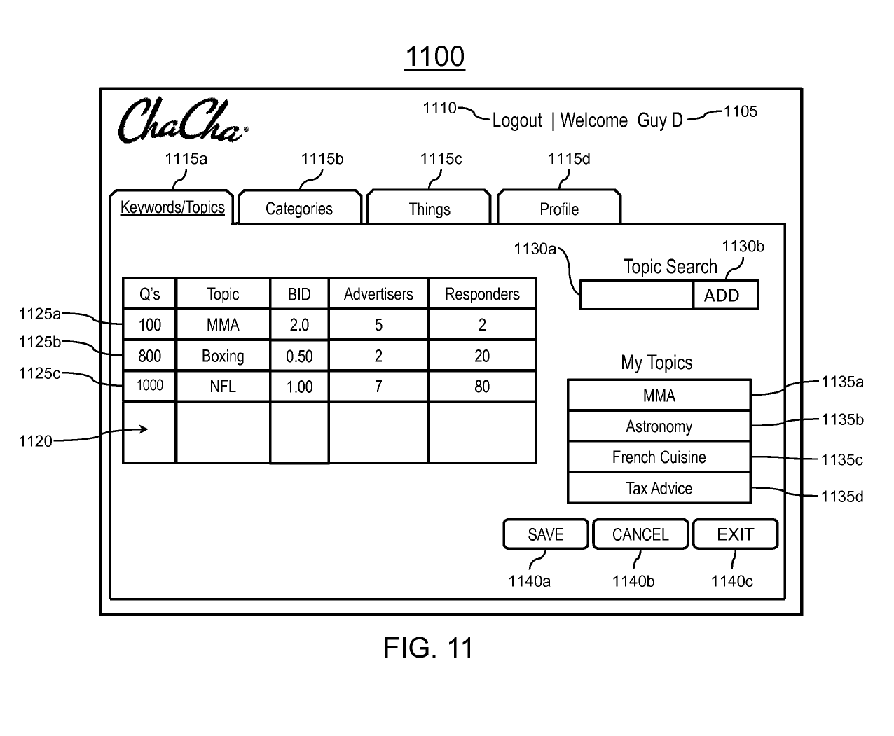

As illustrated in FIG. 11 an exemplary topic selection GUI 1100 is provided. The GUI 1100 may be presented using a device such as the user device 110 (FIG. 1) and/or the guide device 135. The GUI 1100 may be used by a responder to select information which may be used to direct a query to a responder. For example, a responder and/or guide may select a topic based on information provided by the GUI 1100 at any time. The GUI 1100 may include a user indicator 1105, a login control 1110, selection tabs 1115a-1115d, a targeting information window 1120, target information indicators 1125a-1125c, topic filtering controls 1130a, 1130b, current topic indicators 1135a-1135d, and action controls 1140a-1140c.

The user indicator 1105 may indicate information of an operator of the GUI 1100. The login control 1110 may be used to login or log out of the system. The selection tabs 1115a-1115d may be used to view various types of targeting information which may be used to direct a query. For example, the ‘Keywords/Topics’ selection tab 1115a may be used to view information of queries and/or advertisements associated with topics or keywords. The ‘Categories’ selection tab 1115b may be used to view information of queries and/or advertisements based on categories. The ‘Things’ selection tab 1115c may be used to view information of queries and/or advertisements associated with named entities such as cities, famous persons, etc. The ‘Profile’ selection tab 1115d may be used to manage demographic, geographic, etc. information associated with a responder. An active tab may be indicated in any typical manner as is well known in the art such as color, highlighting, etc. The ‘Keywords/Topics’ selection tab 1115a is active as indicated by the underlining in FIG. 11.

The targeting information window 1120 may be used to present information of targeting data indicated by an active selection tab. For example, the number of questions (Q's) relating to a topic, a current bid price for advertisements associated with the topic, a number of advertisers who have submitted bids relating to the topic, and a number of responders who are accepting requests associated with the topic may be indicated. The target information indicator 1125a may present information regarding the topic ‘MMA’, which may be more attractive to a responder since comparatively few responders are registered for ‘MMA’ and the bid price and number of advertisers is high. Content of the targeting information window 1120 may be sorted according to any of the displayed fields in order to assist a responder in selecting targeting information. The topic filtering control 1130a may be used to enter information of a desired topic, which may affect content of the targeting information window 1120. The ‘ADD’ topic filtering control 1130b may be used to add a topic to the current topic indicators 1135a-1135d. The current topic indicators 1135a-1135d may be used to indicate topics and/or targeting information for which a responder has elected to receive requests. A topic may be removed from a current topic indicator by for example a ‘right click’ or ‘dragging’ a topic from a current topic indicator. The ‘SAVE’ action control 1140a may be used to store information obtained using the GUI 1100. The ‘CANCEL’ action control 1140b may be used to cancel any changes made using the GUI 1100. The ‘EXIT’ action control 1140c may be used to close the GUI 1100 without saving information obtained. While a limited number of selection tabs 1115 is depicted in FIG. 11, any number of selection tabs may be provided as per a targeting selected for an embodiment.

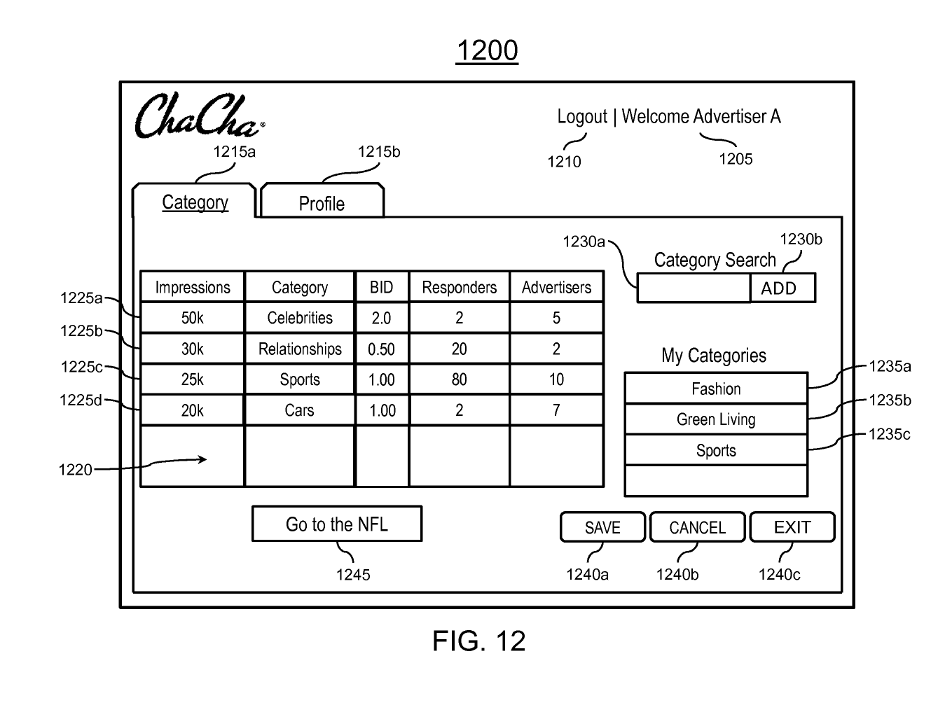

As illustrated in FIG. 12 an exemplary advertiser GUI 1200 is provided. The GUI 1200 may be presented using a device such as the message source 155 (FIG. 1). The GUI 1200 may be used by an advertiser to select information which may be used to target advertisements. The GUI 1200 may include an advertiser indicator 1205, a login control 1210, selection tabs 1215a-1215b, a targeting information window 1220, target information indicators 1225a-1225d, targeting filtering controls 1230a, 1230b, current target indicators 1235a-1235c, action controls 1240a-1240c, and advertisement indicator 1245.

The advertiser indicator 1205 may indicate information of an operator of the GUI 1200. The login control 1210 may be used to login or log out of the system. The selection tabs 1215a, 1215b may be used to view various types of targeting information which may be used to target advertisements. For example, the ‘Category’ selection tab 1215a may be used to view information of queries, responders, and/or advertisements associated with a category. The ‘Profile’ selection tab 1215b may be used to manage demographic, geographic, etc. information associated with an advertisement and/or advertiser. An active tab may be indicated in any typical manner. The ‘Category’ selection tab 1215a is active as indicated by the underlining in FIG. 12. While a limited number of selection tabs is illustrated FIG. 12, any number of selection tabs and/or types of targeting information might be presented to an advertiser within the scope of the embodiments disclosed herein. For example, an advertisement might be targeted based on a keyword, topic, named entity, responder, responder rating, answer rating, etc.

The targeting information window 1220 may include information of categories which might be used to target an advertisement. For example, a number of impressions per day, a current successful bid price, a number of responders and a number of advertisers who have bid to target advertisements based on a targeting parameter may be provided. For example, the category ‘Relationships’ might be attractive for targeting a suitable advertisement as a number of impressions is large, a bid price is low, a number of responders is high and a number of competing advertisers is low. The targeting filtering control 1230a may be used to enter information regarding a target such as a category, which may affect content displayed in the target information window 1220. Content of the targeting information window 1220 may be sorted according to any of the displayed fields in order to assist an advertiser in selecting targeting information. The ‘ADD’ targeting filtering control 1230b may be used to add targeting information to the current target indicators 1235a-1235c. The current target indicators 1135a-1135c may be used to indicate topics and/or targeting information which an advertiser has elected to use to target advertisements. Targeting data may be removed from a current target indicator by for example a ‘right click’ or ‘dragging’ a target from a current target indicator. The ‘SAVE’ action control 1240a may be used to store information obtained using the GUI 1200. The ‘CANCEL’ action control 1240b may be used to cancel any changes made using the GUI 1200. The ‘EXIT’ action control 1240c may be used to close the GUI 1200 without saving information obtained. The advertisement indicator 1245 may provide information of an advertisement for which targeting information is being selected. For example, if an advertiser selected the ‘Sports’ target information indicator 1225c, an advertisement indicated in the advertisement indicator 1245 might be targeted to queries of responders associated with the ‘Sports’ targeting category.

Using the methods and systems described herein a responder may manage messaging which is provided when an answer of a responder is presented. A responder may determine a message which is provided based on temporal, topical, geographic, demographic and/or other types of targeting information. A responder may elect to receive bids for messages which are provided when an answer of a responder is provided. A responder may provide a default message which is presented if another message which meets criteria or targeting information associated with a response, responder, category, topic, etc. is not available. A reused answer of a responder may include an advertisement selected based on information of a responder. A corpus of answers may provide a larger number of message impressions than an individual answer.

An advertiser may elect to target advertisements based on information of a responder. For example, if a responder has registered to respond to requests associated with a category, an advertiser may elect to target an advertisement to the category, and may select responders on a basis such as demographic, geographic, rating, etc. associated with a responder. An advertiser may view information of targeting options which may assist an advertiser in better matching advertisements to responders and/or a target audience.

While the system is described in the context of a peer-to-peer answering system, any system in which answers are provided to queries might take advantage of the benefits of the embodiments described herein. For example, a referral service such as the Angie's List® system or an auction site such as Amazon or Ebay might permit a vendor to respond to a user inquiry and permit a vendor to deliver an advertisement based on providing a response.

In systems wherein questions are submitted by users and answered by peers, it is desirable to have rapid and accurate responses. Systems such as Aardvark, Mosio and Yahoo! Answers have attempted to user peer-to-peer answering to meet this need. However, such systems have met with limited success. In particular it is difficult to provide answers in a timely manner and to provide accurate information. This problem may be made more difficult to solve when many similar queries are received and a plurality of answers may be provided to each similar query.

One way to overcome the timing limitation is to incentivize a person tasked to respond to a request. Various types of compensation methods have been implemented by companies such as KGB and ChaCha. By paying workers to respond to questions, timeliness of answers and answer quality may be improved. However such systems have higher cost to answer and thus must be able to obtain higher compensation per query than a peer-to-peer system in which an answerer is not financially compensated.

As described in the related U.S. application Ser. No. 13/612,377, filed Sep. 12, 2012 entitled METHOD AND SYSTEM OF MANAGEMENT OF SEARCH RESULTS, inventor Eugene M. O'Donnell, a provider of goods and/or services or “vendor” may provide information resources, and/or human assistants which may be used to respond to a user request. However, such a system may have some limitations as well. In particular if a person or entity provides a response, an advertising message may be used as compensation. However, care must be taken regarding other answers and/or advertising messages which may be delivered with a response.

For these and other reasons, a method and system for providing advertising content based on a provider of a response would be greatly appreciated.

A system is implemented whereby a responder may receive a query from a user. If a responder elects to respond to the query, a response of the responder may include a message determined by the responder. A message determined by the responder may be a general or specific advertising message. If a response is associated with a responder and the responder or answerer is associated with a vendor, a message selected by the vendor may be provided regardless of content of a user request. Likewise, a message delivered with a response may be targeted by a vendor in various ways. For example, if a national brand responded to a request, a locally targeted message such as a coupon, etc. might be delivered based on geographic information associated with a query. So long as an answer is provided by a vendor, the vendor may be permitted to deliver any suitable message and may be able to select appropriate targeting criteria for a message.

A system is provided whereby users may submit a request. A request may be submitted using any suitable device such as a desktop or laptop computer, wireless phone or tablet device, etc. A request may be received by a server, which may store information of a request. A response may be provided in various ways. Information of a request may be directed to a responder or answerer. A responder may be a person and/or an entity such as a business or organization. If a responder provides an answer to a request, a message may be included with an answer. A message of a responder may be provided in addition to a response. A message of a responder may be provided when a stored response associated with a responder is returned as an answer to a request.

A responder may determine a type of response which is provided with an answer. A responder may provide a number of messages or promotional messages or advertisements. A responder may be able to determine targeting information of a message provided with a response. For example, a responder may be able to schedule a message to be provided during a particular time interval, to a predetermined location, to users within a demographic, to a number of requesters, a maximum number of times to a particular user or group of users, based on a subject matter of a response, etc.

A responder may provide a resource which produces a response. For example, a responder may provide a resource which receives a query and provides a potential answer based on the query. If an answerer selects a potential answer, a responder may be able to provide a message with the answer. Should a potential answer be reused, a responder or sponsor may be able to provide a message with the answer. In at least one embodiment, a responder may not provide a message indicated in an answer, but may receive a message from an advertiser and/or sponsor, who may bid based on factors such as reputation of the responder, subject matter of answers provided by the responder, etc. In this way, a responder may act as an agent for advertisers.

An additional message may be delivered in conjunction with an answer or response. For example, an advertising message may be chosen based on content of a user query, content of a response, geographic, demographic, affiliation, and/or other profile information associated with a request and/or a user. When an advertising message is selected a selection may be influenced by a responder associated with a response to a request. If an advertisement relates to a direct competitor of a responder, an advertisement may be blocked and/or may be reduced in rank based on a responder and a value or rank associated with a response. Alternately, a response of a responder may be suppressed and/or reduced in rank if an indication of an answer of a responder would conflict with a provider of an advertisement.

A responder and/or an advertiser may provide information which may be used to determine whether a conflict exists. A responder and/or advertiser may provide and/or select names of competitors who may be blocked. An advertiser and/or responder may provide information of allowed advertisers and/or responders. An advertiser and/or responder may submit a bid which may be considered in selection of an advertisement. For example, if a bid of an advertiser on a blocked list of a responder exceeds a bid by the responder by a predetermined amount, percentage, etc. an advertisement of an advertiser may be presented.

An advertiser may submit targeting information based on a keyword, category, topic, etc. A responder may elect to block advertisements associated with a keyword, category, topic, etc. from being presented when a response of a responder is provided. For example, if a responder has replied to a query including the keyword ‘cars’ an advertisement ranked highest for the keyword ‘cars’ might be blocked when a response to a query originates from a responder, but might be displayed when a response to a query indicating ‘cars’ does not originate with a responder. This may incentivize a responder to respond to more queries and accept a broader variety of requests.

A system is provided which includes a user system for submitting a query and receiving a response, a search server receiving the query, a database storing information of queries, search results, searchers, users, resources and other information, a guide system receiving a query and providing a search result, and a sponsor system providing sponsored answers.

A system is implemented to allow a user to submit a query and receive a response. A query and/or a response may include any type of media such as text, URL's, audio, video, etc. A response may be produced automatically and/or using the assistance of a person. A query may be submitted using any suitable device and/or communication service such as SMS, MMS, voice, Instant Messaging, VoIP, internet packet communication, email, etc.

Processing of a query may be divided into various layers. A first layer may consist of automated processing of a query. Automated processing of a query may include comparison of a query to a database, analysis of a query using semantic techniques, pattern matching, etc. which may be used to determine a response to the query. Results of automated processing such as categorization, spelling correction, named entity extraction, location association, etc. may be stored for later use.

A second layer of processing of a query may include a human assistant who analyzes the query or “expediter”. An expediter uses the human ability to recognize context in order to determine a response to a query. An expediter may be provided with relevant context of a query, and offered various options for responding to the query. In its simplest form, an expediter might be presented with a question and two or more options for responding to the question. An expediter may be provided with a rich toolset which provides a greater depth and breadth of responses which may be interactive. In at least one embodiment, an expediter may be provided with responses from a predetermined set of resources.

A third layer of processing of a query may include a human assistant who responds to the query or “searcher”. A searcher may receive an interpreted query, information of a source of the query, and be provided with resources for performing a search responsive to a query. A searcher may formulate a response based on an interpreted query, and submit the response for delivery to a user responsive to the query. In at least one embodiment, a searcher may receive information of resources which may be used to provide a response, and/or resources which are excluded from providing a response.

A resource may be characterized according to various parameters. A resource may be evaluated based on a number of responses obtained from and/or using the resource. A resource may be evaluated based on a number of times that a response obtained from the resource is reused. A resource may be evaluated based on an affiliate relationship between a provider of the resource and a provider of search services and/or a responder.

As used herein, a “request” means a request for information, products, and/or services. A request or search request or query may include various types of media, and may be provided by any user system which may establish communication with a server and/or other devices associated with a search service. A request may be referred to as a “search request”, “search query”, or “query”.

A “user” is a person who submits a request and may receive any type of information responsive to a request. A user may be any person or entity. A “guide” is a person who assists in processing a request. A guide may be referred to as a “provider”, “searcher”, “human searcher”, “human assistant”, “expediter”, “transcriber”, “specialist” or “generalist”. Guides may be assigned various roles. A guide who transcribes a user request from one form to another may be referred to as a transcriber. A guide who reviews a query, determines a most likely response, and may modify a query may be referred to as an expediter or “ambassador”. A guide who performs a search for queries associated with a specific category may be referred to as a specialist. A guide who performs a search for queries regardless of category may be referred to as a generalist. Any guide may perform any role.

An “advertiser” is any person and/or entity which may provide promotional information or “advertisements” to be delivered to a user. An advertisement may take various forms and/or may include media of any sort which can be delivered to a user device. A “result”, “response”, “answer”, or “search result” is any information which has been determined to be a response to a request. A result may include an advertisement. A result may be any information which is provided as a response to a request. A “resource” or “search resource” may be any source of information which may provide a search result and/or other information. A resource may include a search engine, a web server, a software application, an API, printed media, an RSS feed, streaming media, a web page, a database, etc. A “profile” may be any information associated with a person such as demographic data, geographic data, personality data, affiliations, etc. A result may be an “organic” result which is produced by a search which has no intentional bias applied. A result may be a “sponsored” result which is provided and/or approved by a provider with a commercial interest in the response and/or providing the response to a user based on a request for information associated with the sponsored answer or sponsored result. A “responder” is a person or entity that responds to a request. A responder may be referred to as an “answerer”. A responder may be a user who has elected to act in any guide role such as searcher, generalist, expediter, etc. A responder may perform any task which a guide may perform. A responder may be a person or an entity such as an organization, business, etc.

A human assistant such as an expediter may select a search result associated with a previous query and/or an automated resource. A search result selected by a human assistant may be indicated as a sponsored result and/or an organic result. A human assistant may be presented with sponsored results, organic results, and/or a mixture of organic and sponsored results. An expediter may be associated with a sponsor, and may be presented with sponsored results associated with the sponsor.

The terms voice and speech are used interchangeably herein. A user, a guide and/or a search system may establish a communication session using a voice service, a messaging service such as Short Messaging Service (SMS), Enhanced Messaging Service (EMS), Multi-media Messaging Service (MMS), Instant Messaging (IM), email, an internet portal or web page, an application, regular mail and/or any other suitable type of communication. A connection or communication session may be established using any device which is capable of utilizing a communication service. For example, a wireless device such as a cell phone, PDA, smart phone, etc., might be used to establish a communication session using voice, SMS, IM, email and/or internet protocols. A desktop, laptop or server system might be used to establish a communication session using IM, email, SMS, MMS, etc. A landline phone, a specialized communication terminal, and/or any other communication device might be used to establish a communication session.

Communication between a user, a guide and/or a search system may include conversion of text to speech and speech to text. Any type of media which can be sent and/or received using a communication system may be part of a communication session. A communication session may be conducted using any or all communication services associated with a user, a guide, and/or a search system. Any communication session may include communication via multiple services and/or devices. For example, a request may be submitted as a voice query, which might indicate an image located on a resource accessible to a user. A voice query might be converted to a text message, the image might be processed in order to associate a tag and/or other images with the image, and a response might be provided as a spoken reply to a mobile phone associated with a user, and a video presentation which is accessible via a high-speed connection that might be delivered to a browser functionality of a different user device.

An advertisement may be transmitted, including during any or all communication sessions. A guide, a user, a search result, a resource, a responder, an advertiser and/or a request may be rated. Rating information may be obtained from a user, a guide, an advertiser and/or an administrator of a search system. Rating information may be used to select a user, a guide, a request, a result, a responder, an advertiser, and/or any item based on information associated with an item indicated in a database. A search service may be compensated by advertising revenue. Advertising and/or content may be delivered to a user and/or a guide using any communication service associated with a user and/or a guide. An advertiser may request and obtain information regarding usage, users, demographics, affiliations, etc. associated with queries, keywords, categories, resources etc. and may submit sponsored answers and associate sponsored answers with queries based on information provided.

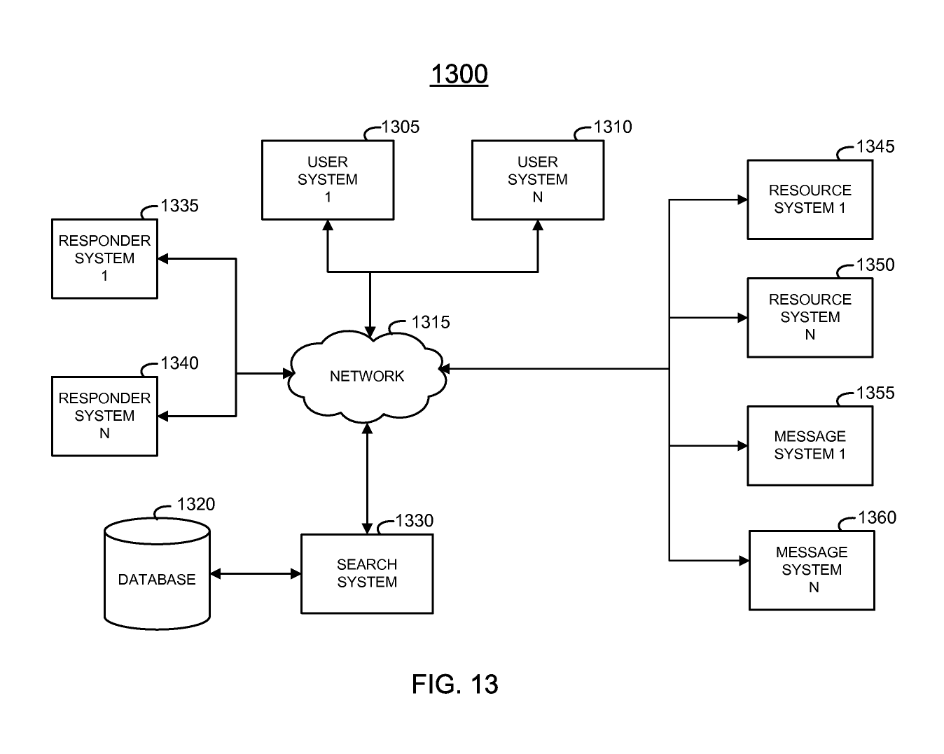

As illustrated in FIG. 13, system 1300 includes user systems 1305, 1310, a network 1315 such as the Internet, a search system 1330, a database 1320, which may comprise various records, responder systems 1335, 1340, resource systems 1345, 1350, and message systems 1355, 1360.

While only a few systems associated with a user, a resource, a message source and a responder are depicted in FIG. 13 it is within the scope of the disclosure for multiple systems for a user, resource, message and responder or guide to be utilized. In particular it is envisioned that many user, resource, message and responder systems may be implemented. The search system 1330 may be composed of many components as described further herein.

Any user system (e.g. the user system 1305) may be used, to submit a request to the search system 1330 and/or receive a result and/or other information. Any user system may receive a response, provide a response, and/or may provide compensation to the search system 1330.

The network 1315 may be a global public network of networks (i.e., the Internet) and/or may consist in whole or in part of one or more private networks and communicatively couples the user systems 1305, 1310, the responder systems 1335, 1340, the resource systems 1345, 1350 and the message systems 1355, 1360 with the other components of the system such as the search system 1330, and the database 1320. The network 1315 may include one or more wireless networks which may enable wireless communication between the various elements of the system 1300. For example, the search system 1330 may receive messages which may be routed via a wireless network controlled by a wireless service to the user systems 1305, 1310. A wireless service may receive messages from the responder systems 1335, 1340 via a wireless network which is a part of the network 1315, and provide the messages to the search system 1330 via an internet connection which is part of the network 1315. Similarly a voice communication via wired and/or wireless communication might be established between any elements of the system 1300.

The search system 1330 allows interaction to occur among the user systems 1305, 1310, the responder systems 1335, 1340, the resource systems 1345, 1350 and the message systems 1355, 1360. For example, a request can be transmitted from the user system 1305 to the search system 1330, which may provide information obtained from the database 1320, which may include an advertisement provided by the message system 1355 to the user system 1305. Similarly, a search result from a searcher operating the responder system 1335 and/or the resource system 1345 might be routed to the search system 1330, which might process the search result, formulate a response and provide a message to the user system 1305. Any type of communication between users, resources, sponsors and/or guides may be mediated and/or facilitated by the search system 1330, and/or other elements of the system 1300.

The search system 1330 is communicatively coupled with the database 1320. As will be described herein in further detail below, the database 1320 includes data that is processed in association with operation of the embodiments. Although FIG. 13 illustrates the database 1320 as a separate component of the system, the database 1320 may be integrated with the search system 1330. Further, the records maintained in the database 1320 may be stored in any typical manner, including in a Network Attached Storage (NAS), a Storage Area Network (SAN), RAID, etc., using any typical or proprietary database software such as DB2®, Informix®, Microsoft® SQLServer™, MySQL®, Oracle®, etc., and may also be a distributed database on more than one server. Elements of the database 1320 may reside in any suitable elements of the system 1300. Any or all elements of the system 1300 may include any or the entirety of the database 1320.

The user systems 1305, 1310, the responder systems 1335, 1340, the resource systems 1345, 1350, the message systems 1355, 1360 and the search system 1330 may include equipment, software, systems and personnel required to send and/or receive messages between a user system 1305, 1310, the responder systems 1335, 1340, the resource systems 1345, 1350 the message systems 1355, 1360 and/or the search system 1330 using the network 1315. The database 1320 includes information which may allow the search system 1330 to establish communication between any or all of the elements of the system 1300.

A user system, a responder system, a resource system, a message system and/or a search system may be a desktop, portable, or tablet PC or Mac®, a mobile phone, a smart phone, a PDA, a server system, a landline phone, a specialized communication terminal, a terminal connected to a mainframe, or any other communication hardware and/or system. The search system 1330 may include one or more servers, computers, etc. For example, servers such as the PowerEdge® 2900 by Dell, or the BladeCenterJS22 by IBM, or equivalent systems might be used to implement elements of the search system 1330. The search system 1330 may utilize an operating system (OS) such as Microsoft Windows XP, or Linux, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, responder systems, resource systems, message systems and/or to implement the search system 1330.

A user may be identified by the search system 1330. When a user system, such as the user system 1305, establishes a communication session with the search system 1330, an identifier of a user system is determined. An identifier of a user system may be associated with other information regarding a user. A user system may be identified using an email address, a telephone number, an IM credential, a username, and/or any other identifier which may be used to associate information with a user. Multiple identifiers of a user may be associated with each other. Using information of communication services associated with a user, a communication session may be established between a user system such as the user system 1305 and a resource system, a responder system, a message system and/or the search system 1330. Information such as a keyword, a category, a user profile, a request, a result, etc., may be associated with a user. A user may be required to provide profile information to the search system 1330. A user may elect to receive requests from the search system 1330. Parameters and/or attributes may be associated with a resource as will be further described herein below. Information of a user may be stored in the database 1320.

A responder may be required to register with the search system 1330. As part of a registration process, at least one communication method is associated with a responder. In at least one embodiment, a responder may register with the search system 1330 and establish a username and password which are associated with the responder. A responder may login to the search system 1330 using a web browser functionality of the responder system 1335 in order to communicate with the search system 1330. Multiple communication services may be associated with a guide and may allow a communication session to be established between a responder system such as the responder system 1335 and a user system, a resource system, a message system, and/or the search system 1330. Multiple identifiers of a responder may be associated with each other. Information such as IM credentials, an email address, a phone number, a URL, a username, etc., of a responder may be identified which may allow the search system 1330 to establish a communication session between a responder system and a user system, a resource system, a message system and/or the search system 1330.

When a responder registers with the search system 1330 the responder may be associated with one or more keywords, categories, profiles, and/or other information. Information associated with a responder may be stored in the database 1320 and may be used for various purposes. Information associated with a responder may be used to rank requests, resources, results, advertisements, sponsors and/or other information which may be presented to the responder. In at least one embodiment, payment information is associated with a responder. In at least one embodiment, a responder may be required to undergo testing to determine whether a responder is able to perform any tasks which may be required by the search system 1330. For example, a responder may be assigned to a role such as translator, transcriber, expediter, generalist, specialist, auditor, etc. A responder may be registered by a sponsor. A sponsor may provide compensation to a sponsored guide or responder.

A sponsor or advertiser controlling a message system may be required to register with the search system 1330. As part of a registration process, at least one communication method is associated with a sponsor. In at least one embodiment, a sponsor may register with the search system 1330 and establish a username and password which are associated with the sponsor. A sponsor may login to the search system 1330 using a web browser functionality of the message system 1355 in order to communicate with the search system 1330. Multiple communication services may be associated with a sponsor and may allow a communication session to be established between a sponsor system such as the message system 1355 and a user system, a resource system, a guide system, and/or the search system 1330. Multiple identifiers of a sponsor may be associated with each other. Information such as IM credentials, an email address, a phone number, a URL, a username, etc., of a sponsor may be identified which may allow the search system 1330 to establish a communication session between a sponsor system and a user system, a guide system, a resource system and/or the search system 1330.

When a sponsor registers with the search system 1330 the sponsor may be associated with one or more keywords, categories, profiles, and/or other information. Information associated with a sponsor may be stored in the database 1320 and may be used for various purposes. Information associated with a sponsor may be used to rank requests, resources, results, advertisements, guides and/or other information which may be presented to the sponsor and/or others. In at least one embodiment, payment information is associated with a sponsor. A sponsor may provide payment information which may be used to compensate the search system 1330 for services such as advertisements and/or sponsored answers provided to a user. A sponsor may designate a guide or responder associated with a sponsor, and may provide registration information associated with the sponsored guide. A sponsor may provide information associated with a resource. A sponsor may designate conditions for accessing a resource provided by a sponsor.

Records may be maintained in the database 1320 which may be used to record the status of various items. Such records may be used to aid the processing of requests and production of responses or answers. For example, a user may submit a request, which may describe a desired response, and provide access to information and/or materials needed to produce the response. Information indicated in a record may be combined with information in other records, and may be used to produce tables, as further described herein.

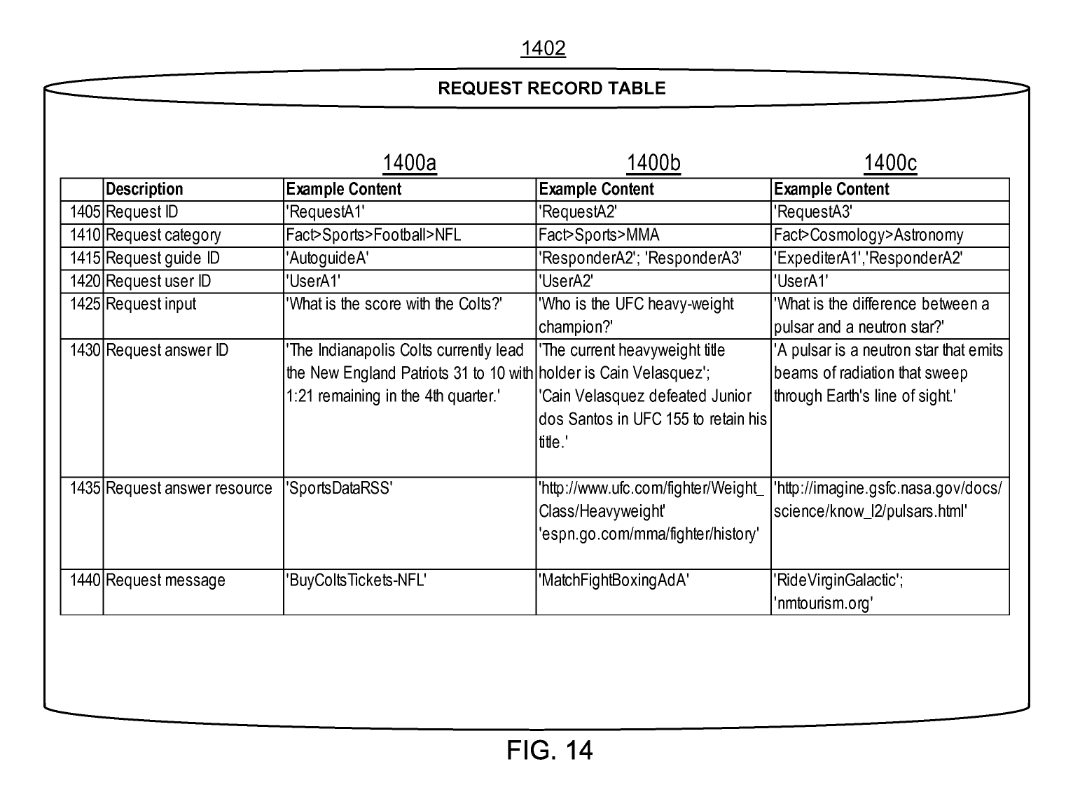

As illustrated in FIG. 14 an exemplary request record table 1402 which may comprise a number of request records is provided. One or more request records may be associated with or resident in the database 1320 (FIG. 13). The request record table 1402 may include information of requests which may be processed. Request records 1400 may include a request ID field 1405, a request category field 1410, a request guide ID field 1415, a request user ID field 1420, a request input field 1425, a request answer ID field 1430, a request answer resource field 1435, and a request message field 1440.

The request ID field 1405 includes an identifier of a request which is preferably unique and is preferably used consistently. A request ID serves to distinguish a request record associated with a request from a request record associated with other requests. Any number of characters, numbers, and/or other indicators may be used to indicate a request ID. In at least one embodiment, a request ID associated with a request is included in the request ID field 1405. In at least one embodiment, a random number is indicated in the request ID field 1405. Using the example in FIG. 14, ‘RequestA1’ is the request ID associated with the request record 1400a.

The request category field 1410 may include information of a category associated with a request. Information indicated in the request category field 1410 may be used to select an item associated with a request. For example, a category associated with a request may be used to rank guides who may be associated with a type of request. Likewise, a category associated with a request may be used to rank resources, requests and/or other items which may be presented to a guide or responder. A category or type associated with a request may be determined based on factors such as keywords of a query, a profile of a user, a selection of a guide, a user history, etc. A category associated with a system taxonomy may be indicated in the request category field 1410. A category may be associated with a request automatically and/or using the assistance of a person. Using the example in FIG. 14, ‘RequestA2’ may be categorized as ‘Fact>Sports>MMA’ as indicated in the request record 1400b. This may indicate that a person or item associated with the category ‘Fact>Sports>MMA’ may have a higher ranking for responding to ‘RequestA2’. A category of a request may be associated with a user submitting the request. Content of a request such as a keyword, named entity, etc. may be used to assign a category or type to a request.

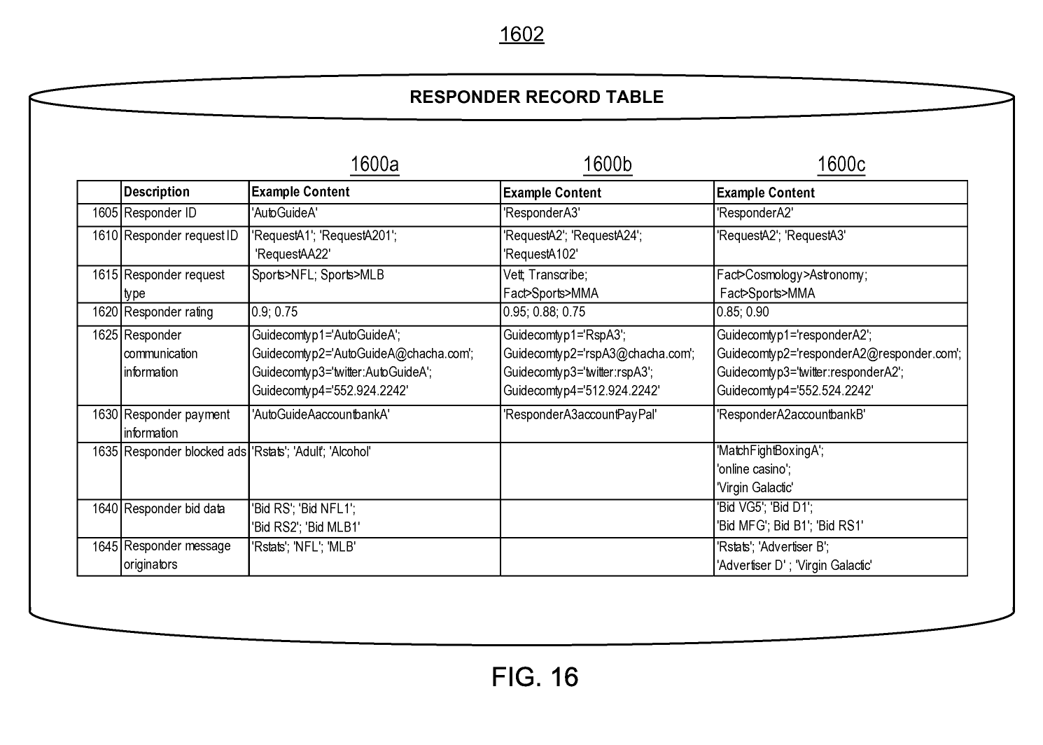

The request guide ID field 1415 may include information of a number of guides associated with a request. Content of the request guide ID field 1415 may be used to obtain information of a guide or responder using a record such as the record illustrated in FIG. 16. If a person is selected for a request, elects to receive a request, provides a response to a request, reviews a result of a request and/or completes a request, an identifier of the person may be indicated in the request guide ID field 1415. Using the example in FIG. 14, ‘ResponderA2’ and ‘ResponderA3’ are associated with ‘RequestA2’. This may for example indicate that ‘RequestA2’ has been responded to by ‘ResponderA2’ and ‘ResponderA3’.

The request user ID field 1420 may include information of a number of users associated with a request. Content of the request user ID field 1420 may be used to obtain information of a user associated with a request. For example, if a request is submitted by a user, an identifier of the user may be indicated in the request user ID field 1420. A request may not be associated with a user request. For example, the search system 1330 (FIG. 13) may provide requests to persons which are not directly related to a user request. The search system 1330 may provide a request to a searcher or responder based on a selection of the request by a sponsor. Using the example in FIG. 14, ‘UserA1’ is associated with ‘RequestA1’ and ‘RequestA3’ and ‘UserA2’ is associated with ‘RequestA2’. This may indicate that ‘RequestA1’ and ‘RequestA3’ were submitted by ‘UserA1’ while ‘RequestA2’ was submitted by ‘UserA2’.

The request input field 1425 may include information of a request. Content of the request input field 1425 may be provided to a person who accepts a request. Content of the request input field 1425 may include any type of information. For example, a pointer to audio, video, text, and/or other media may be indicated in the request input field 1425. As illustrated in FIG. 14, the query “What is the difference between a pulsar and a neutron star?” is the request input associated with ‘RequestA3’, as indicated in the request record 1400c. In at least one embodiment, the request input field 1425 may indicate an original user request, a categorization, and a rewritten user request.

The request answer ID field 1430 may include information of a response associated with a request. Content of the request answer ID field 1430 may be provided responsive to a request. Content of the request answer ID field 1430 may be stored in the database 1320 (FIG. 13). Content of the request answer ID field 1430 may be reviewed and/or rated by a user, a guide, a responder and/or an administrator. As illustrated in FIG. 14, the response ‘A pulsar is a neutron star that emits beams of radiation that sweep through Earth's line of sight.’ is associated with ‘RequestA3’ as illustrated in the request record 1400c. While a text response to a query is used for the purposes of illustration, any type of media may be indicated in the request answer ID field 1430. In at least one embodiment, a text response and a URL associated with a source of the text response may be indicated in the request answer ID field 1430.

The request answer resource field 1435 may include information of a number of search resources associated with a request. Content of the request answer resource field 1435 may be used to provide a search result. For example, a guide may cut a snippet of text from a web page in order to create a response to a request. A resource used by a responder and/or other information relating to a source of a response may be indicated in the request answer resource field 1435. Content of the request answer resource field 1435 may be produced automatically and/or using the assistance of a person. Using the example in FIG. 14, the resources <<http://www.ufc.com/fighter/Weight_Class/Heavyweight>> and <<espn.go.com/mma/fighter/history>> are associated with ‘RequestA2’. This may indicate that the answers indicated in the request answer ID field 1430 were produced using those resources.

The request message field 1440 may include information of a message associated with a request. Content of request message field 1440 may be used for various purposes. For example, a pointer to a message record indicated in the request message field 1440 may indicate a message which is to be delivered with a response to a request. A number of requests may be indicated in the request message field 1440, and a ranking of messages may be used to determine which request messages may be delivered responsive to a request and/or an order, location, etc.in which messages may be presented. A message indicated in the request message field 1440 may affect a response which is provided to a request. For example, if a highest ranking message is associated with blocking of a responder or response, a ranking of a response indicated in the request answer ID field 1430 may be modified. As illustrated by the request record 1400b, the request message ‘MatchFightBoxingAd’ is associated with the ‘RequestA2’ which may affect whether answers indicated in the request answer ID field 1430 are presented responsive to ‘RequestA2’. For example, if a sponsor associated with ‘MatchFightBoxingAd’ is associated with a resource from which an answer is obtained, the answer may be ranked higher.

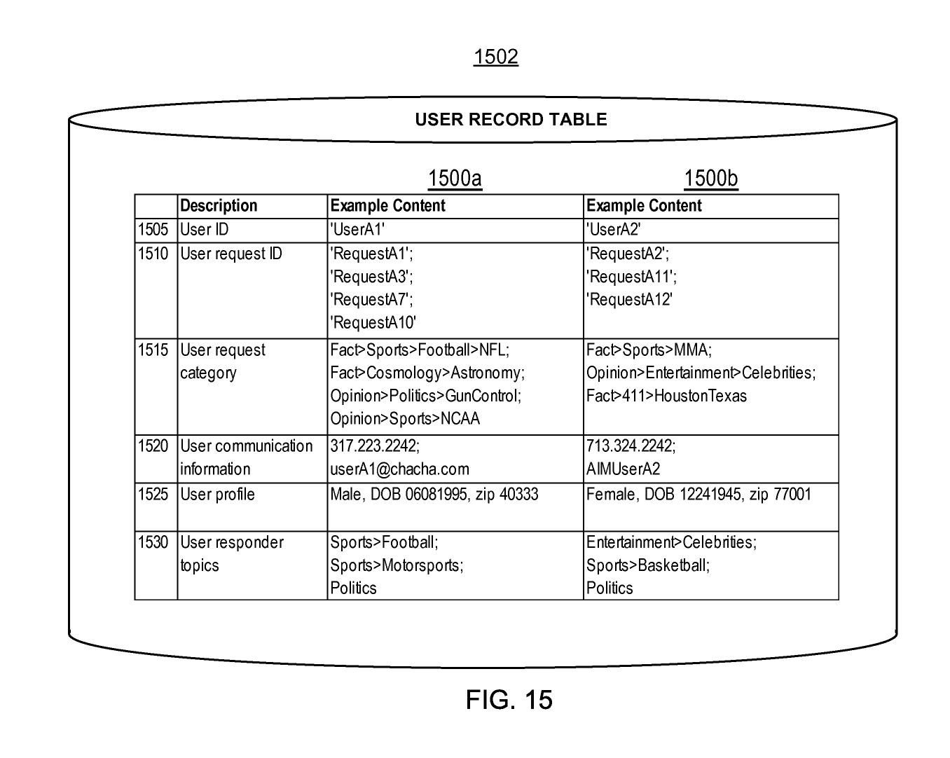

As illustrated in FIG. 15 an exemplary user record table 1502, which may comprise a number of user records is provided. One or more user records may be associated with or resident in the database 1320 (FIG. 13). The user record table 1502 may include information of users. User records 1500 may include a user ID field 1505, a user request ID field 1510, a user request category field 1515, a user communication information field 1520, a user profile field 1525, and a user responder topics field 1530.

The user ID field 1505 includes an identifier of a user which is preferably unique and is preferably used consistently. A user ID serves to distinguish a user record associated with a user from a user record associated with other users. Any number of characters, numbers, and/or other indicators may be used to indicate a user ID. In at least one embodiment, a random number is indicated in the user ID field 1505. Using the example in FIG. 15, ‘UserA1’ is the user ID associated with the user record 1500a.

The user request ID field 1510 may include information of a number of requests associated with a user. A user request ID may be for example a pointer to a request record associated with a request submitted by a user. If a user submits a request, a request ID may be added to the user request ID field 1510. Using the example illustrated in FIG. 15, ‘RequestA2’, ‘RequestA11’ and ‘RequestA12’ are associated with ‘UserA2’ as indicated in the user record 1500b. This may indicate that ‘UserA2’ has submitted ‘RequestA2’, ‘RequestA11’ and ‘RequestA12’.

The user request category field 1515 may include information regarding a category or type associated with a user request. For example, if a request is directed to a type of processing or a category, etc., a type and/or category associated with the processing may be indicated in the user request category field 1515. In at least one embodiment, the user request ID field 1510 and the user request category field 1515 are linked by for example a pointer. In at least one embodiment, a category associated with a request of a user may affect whether a message will be provided. An affiliation of a user may affect a category associated with a request of a user.

The user communication information field 1520 may include information of a number of communication services associated with a user. Any information which may be used to establish communication with a user may be indicated in the user communication information field 1520. For example, a telephone number, an email address, an IM credential, a URL, a username, a password, and/or other communication information may be indicated in the user communication information field 1520. Using the example in FIG. 15, the phone number ‘317.223.2242’ and the email ‘userA1@chacha.com’ are associated with ‘UserA1’.

The user profile field 1525 may include information of a profile associated with a user. For example, demographic, geographic, affiliation, personality, and/or other types of anthropic and/or other characteristic information may be associated with a user. A user may provide profile information as part of a registration process. User profile information may be obtained from a database provided by a third party. User profile information may be determined based on a test, polling, query history, peer review, and/or other information associated with a user. Using the example illustrated in FIG. 15, ‘Female, DOB 12241945, zip 77001’ are associated with ‘UserA2’. Profile information may be used to match information provided by a user to other information. For example, a ranking of a guide for a query of a user may be adjusted based on a profile associated with the user. An answer and/or a message might be modified based on geographic, demographic, etc., profile information of a user.

The user responder topics field 1530 may include information of responder topics associated with a user. The user responder topics field 1530 may include information of topics, types, keywords, categories, etc., which may be used to direct a request or task to a user. For example the user responder topics associated with ‘UserA2’ in user record 1500b are ‘Entertainment>Celebrities’; ‘Sports>Basketball’; and ‘Politics’. This may indicate that ‘UserA2’ has responded to and/or may be interested in responding to requests and/or items associated with those topics.

As illustrated in FIG. 16 an exemplary responder record table 1602 which may comprise a number of responder records is provided. One or more responder records may be associated with or resident in the database 1320 (FIG. 13). The responder record table 1602 (FIG. 16) may include information of responders. Responder records 1600 may include a responder ID field 1605, a responder request ID field 1610, a responder request type field 1615, a responder rating field 1620, a responder communication information field 1625, a responder payment information field 1630, a responder blocked ads field 1635, a responder bid data field 1640, and a responder message originators field 1645.

The responder ID field 1605 includes an identifier of a responder which is preferably unique and is preferably used consistently. A responder ID serves to distinguish a responder record associated with a responder from a responder record associated with other responders. Any number of characters, numbers, and/or other indicators may be used to indicate a responder ID. In at least one embodiment, a random number is indicated in the responder ID field 1605. In at least one embodiment, a pseudonym selected by a responder may be indicated in the responder ID field 1605. Using the example in FIG. 16, ‘AutoGuideA’ is the responder ID associated with the responder record 1600a. A responder ID may be a user ID.

The responder request ID field 1610 may include information of a number of requests associated with a responder. Content of the responder request ID field 1610 may be used to obtain information of a request. For example, if a user request has been determined to require a number of requests to be performed, the search system 1330 (FIG. 1) may assign a unique ID to the requests and may distribute information of the requests to responders. Using the example in FIG. 16, ‘RequestA2’, ‘RequestA24’, and ‘RequestA102’ are associated with ‘ResponderA3’ as indicated in the responder record 1600b. This may indicate that ‘ResponderA3’ has expedited or handled ‘RequestA2’, ‘RequestA24’ and ‘RequestA102’.

The responder request type field 1615 may include information of a number of types of requests which may be processed by a responder. For example, a category and/or keyword associated with a request, a type of request, temporal information associated with a request, etc., which may be used to determine if a responder is to be presented with a request may be indicated in the responder request type field 1615. In at least one embodiment, a responder may be assigned to a particular type of request as part of a registration process. A responder may select a type of request which the responder may perform. A responder may be required to pass a test in order to be associated with a type of request. A responder may be assigned to a role such as expediter, searcher, etc., which may be indicated in the responder request type field 1615. A request indicating a keyword may be directed to a responder. Using the example in FIG. 16, ‘ResponderA3’ is associated with the types ‘Vett’, ‘Transcribe’, and ‘Fact>Sports>MMA’. This may for example indicate that ‘ResponderA3’ may be presented with and/or selected to respond to requests indicating those categories and/or types.

The responder rating field 1620 may include information of a number of ratings associated with a responder. For example, quality, speed, peer review, etc., may be used to determine a rating of a responder. A rating of a responder may be used for purposes such as determining compensation for the responder (e.g. bonus points), selecting a responder to respond to a request, matching a request to a responder, etc. In at least one embodiment, the responder request type field 1615 and the responder rating field 1620 may be linked by, for example, a pointer. Using the example in FIG. 16, ‘ResponderA2’ has a rating of ‘0.85’ associated with ‘Fact>Cosmology>Astronomy’, and a rating of ‘0.90’ associated with ‘Fact>Sports>MMA’ as indicated by the responder record 1600c. A rating may be used to rank ‘ResponderA2’ versus other responders associated with the request types ‘Fact>Cosmology>Astronomy’ and ‘Fact>Sports>MMA’.

The responder communication information field 1625 may include information of a number of communication services associated with a responder. For example, a user name and password, an email address, an IM credential, a phone number, a web page, a physical address, etc., may be indicated in the responder communication information field 1625. Using the example illustrated in FIG. 16, ‘AutoGuideA’ is associated with the login ID ‘AutoGuideA’, the email ‘AutoGuideA@chacha.com’, the Twitter account ‘twitter.AutoGuideA’, and the phone number ‘552.924.2242’. This may indicated that ‘AutoGuideA’ may be contacted using the associated communication services.

The responder payment information field 1630 may include information of a payment method associated with a responder. For example, banking information, a PayPal® account, a Western Union® account, etc., may be indicated in the responder payment information field 1630. Content of the responder payment information field 1630 may be used to provide compensation to a responder. For example, payment may be made by Automated Clearing House (ACH), wire transfer, etc., using information indicated in the responder payment information field 1630. As indicated in FIG. 16, the responder ‘ResponderA3’ is associated with ‘ResponderA3accountPayPal’.

The responder blocked ads field 1635 may include information of ads a responder may block. A responder may block advertisements associated with a keyword, category, topic, advertiser, sponsor, profile, etc. For example, if a responder has replied to a query including the keyword word ‘cars’ an advertisement ranked highest for the keyword ‘cars’ might be blocked when a response to a query originates from a responder that has blocked an advertiser associated with the advertisement, but may be displayed when a response indicating ‘cars’ does not originate with a responder. A responder may block ads which may not relate to topics a responder may be interested in. For example, a responder may block ads associated with categories which the responder does not wish a response indicating the responder to be associated with. A responder and/or an advertiser may provide and/or select names of competitors who may be blocked. For example if a car maker responded to a query, the car maker might elect to block ads originating from competitors from being provided when a response of the car maker is displayed. As illustrated in FIG. 16, ‘AutoGuideA’ may have blocked ads originating from Rstats' and ads categorized as ‘Adult’ and ‘Alcohol’ related from being incorporated in responses including a response of ‘AutoGuide’ as indicated in the responder blocked ads field 1635 of the responder record 1600a.

The responder bid data field 1640 may include information of a number of bids associated with a responder. An advertiser and/or a responder may submit a bid which may be considered in selection of a message or an advertisement. For example, if a bid of an advertiser on a blocked list of a responder exceeds a bid by the responder by a predetermined amount, percentage, etc. an advertisement of an advertiser may be presented. Similarly, a bid associated with a topic, type or keyword may influence a ranking of an advertisement or other message associated with an item. In at least one embodiment, a bid may be associated with a type indicated in the responder request type field 1610. A ranking of an advertisement may be influenced by a bid associated with an advertisement. As illustrated in FIG. 16, ‘Bid VG5’ and ‘Bid D1’ may be associated with the type ‘Fact>Cosmology>Astronomy’ as indicated by the responder record 1600c. However, ‘Bid VG5’ may originate from the blocked advertiser ‘Virgin Galactic’, in which case an advertisement associated with ‘Advertiser B’ might be presented.

The responder message originators field 1645 may include information regarding an originator of a message. A message may originate from an advertiser and/or a responder. A message may be sent to a responder if a condition is met. For example, if an advertisement associated with a request has a higher bid than another advertisement, but a responder has requested to block a message originator associated with the advertisement, a responder may be presented with advertisements and/or other information in order to decide whether an advertisement will be provided. As illustrated in FIG. 16, ‘Rstats’; ‘Advertiser B’; ‘Advertiser D’; and ‘Virgin Galactic’ are associated with ‘ResponderA2’ in responder record table 1600c, which may indicate that bids have been received from those originators. In at least one embodiment, an advertiser may elect to bid based on a responder. For example, if a responder has a low rating for a category, no bid may be made for messages to be delivered including responses of a responder. As illustrated in FIG. 16, ‘ResponderA3’ has a rating of 0.75 associated with ‘Fact>Sports>MMA’ and no responder bid data is present in the responder bid data field 1640 of the responder record 1600b. This may permit an advertiser or content provider to control quality of answers with which content is presented.

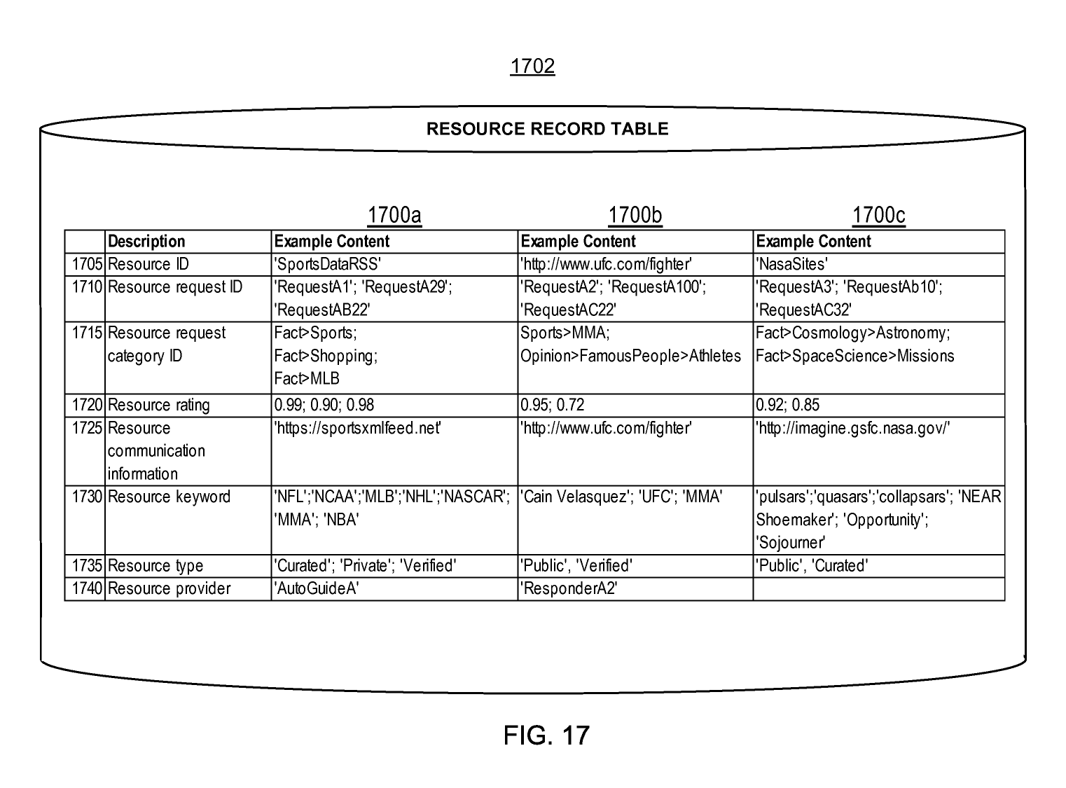

As illustrated in FIG. 17 an exemplary resource record table 1702 which may comprise a number of resource records is provided. One or more resource records may be associated with or resident in the database 1320 (FIG. 13). The resource record table 1702 (FIG. 17) may include information of resources. Resource records 1700 may include a resource ID field 1705, a resource request ID field 1710, a resource request category ID field 1715, a resource rating field 1720, a resource communication information field 1725, a resource keyword field 1730, a resource type field 1735, and a resource provider field 1740.

The resource ID field 1705 includes an identifier of a resource which is preferably unique and is preferably used consistently. A resource ID serves to distinguish a resource record associated with a resource from a resource record associated with other resources. Any number of characters, numbers, and/or other indicators may be used to indicate a resource ID. Using the example in FIG. 17, ‘SportsDataRSS’ is the resource ID associated with the resource record 1700a. This may indicate that ‘SportsDataRSS’ has been used to produce a search result, and is accessible to a guide.

The resource request ID field 1710 may include information of a number of requests associated with a resource. Content of the resource request ID field 1710 may be used to obtain information of a request. For example, if a resource has been used to respond to a request, an identifier of the request may be indicated in the resource request ID field 1710. Using the example in FIG. 17, ‘RequestA2’, ‘RequestA100’ and ‘RequestAC22’ are associated with the resource <<http://www.ufc.com/fighter>> as indicated in the resource record 1700b. This may indicate that <<http://www.ufc.com/fighter>> has been utilized to respond to ‘RequestA2’, ‘RequestA100’ and ‘RequestAC22’.

The resource request category ID field 1715 may include information of a number of categories of requests which may be processed by a resource. For example, a category and/or keyword associated with a request, a type of request, profile, etc., which may be used to determine if a resource is to be presented to a guide for a request may be indicated in the resource request category ID field 1715. In at least one embodiment, a resource may be assigned to a category of request as part of a registration process. A resource may be associated with a user, a group of users, an access right, an advertiser or sponsor, etc. A provider of a resource may select a type and/or category of request for which the resource may be used and/or required. A resource may be associated with a category based on a selection by an administrator, based on success rates of obtaining or providing answers, etc. Using the example in FIG. 17, ‘NasaSites’ is associated with the categories ‘Fact>Cosmology>Astronomy’ and ‘Fact>SpaceScience>Missions’ as indicated by the resource record 1700c.

The resource rating field 1720 may include information of a number of ratings associated with a resource. For example, a rating of a resource may be based on ratings of answers produced using the resource, a contractual agreement, an affiliation, temporal information such as time spent by guides, etc. A rating of a resource may be used to select a resource which is provided to a searcher or guide or responder, to rank a response associated with a resource, etc. In at least one embodiment, the resource request category ID field 1715 and the resource rating field 1720 may be linked by, for example, a pointer. Using the example in FIG. 17, SportsDataRSS' has a rating of ‘0.99’ associated with ‘Fact>Sports’, a rating ‘0.90’, associated with ‘Fact>Shopping’ and a rating of 0.98 associated with ‘Fact>MLB’ which may indicate a probability that ‘SportsDataRSS’ may produce an acceptable response for those categories. A resource may have a rating corresponding to various categories, types of information, types of tasks, keywords, etc.

The resource communication information field 1725 may include information of a number of communication services associated with a resource. For example, a user name and password, an email address, an IM credential, a phone number, a web page, a physical address, etc., may be indicated in the resource communication information field 1725. A communication service indicated in the resource communication information field 1725 may for example be used to indicate a service by which a resource may be accessed. Using the example illustrated in FIG. 17, the URL <<http://imagine.gsfc.nasa.gov/>> is associated with ‘NasaSites’. This may indicate that a query associated with ‘Fact>Cosmology>Astronomy’ may be submitted to that URL by for example an API and/or that the resource may be processed to obtain an answer and/or presented to a responder.

The resource keyword field 1730 may include information of a number of keywords associated with a resource. A match to a keyword indicated in the resource keyword field 1730 may affect a probability that a request will receive a response associated with a resource. For example, a match may prohibit a query from receiving a result from a resource, may increase a ranking of a resource, may be used to associate a category with a request, may identify a resource to be provided to a guide, etc. In at least one embodiment, keywords included in requests for which a resource has provided an answer may be more highly ranked for a category associated with the query and the resource. A responder may select keywords associated with a resource provided by the responder.

The resource type field 1735 may include information of a number of types or characteristics associated with a resource. A type may include an indication of an access right, a commercial arrangement, a preference, quality of content, source of content, etc. A searcher or responder may elect to associate a resource with a type. A system administrator may associate a type with a resource. A provider of a resource may designate a type associated with the resource for example as part of a registration process. Using the example in FIG. 17, ‘SportsDataRSS’ is a ‘Verified’, ‘Private’, ‘Curated’ resource. This may indicate that content of the resource is controlled, that the resource is not accessible to the general public, and that the content of the resource is verified to be correct.

The resource provider field 1740 may include information of a provider of a resource. A resource may be provided by any number of advertisers and/or responders. As illustrated in FIG. 17, ‘ResponderA2’ is the resource provider associated with <<http://www.ufc.com/fighter>> as indicated by the resource record 1700b.

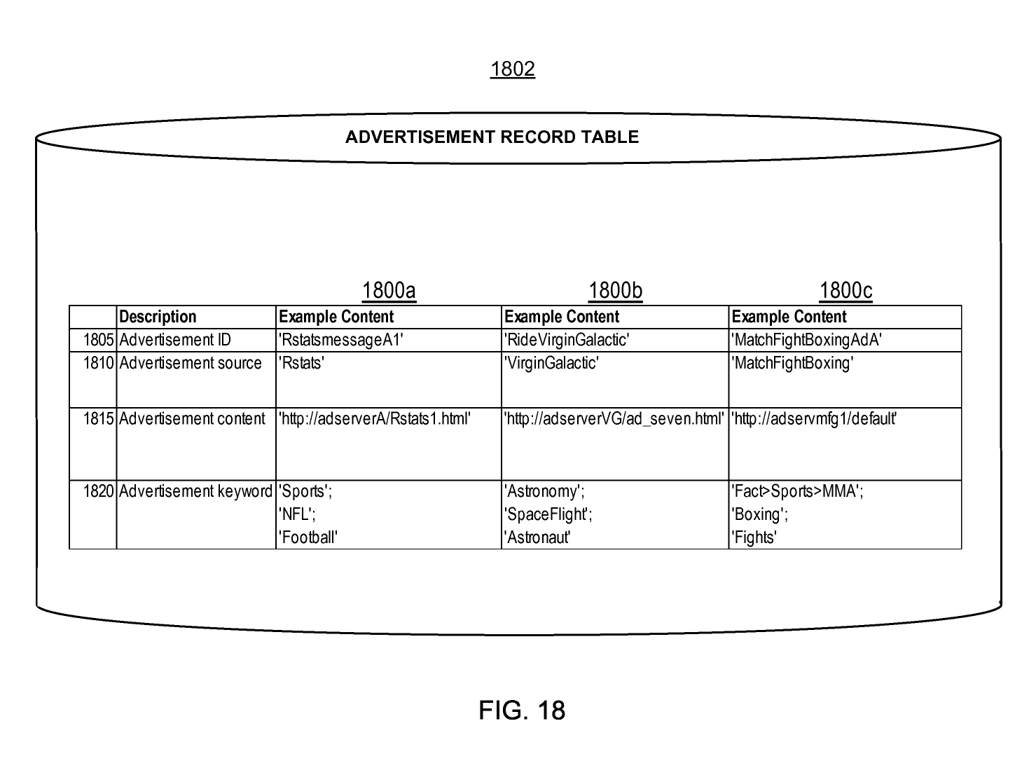

As illustrated in FIG. 18 an exemplary advertisement record table 1802 which may comprise a number of advertisement records is provided. One or more advertisement records may be associated with or resident in the database 1320 (FIG. 13). The advertisement record table 1802 (FIG. 18) may include information of advertising messages. Advertisement records 1800 may include an advertisement ID field 1805, an advertisement source field 1810, an advertisement content field 1815, and an advertisement keyword field 1820.

The advertisement ID field 1805 includes an identifier of an advertisement which is preferably unique and is preferably used consistently. An advertisement ID serves to distinguish an advertisement record associated with an advertisement from an advertisement record associated with other advertisements. Any number of characters, numbers, and/or other indicators may be used to indicate an advertisement ID. Using the example in FIG. 18, ‘Rstats messageA1’ is the advertisement ID associated with the advertising message record 1800a.

The advertisement source field 1810 may include information about a source of an advertisement. An advertisement may come from any number of businesses, companies and/or responders. For example, ‘VirginGalactic’ is the source of the advertisement ‘RideVirginGalactic’ as indicted by the advertisement source field 1810 of the advertisement record 1800b.

The advertisement content field 1815 may include information about content of an advertisement. An advertisement content may be indicated as a URL and/or a link for viewing. For example, ‘MatchFightBoxingAd’ may be an advertisement which may be obtained from a server at <http://adservmfg1/default>>. The advertisement content field 1815 may include security information such as an API key, etc. which may be required to access an advertisement. An advertisement may include any media and may be obtained from sources such as responders, advertisers, ad servers, etc.

The advertisement keyword field 1820 may include information of a number of keywords associated with an advertisement. A keyword may be present which may correlate to an advertisement, and may be used for various purposes such as ranking, rating, and/or bidding regarding an advertisement. An advertisement may be selected and/or blocked based on a keyword provided by an advertiser and/or responder. As illustrated in FIG. 18, ‘Fact>Sports>MMA’; ‘Boxing’ and ‘Fights’ are keywords associated with the advertisement ‘MatchFightBoxingAd’, as indicated by the advertisement keyword field 1820 of the advertisement record 1800c. This may indicate the ad ‘MatchFightBoxingAd’ may be selected, ranked, etc. when the keywords ‘Fact>Sports>MMA’, ‘Boxing’ and/or ‘Fights’ are indicated in a query.

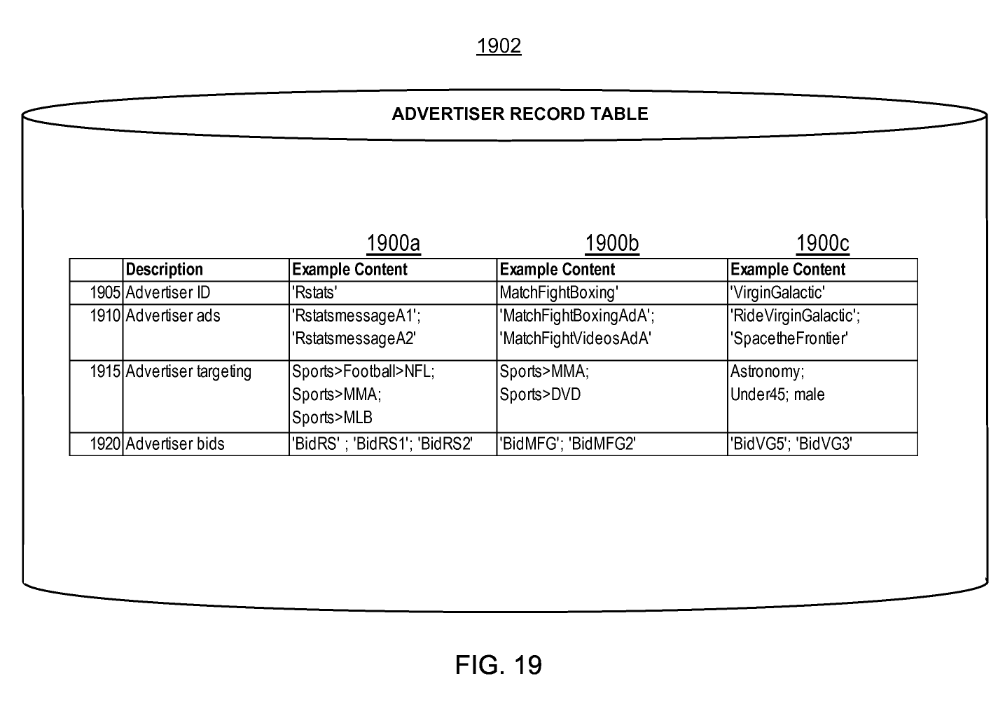

As illustrated in FIG. 19 an exemplary advertiser record table 1902 which may comprise a number of advertiser records is provided. One or more advertiser records may be associated with or resident in the database 1320 (FIG. 13). The advertiser record table 1902 (FIG. 19) may include information of advertisers. Advertiser records 1900 may include an advertiser ID field 1905, an advertiser ads field 1910, an advertiser targeting field 1915, and an advertiser bids field 1920.

The advertiser ID field 1905 includes an identifier of an advertiser which is preferably unique and is preferably used consistently. An advertiser ID serves to distinguish an advertiser record associated with an advertiser from an advertiser record associated with other advertisers. Any number of characters, numbers, and/or other indicators may be sued to indicate an advertisement ID. Using the example in FIG. 19, Rstats' is the advertiser ID associated with the advertising message record 1900a.

The advertiser ads field 1910 may include information of a number of ads associated with an advertiser. Any number of advertisements may be associated with an advertiser. An advertiser may be an agent, who may provide advertisements from various sources such as entities and/or individuals. As illustrated in FIG. 19, ‘MatchFightBoxingAdA’ and ‘MatchFightVideosAdA’ are ads associated with ‘Match Fight Boxing’ as indicated by the advertiser ads field 1910 of the advertiser record 1900b.

The advertiser targeting field 1915 may include information of targeting information for ads. For example, an advertiser may direct ads to users and/or responders based on content of the advertiser targeting field 1915. An advertiser may target a responder based on a topic, category, profile, type, and/or keyword. An advertiser may wish to target a particular audience in order to have a more effective response to an advertisement. An advertisement viewed by interested individuals may have better responses than an advertisement viewed by uninterested individuals. For example the advertiser ‘VirginGalactic’ may target the category ‘Astronomy’ with the advertisement ‘RideVirginGalactic’ and the profile ‘Under45’; and ‘male’ with the advertisement ‘SpacetheFrontier’ as indicated by the advertiser targeting field 1915 of the advertiser record 1900c. Content of the advertiser targeting field may be used to rate and/or rank items which may be provided responsive to a request and/or to a responder. An advertiser ranking may affect a ranking of an advertisement associated with an advertiser.

The advertiser bids field 1920 may include information of a number of bids of an advertiser. An advertiser may be associated with an item such as a category, a keyword, a type, a profile, a responder, a guide, an affiliation, or any other data indicated in the database 1320 (FIG. 13). The advertiser targeting field 1915 and the advertiser bid field 1920 may be linked by for example a pointer. Using the example illustrated in FIG. 19, ‘MatchFightBoxingA’ may have bid ‘BidMFG’ for items associated with ‘Sports>MMA’ and ‘BidMFG2’ for items associated with ‘Sports>DVD’. A bid associated with an item may influence a ranking of items such as advertisements associated with a query and the item.

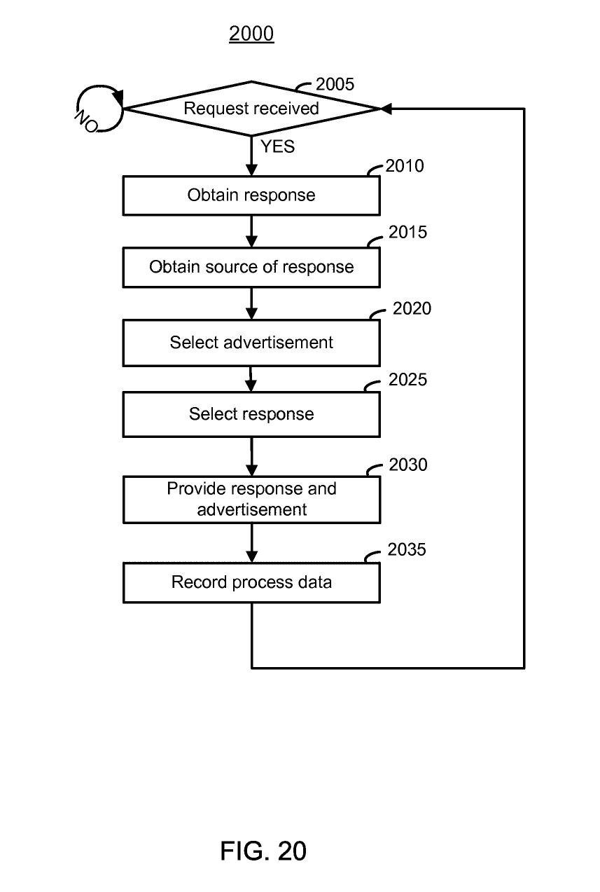

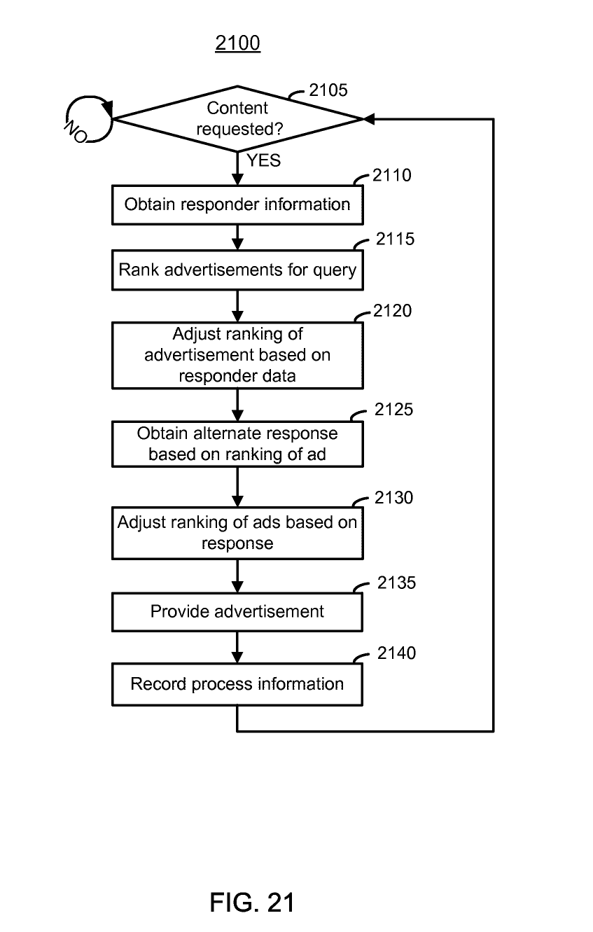

As illustrated in FIG. 20, a process 2000 for responding to a request is provided. The process 2000 may be performed in whole or in part by any suitable element of the system 1300 (FIG. 13). In at least one embodiment, the process 2000 is operative on a server associated with the search system 1330. A request may be a request for an automated answer, a human assisted answer and/or a combination thereof. The process 2000 may be incorporated with a process such as the process 2100 (FIG. 21).

In operation 2005 (FIG. 20) a determination is made as to whether a request is received. If it is determined in operation 2005 that a request is not received, control remains at operation 2005 and process 2000 continues. If it is determined in operation 2005 that a request is received, control is passed to operation 2010 and process 2000 continues.

The determination in operation 2005 may be made using various criteria. In at least one embodiment, if a message is received at a system associated with the search system 1330 (FIG. 13), it may be determined that a request is received. For example, if an email message, an SMS, EMS, and/or MMS message, an IM, an IP message, and/or a voice message is received at an address associated with the search system 1330, it may be determined that a request is received. If a message is received at a server associated with the search system 1330, it may be determined that a request is received.

In operation 2010 a response is obtained. A response may be obtained programmatically using a database, software application, stored information, etc. A response may be obtained from a resource. For example, a query may be submitted to a resource, a responder may select media provided by a resource and may obtain a response from a resource, etc. An answer or response may be obtained by directing a task to a guide or responder. Any number of responses may be obtained. Control is passed to operation 2015 and process 2000 continues.

In operation 2015 a source of a response is obtained. For example, a responder providing a response, a resource associated with a response, a guide, a user, an advertiser or sponsor, etc., that has provided an answer may be determined. Stored information regarding a response may be used to obtain a source of a response. Any number of sources may be associated with a response. Control is passed to operation 2020 and process 2000 continues.

In operation 2020 an advertisement is selected. An advertisement may be selected based on various factors. An advertisement may be selected based on ranking of advertisements. Advertisements may be ranked based on ratings and/or bids and a highest ranking advertisement may be selected. An advertisement may be selected based on geographic location, and/or demographic information. Any number of factors may be considered in order to select an advertisement. Control is passed to operation 2025 and process 2000 continues.

In operation 2025 a response is selected. A response may be selected based on various factors. In one embodiment a response may be selected because it is highest ranking response. A response may be selected based on an advertisement and/or a responder associated with a response. For example, if an advertisement is selected and an advertiser has blocked a particular responder, an answer or response may be selected which does not originate from the responder. Control is passed to operation 2030 and process 2000 continues.

In operation 2030 a response and an advertisement are provided. Any number of responses and/or advertisements may be provided. A ranking of responses and/or advertisements may be provided. A response and/or advertisement may be provided in any suitable form. For example, an advertisement and a response may be provided as a pointer to a location from which the response and the advertisement may be obtained. A number of responses and/or advertisements may be presented in an order based on a ranking of an advertisement and/or response. A response and an advertisement may be provided to a requesting system which may not cause the response and the content to be provided to a user. Control is passed to operation 2035 and process 2000 continues.

In operation 2035, process data is recorded. Data of a request, an answer, a resource, a user, a sponsor, a guide, a rating, a ranking, an advertisement, etc. may be recorded. A stored response may be rated, ranked, or deleted. Usage and compensation associated with an answer and/or an advertisement may be recorded. In at least one embodiment, process data is recorded in the database 1320 (FIG. 13). Control is passed to operation 2005 and process 2000 continues.

As illustrated in FIG. 21, a process 2100 for providing content is provided. The process 2100 may be performed in whole or in part by any suitable element of the system 1300 (FIG. 13). In at least one embodiment, the process 2100 is operative on a server associated with the search system 1330. The process 2100 may be employed as an element of the process 2000 (FIG. 20).

In operation 2105 (FIG. 21) a determination is made as to whether content is requested. If it is determined in operation 2105 that content is not requested, control remains at operation 2105 and process 2100 continues. If it is determined in operation 2105 that content is requested, control is passed to operation 2110 and process 2100 continues.

The determination in operation 2105 may be made using various criteria. In at least one embodiment, if a message is received at a system associated with the search system 1330 (FIG. 1), it may be determined that content is requested. For example, if a request for an ad as a URL, webpage or any other form of ad is received at an address associated with the search system 1330, it may be determined that content is requested. If a message is received at a server associated with the search system 1330, it may be determined that content is requested.

In operation 2110 responder information is obtained. Information of a responder may be obtained based on a content request. For example, a responder associated with an answer may be identified in a request for an advertisement or content. Control is passed to operation 2115 and process 2100 continues.

In operation 2115 advertisements for a query are ranked. Advertisements or content may be ranked based on any number of factors. An advertisement may be ranked based on a rating of the advertisement related to keywords, topics and/or categories. For example, a click through ratio observed when an ad is served responsive to a targeting parameter may be used to rank an advertisement for a parameter. Advertisements may also be ranked based on an action of a responder regarding an advertisement. For example, if a responder is presented with a list of advertisements an advertisement selected by a responder may have a higher rating or ranking, which may increase a probability that an advertisement will be selected. A bid associated with an advertisement may be used to rank an advertisement. Control is passed to operation 2120 and process 2100 continues.

In operation 2120 a ranking of an advertisement based on responder data is adjusted. For example, if a responder associated with a response has blocked an advertiser, a ranking of an advertisement associated with the advertiser may be reduced. A responder may block an advertisement giving an advertisement a lower rating than another advertisement which is not blocked by a responder. A ranking of a responder may affect a ranking of an advertisement. For example, if a low ranking responder elects to block an advertisement, a reduction in rank of an advertisement may be decreased. Similarly, if a responder has elected to block advertisements associated with a targeting parameter such as a keyword, profile, or category a ranking of an advertisement associated with the category may be reduced or adjusted. Any suitable combination of parameters associated with a responder and/or content may be used to adjust a ranking of an advertisement based on responder data. Control is passed to operation 2125 and process 2100 continues.

In operation 2125 alternate responses based on a ranking of ads are obtained. If an advertisement has a high ranking, a high bid, etc., a response associated with a responder that has not blocked the advertisement may be obtained. A response to a query which has a lower ranking may be provided with an ad which has a high ranking which would be blocked by a higher ranking response. See for example the request record 1400b (FIG. 14) wherein an alternate response may be selected based on a blocking of ‘MatchfightboxingAdA’ by ‘ResponderA2’. An alternate response may be obtained from stored information and/or a responder. Control is passed to operation 2130 and process 2100 continues.

In operation 2130 a ranking of an ads based on a response is adjusted. A ranking of an ad may be adjusted based on factors such as a number of responses obtained for a request, a rating of responses and/or responders associated with a request, a decision of a responder, etc. For example a response may be ranked highly, may be a sole available response, may have a high bid associated with blocking, may have a high quality rating, or other factors which may cause a rating of an ad to be adjusted. An ad that may not have been presented may be ranked more highly to be used in a future response than an ad that was presented and vice versa. Control is passed to operation 2135 and process 2100 continues.

In operation 2135 an advertisement is provided. An advertisement may be provided in any number of ways. An advertisement may be provided by a responder, automatically and/or by a business. An advertisement may be provided to a user with content similar to content in a query asked by a user. For example, an advertisement providing a coupon to a business in a query may be provided to a user. An advertisement may be provided from a human assistant provided by a sponsor and selecting the advertisement based on the sponsor, time, demographic location, geographic location etc. Control is passed to operation 2140 and process 2100 continues.

In operation 2140, process information is recorded. Information of a request, an advertisement, an answer, a resource, a user, a sponsor, an advertiser, a guide, a rating, a ranking, etc. may be recorded. A stored response may be rated, ranked, or deleted. Usage and compensation associated with an answer, and advertisement, a responder, etc. may be recorded. In at least one embodiment, process information is recorded in the database 1320 (FIG. 13). Control is passed to operation 2105 and process 2100 continues.

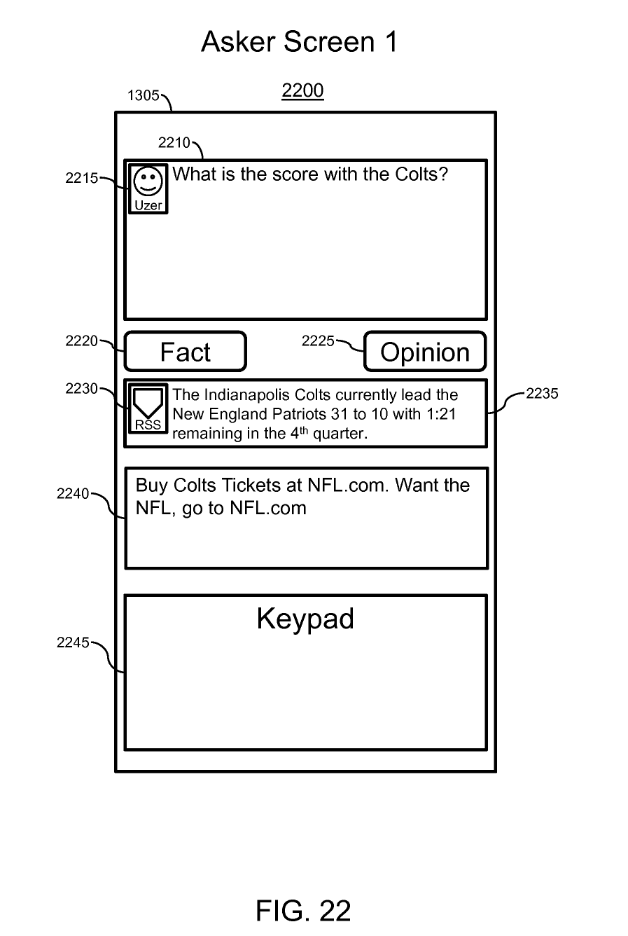

As illustrated in FIG. 22 an exemplary GUI 2200 is provided. The query submission GUI 2200 may be provided to a user at any time. The GUI 2200 may be presented using a system such as the user system 1305 (FIG. 13). The GUI 2200 may be used to submit any type of request. The GUI 2200 may include a query entry area 2210, a user identifier 2215, a factual query indicator 2220, an opinion query indicator 2225, a responder indicator 2230, a response indicator 2235, an advertisement field 2240 and user controls 2245.

The request entry area 2210 may be used to indicate information of a request. The user indicator 2215 may be used to indicate information of a user submitting a request. The factual query indicator 2220 may be used to indicate that a request is a request for factual information. The opinion query indicator 2225 may be used to indicate that a request is a request for subjective information. The responder indicator 2230 may be used to indicate a source of a response. The response indicator 2235 may be used to indicate a response associated with a request indicated in the request indicator 2210. The advertisement field 2240 may be used to provide content related to a query in request entry area 2210, a response indicated in the response indicator 2235 and/or a responder indicated in the responder indicator 2230. The user controls 2245 may be used to submit a request. While a keypad is used for purposes of illustration, any user input device which is well known in the art may be used to implement the user controls 2245.

Using the example illustrated in FIG. 22, a query associated with ‘Sports>NFL>Football’ may have received a response from ‘AutoGuide’ which may block an advertisement such as ‘Rstatsmessage1’ originating from ‘Rstats’. An advertisement from a source which is not blocked may be presented in the advertisement field 2240.

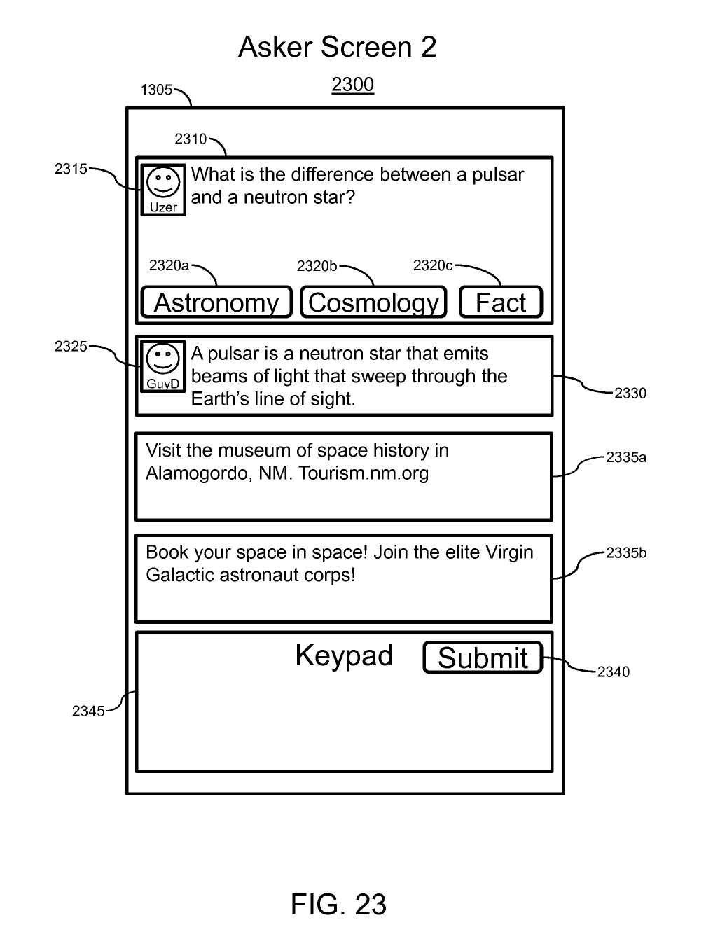

An exemplary GUI 2300 for providing a response to a request is illustrated in FIG. 23. The GUI 2300 may be presented using a device such as the responder system 1335 (FIG. 13). If a responder elects to provide an answer to a request, the GUI 2300 may be provided. The GUI 2300 may include a query indicator 2310, a user indicator 2315, category indicators 2320a-2320c, responder indicator 2325, answer indicator 2330, advertisement indicators 2335a-2335b, an action control 2340 and user controls 2345.

The query indicator 2310 may be used to indicate information of a query to which a responder has chosen to respond. The user indicator 2315 may be used to indicate information of a user associated with a request. The category indicators 2320a-2320c may be used to indicate information such as a category, keyword, tag, topic, etc., associated with a request, which may be used to select requests and/or other items provided to a responder. The responder indicator 2325 may indicate information of a responder submitting a response. The answer indicator 2330 may be used to indicate a response, which may be submitted by a responder. The advertisement indicators 2335a-2335b may indicate advertisements targeted to a user which may be based on a query in query indicator 2310. For example, a number of advertisements may be indicated to a responder based on a ranking of advertisements. As illustrated in FIG. 23, an advertisement indicated in the advertisement indicator 2335a may be blocked by the responder ‘GuyD’ while an advertisement indicated in the advertisement indicator 2335b may not be blocked by ‘GuyD’. A responder may indicate that an advertisement indicated in the advertisement indicator 2335b is to be provided responsive to a request by activating an advertisement indicator by for example ‘tapping’, ‘swiping’, etc. the advertisement indicator 2335b. The action control 2340 may be used to indicate that a response provided by a responder is to be provided as a response to a query indicated in the query indicator 2310. The user controls 2345 may be used to provide input for the GUI 2300.

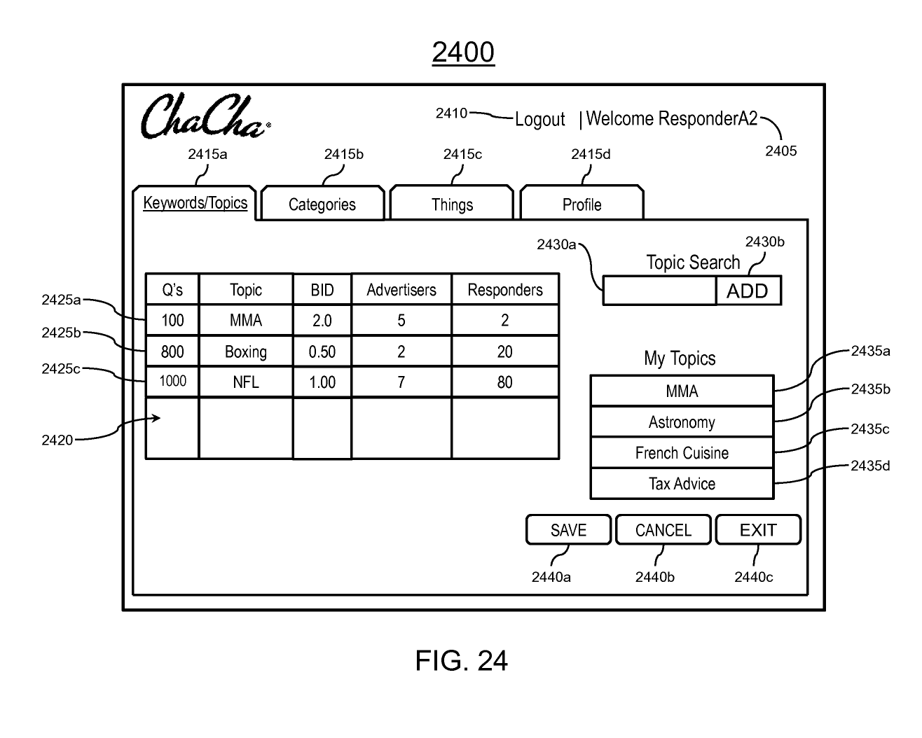

As illustrated in FIG. 24 an exemplary GUI 2400 is provided. The GUI 2400 may be presented using a device such as the responder system 1335 (FIG. 13). The GUI 2400 may be used by a responder to select information which may be used to direct a query to a responder. The GUI 2400 may include a user indicator 2405, a login control 2410, selection tabs 2415a-2415d, a targeting information window 2420, target information indicators 2425a-2425c, topic filtering controls 2430a, 2430b, current topic indicators 2435a-2435d, and action controls 2440a-2440c.

The user indicator 2405 may indicate information of an operator of the GUI 2400. The login control 2410 may be used to login or log out of the system. The selection tabs 2415a-2415d may be used to view various types of targeting information which may be used to direct a query to a responder. For example, the ‘Keywords/Topics’ selection tab 2415a may be used to view information of queries and/or advertisements associated with topics or keywords. The ‘Categories’ selection tab 2415b may be used to view information of queries and/or advertisements based on categories. The ‘Things’ selection tab 2415c may be used to view information of queries and/or advertisements associated with named entities such as cities, famous persons, etc. The ‘Profile’ selection tab 2415d may be used to manage demographic, geographic, etc., information associated with a responder. An active tab may be indicated in any typical manner. The ‘Keywords/Topics’ selection tab 2415a is active as indicated by the underlining in FIG. 24. While a limited number of selection tabs is illustrated FIG. 24, any number of selection tabs and/or types of targeting information might be presented to a responder within the scope and spirit of the embodiments disclosed herein. For example, a query might be targeted based on a keyword, topic, named entity, affiliation, responder rating, answer rating, demographic, etc.

The targeting information window 2420 may be used to present information of targeting data indicated by an active selection tab. For example, the number of questions (Q's) relating to a topic, a current bid price for advertisements associated with the topic, a number of advertisers who have submitted bids relating to the topic, and a number of responders who are accepting requests associated with the topic may be indicated. The target information indicator 2425a may present information regarding the topic ‘MMA’, which may be more attractive to a responder since comparatively few responders are registered for ‘MMA’ and the bid price and number of advertisers is high. Content of the targeting information window 2420 may be sorted according to any of the displayed fields in order to assist a responder in selecting targeting information. The topic filtering control 2430a may be used to enter information of a desired topic, which may affect content of the targeting information window 2420. The ‘ADD’ topic filtering control 2430b may be used to add a topic to the current topic indicators 2435a-2435d. The current topic indicators 2435a-2435d may be used to indicate topics and/or targeting information for which a responder has elected to receive requests. A topic may be removed from a current topic indicator by for example a ‘right click’ or ‘dragging’ a topic from a current topic indicator. The ‘SAVE’ action control 2440a may be used to store information obtained using the GUI 2400. The ‘CANCEL’ action control 2440b may be used to cancel any changes made using the GUI 2400. The ‘EXIT’ action control 2440c may be used to close the GUI 2400 without saving information obtained. While a limited number of selection tabs 2415 is depicted in FIG. 24, any number of selection tabs may be provided as per a targeting selected for an embodiment.

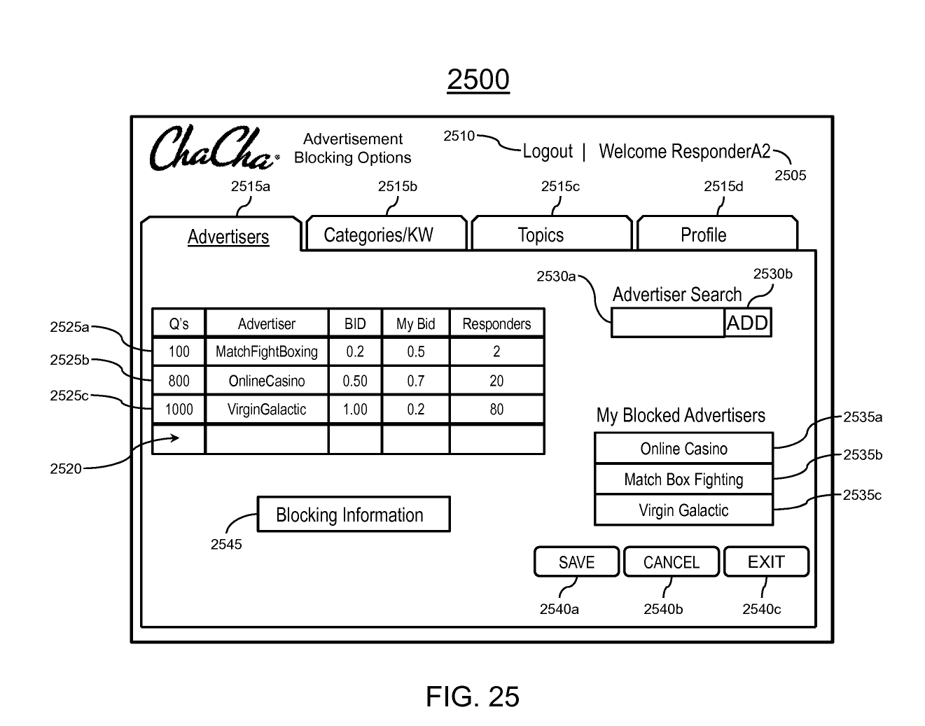

As illustrated in FIG. 25 an exemplary GUI 2500 is provided. The GUI 2500 may be presented using a device such as the user device 1310 (FIG. 13). The GUI 2500 may be used by a responder to select information which may be used suppress an advertisement or content from being presented when a response of a responder is presented. The GUI 2500 may include a user indicator 2505, a login control 2510, selection tabs 2515a-2515d, a targeting information window 2520, target information indicators 2525a-2525c, filtering controls 2530a, 2530b, current blocked advertiser indicators 2535a-2535c, action controls 2540a-2540c, and a blocking options indicator 2545.

The user indicator 2505 may indicate information of an operator of the GUI 2500. The login control 2510 may be used to login or log out. The selection tabs 2515a-2515d may be used to view various types of targeting information which may be used to block an advertisement and/or advertiser. For example, the ‘Advertisers’ selection tab 2515a may be used to select advertisers which a responder may desire to block. The ‘Categories/Keywords’ selection tab 2515b may be used to block advertisements based on categories and/or keywords. The ‘Topics’ selection tab 2515c may be used to view information of advertisements which may be blocked which are associated with named entities such as cities, famous persons, etc. The ‘Profile’ selection tab 2515d may be used to manage advertisements which may be blocked based on demographic, geographic, etc. information associated with a responder. An active tab may be indicated in any typical manner. The ‘Advertisers’ selection tab 2515a is active as indicated by the underlining in FIG. 25.

The targeting information window 2520 may be used to present information of targeting data indicated by an active selection tab. For example, the number of questions (Q's) relating to an advertiser, a current bid price for advertisements associated with the advertiser, a bid for a responder which may be used to block an advertiser, and a number of responders who are accepting advertisements associated with an advertiser may be indicated. The target information indicator 2525c may present information regarding the advertiser ‘VirginGalactic’, which may be less attractive for a responder to block since the bid price is of the advertiser is high, and a number of responders accepting ads from ‘VirginGalactic’ is high. A responder might be required to pay to prevent a competitor's advertisement from being presented. For example, if a query would result in an ad from ‘MatchFightBoxing’ being presented, ‘ResponderA2’ might be required to pay the amount indicated in the ‘BID’ field of the target information indicator 2525a to prevent the competitive advertisement from being presented. Content of the targeting information window 2520 may be sorted according to any of the displayed fields in order to assist a responder in selecting targeting information. An individual advertisement may be selected for blocking by for example activating an indicator of an advertiser. Activation of an indicator of an advertiser may present information of an advertisement such as advertisement content, targeting, bid price, etc., for an advertisement associated with an advertiser, category, etc. An advertisement may be blocked by making a selection in the blocking options indicator 2545. The blocking options indicator 2545 may allow a responder to determine which advertisements, keywords, topics, etc. may be blocked.

The advertiser search control 2530a may be used to enter information of an advertiser, which may affect content of the targeting information window 2520. The ‘ADD’ targeting filtering control 2530b may be used to add an advertiser to the current blocked advertiser indicators 2535a-2535c. The current blocked advertiser indicators 2535a-2535c may be used to indicate advertisers, advertisements and/or targeting information for which a responder has elected to block advertisements. An advertiser may be removed from a blocked advertiser indicator by for example a ‘right click’ or ‘dragging’ a topic from a current advertiser indicator or otherwise activating a blocked advertiser indicator. The ‘SAVE’ action control 2540a may be used to store information obtained using the GUI 2500. The ‘CANCEL’ action control 2540b may be used to cancel any changes made using the GUI 2500. The ‘EXIT’ action control 2540c may be used to close the GUI 2500 without saving information obtained.

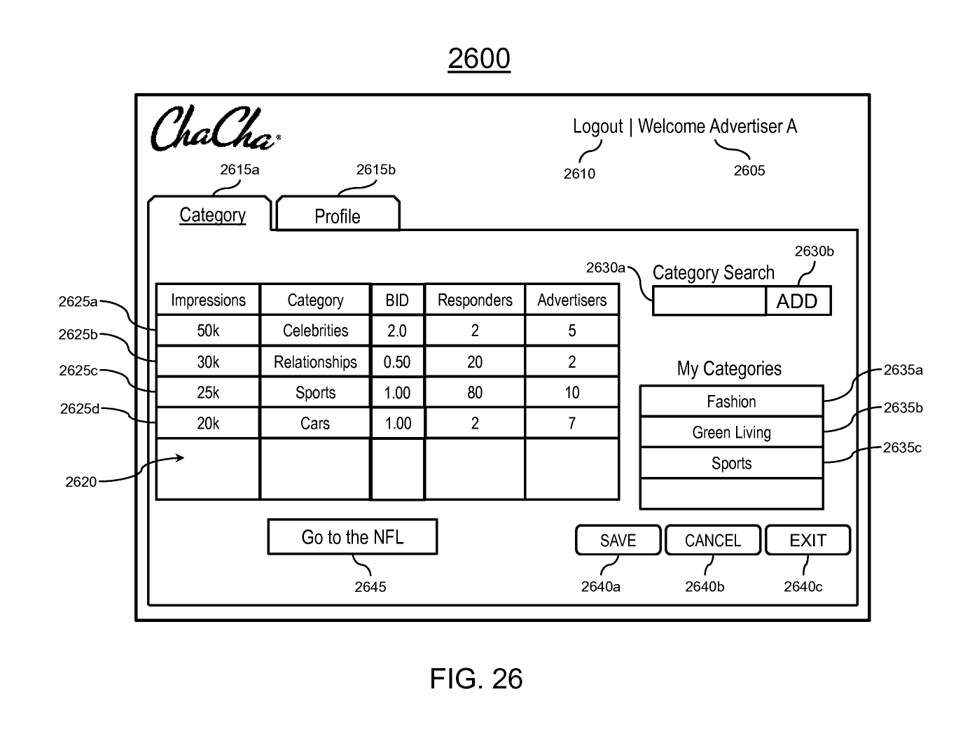

As illustrated in FIG. 26 an exemplary GUI 2600 is provided. The GUI 2600 may be presented using a device such as the message source 1355 (FIG. 13). The GUI 2600 may be used by an advertiser to select information which may be used to target advertisements. The GUI 2600 may include an advertiser indicator 2605, a login control 2610, selection tabs 2615a-2615b, a targeting information window 2620, target information indicators 2625a-2625d, targeting filtering controls 2630a, 2630b, current target indicators 2635a-2635c, action controls 2640a-2640c, and an advertisement indicator 2645.

The advertiser indicator 2605 may indicate information of an operator of the GUI 2600. The login control 2610 may be used to login or log out. The selection tabs 2615a, 2615b may be used to view various types of targeting information which may be used to target advertisements. For example, the ‘Category’ selection tab 2615a may be used to view information of queries, responders, and/or advertisements associated with a category. The ‘Profile’ selection tab 2615b may be used to manage demographic, geographic, etc. information associated with an advertisement and/or advertiser. An active tab may be indicated in any typical manner. The ‘Category’ selection tab 2615a is active as indicated by the underlining in FIG. 26. While a limited number of selection tabs is illustrated FIG. 26, any number of selection tabs and/or types of targeting information might be presented to an advertiser within the scope and spirit of the embodiments disclosed herein. For example, an advertisement might be targeted based on a keyword, topic, named entity, responder, responder rating, answer rating, etc.

The targeting information window 2620 may include information of categories which might be used to target an advertisement. For example, a number of impressions per day, a current successful bid price, a number of responders and a number of advertisers who have bid to target advertisements based on a targeting parameter may be provided. For example, the category ‘Relationships’ might be attractive for targeting a suitable advertisement as a number of impressions is large, a bid price is low, a number of responders is high and a number of competing advertisers is low. The targeting filtering control 2630a may be used to enter information regarding a target such as a category, which may affect content displayed in the target information window 2620. Content of the targeting information window 2620 may be sorted according to any of the displayed fields in order to assist an advertiser in selecting targeting information. The ‘ADD’ targeting filtering control 2630b may be used to add targeting information to the current target indicators 2635a-2635c. The current target indicators 2635a-2635c may be used to indicate topics and/or targeting information which an advertiser has elected to use to target advertisements. Targeting data may be removed from a current target indicator by for example a ‘right click’ or ‘dragging’ a target from a current target indicator. The ‘SAVE’ action control 2640a may be used to store information obtained using the GUI 2600. The ‘CANCEL’ action control 2640b may be used to cancel any changes made using the GUI 2600. The ‘EXIT’ action control 2640c may be used to close the GUI 2600 without saving information obtained. The advertisement indicator 2645 may provide information of an advertisement for which targeting information is being selected. For example, if an advertiser selected the ‘Sports’ target information indicator 2625c, an advertisement indicated in the advertisement indicator 2645 might be targeted to queries of responders associated with the ‘Sports’ targeting category. The advertisement indicator 2645 may indicate any number of advertisements associated with an advertiser and/or targeting information.

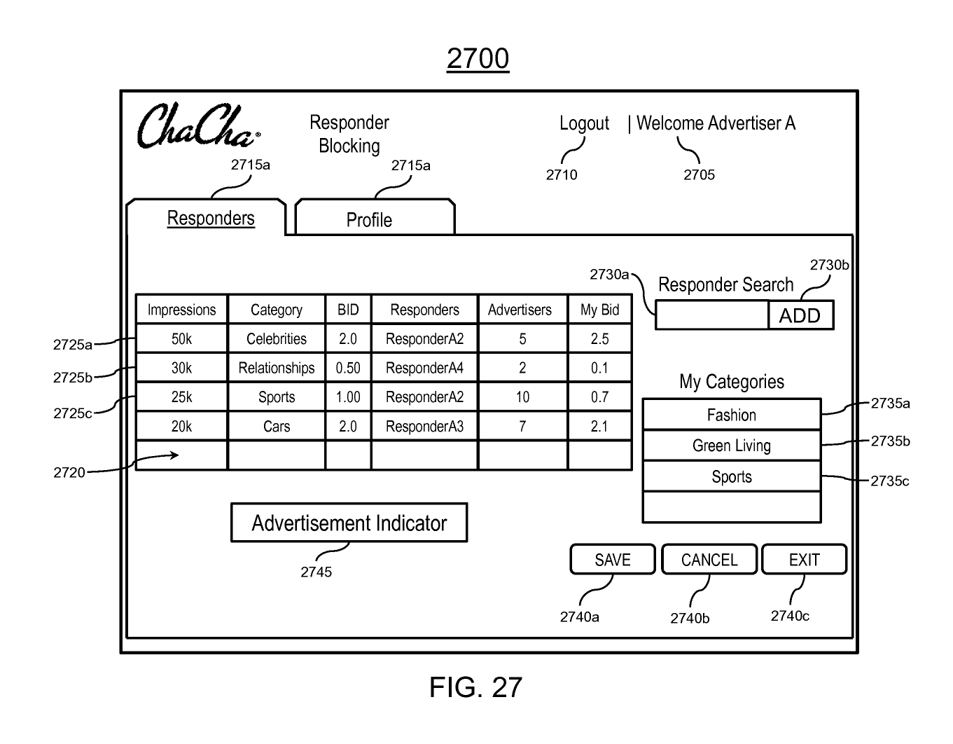

As illustrated in FIG. 27 an exemplary GUI 2700 is provided. The GUI 2700 may be presented using a device such as the message source 1355 (FIG. 13). The GUI 2700 may be used by an advertiser to view information of blocking of advertisements. The GUI 2700 may include an advertiser indicator 2705, a login control 2710, selection tabs 2715a-2715b, a targeting information window 2720, target information indicators 2725a-2725d, targeting filtering controls 2730a, 2730b, current target indicators 2735a-2735c, action controls 2740a-2740c and an advertisement blocking indicator 2745.

The advertiser indicator 2705 may indicate information of an operator of the GUI 2700. The login control 2710 may be used to login or log out. The selection tabs 2715a, 2715b may be used to view various types of targeting information which may be used to target advertisements. For example, the ‘Responders’ selection tab 2715a may be used to view information of queries, categories, and/or advertisements associated with a responder who has blocked an advertisement of an advertiser. The ‘Profile’ selection tab 2715b may be used to manage demographic, geographic, etc., information associated with an advertisement and/or advertiser, and to view responders who may have blocked an advertisement associated with a responder based on profile parameters. An active tab may be indicated in any typical manner. The ‘Responders’ selection tab 2715a is active as indicated by the underlining in FIG. 27. While a limited number of selection tabs is illustrated FIG. 27, any number of selection tabs and/or types of targeting information might be presented to an advertiser within the scope and spirit of the embodiments disclosed herein. For example, an advertisement might be targeted based on a keyword, topic, named entity, responder, responder rating, answer rating, etc.

The targeting information window 2720 may include information of categories which might be used to target an advertisement, and responders who may have blocked a category. For example, a number of impressions per day, a current successful bid price, a number of blocking responders, a number of advertisers who have bid to target advertisements based on a targeting parameter, and a current bid by an advertiser which may override blocking by a responder may be provided. For example, the category ‘Relationships’ might be unattractive for targeting a suitable advertisement as a number of impressions is large, but the advertiser bid price is low, and a blocking bid price by ‘ResponderA4’ is high. The targeting filtering control 2730a may be used to enter information regarding a responder, which may affect content displayed in the target information window 2720. Content of the targeting information window 2720 may be sorted according to any of the displayed fields in order to assist an advertiser in selecting targeting information. Activation of an indicator of a responder may provide information of any or all categories associated with a responder. Activation of an indicator of a category may provide information of responders and bids by responders relating to an advertiser. The ‘ADD’ targeting filtering control 2730b may be used to add targeting information to the current target indicators 2735a-2735c. The current target indicators 2735a-2735c may be used to indicate topics and/or targeting information which an advertiser has elected to use to target advertisements. Activation of a current target indicator may cause information of responders and bidding and/or blocking information associated with a target to be provided. Targeting data may be removed from a current target indicator by for example a ‘right click’ or ‘dragging’ a target from a current target indicator. The ‘SAVE’ action control 2740a may be used to store information obtained using the GUI 2700. The ‘CANCEL’ action control 2740b may be used to cancel any changes made using the GUI 2700. The ‘EXIT’ action control 2740c may be used to close the GUI 2700 without saving information obtained.

The advertisement blocking indicator 2745 may provide information of an advertisement for which blocking information is desired. For example, if an advertiser selected the ‘Sports’ target information indicator 2725c, an advertisement indicated in the advertisement blocking indicator 2745 might be targeted to queries of responders associated with the ‘Sports’ targeting category, but might be blocked by a responder indicated in the responders field of the targeting information window 2720. The advertisement blocking indicator 2745 may indicate any number of advertisements associated with an advertiser and/or targeting information. Activation of the advertisement blocking indicator 2745 may cause information of targeting, blocking, bidding, responders, etc. associated with an advertisement indicated by the advertisement blocking indicator 2745 to be provided. The advertisement blocking indicator 2745 may be used to show an advertisement which may be blocked for some reason. An advertisement may be blocked by a responder for various reasons, such as a category of the advertisement, for competitive reasons, for brand safety reasons, etc. An advertiser may be able to select an alternate responder from whom responses may be provided for a blocked advertisement. An advertiser may be able to overcome blocking by increasing a bid associated with an advertisement. A responder may be notified of a bid by an advertiser to overcome blocking of the advertiser or advertisement.

Using the methods and systems described herein a method and system for management of advertisements based on a source of a response is described. When a request is received a number of responses may be obtained. A number of advertisements which may be targeted to a source of a request may be selected. A ranking of a response may be affected by an advertisement selected. A ranking of an advertisement may be affected by a responder associated with a response.

A responder and/or a source of a message or advertiser may affect whether an advertisement and/or a response will be provided to a source of a request. A responder may elect to block advertisements on any basis. A tool may be provided to assist a responder in selecting information which may be used to direct a request to a responder. A responder may be provided with a tool for selection of blocking criteria. A responder may block advertisements based on a source of an advertisement (e.g., a competitor), a category (e.g., adult products), a demographic (e.g., under 21), etc. A responder may be required to submit a bid and/or otherwise provide compensation to a publisher if an advertisement is blocked.

An advertiser may be provided with a tool for targeting advertisements. An advertiser may direct advertisements based on any suitable parameters. An advertiser may be provided with information of responders who have elected to block an advertisement. An advertiser may be able to cause an advertisement to be provided despite blocking by a responder. For example, if a response is available from a responder who has not elected to block an advertiser, a response of an advertiser who has not blocked an advertiser may be provided responsive to a request.

While the system and methods herein have been described in the context of a question answering system, no limitation is implied thereby. For example, advertisements associated with social media, forum responses, streaming music, and/or video, an auction site, a service supplier, etc., might take advantage of the features of the invention. Any system wherein a response is associated with a particular source might benefit from the invention.

A system and method for providing advertising content based on a provider of a response is described. A response to a request is selected, and an advertisement may be selected based on a request, a response and a responder. An advertisement may affect whether a response is provided and a response may affect whether an advertisement is provided.

In systems wherein questions are submitted by users and answered by peers, it is desirable to have rapid and accurate responses. Systems such as Aardvark, Mosio and Yahoo! Answers have attempted to use peer-to-peer answering to meet this need. However, such systems have met with limited success. In particular it is difficult to provide answers in a timely manner and to provide accurate information. This problem is aggravated when many similar queries are received and a plurality of answers may be provided to each similar query.

One way to overcome the timing limitation is to incentivize a person tasked to respond to a request. Various types of compensation methods have been implemented by companies such as KGB and ChaCha. By paying workers to respond to questions, timeliness of answers and answer quality may be improved. However such systems have higher cost to answer and thus must be able to obtain higher compensation per query than a peer-to-peer system in which an answerer is not financially compensated.

As described in the related U.S. application Ser. No. 13/612,377, filed Sep. 12, 2012 entitled METHOD AND SYSTEM OF MANAGEMENT OF SEARCH RESULTS, inventor Eugene M. O'Donnell, a provider of goods and/or services or “vendor” may provide information resources, and/or human assistants which may be used to respond to a user request. However, such a system may have some limitations as well. In order to ensure a high level of answerer or responder availability, as well as a high level of accountability for answer quality a group of answerers associated with a topic, entity or person may be created. However, it may not be possible to separate whether an answer is provided by a group member acting as an individual, as a representative of the group, or as both. This may be particularly important for management of reputation as well as recognition and compensation.

For these and other reasons, a method and system for management of responder groups would be greatly appreciated.

A system is implemented whereby a responder may receive a query from a user. If a responder elects to respond to the query, a response of the responder may include a message determined by the responder. An answer supplied by a responder may identify a responder when presented responsive to a request. An answerer may be assigned to group. If an answerer or responder is assigned to a group, an answer of the responder may identify a group when presented. A responder may be associated with items such as topics, named entities, categories, types of tasks, etc., which may be used to associate a query with a responder and/or item. If a responder is associated with an item an item may determine whether an answer of a responder will identify a responder, a group including a responder, or both.

A system is provided whereby users may submit a request. A request may be submitted using any suitable device such as a desktop or laptop computer, wireless phone or tablet device, etc. A request may be received by a server, which may store information of a request. A response may be provided by a server in various ways. Information of a request may be directed to a responder or answerer. A responder may be a person and/or an entity such as a business or organization. If a responder provides an answer to a request, a message may be included with an answer. A message of a responder may be provided in addition to a response. A message of a responder may be provided when a stored response associated with a responder is returned as an answer to a request. A message of a responder may be provided when a resource provided by a responder produces an answer.

A group of answerers or responders may be established using various criteria. A group may be associated with a person, an entity, and/or an ad hoc group created based on a tag which is published for the purpose of creating a group. A group may be managed by a number of persons. A group manager may include or exclude responders from a group. A group manager may determine whether an answer will identify a responder, a group, and/or both the responder and the group. A group manager may determine topics, categories, named entities, and/or geographic, demographic, etc. parameters which may affect whether a response will be provided, whether a response will identify a responder, whether a response will identify a group, etc.

A group may provide a resource which produces a response. For example, a group may provide a resource which receives a query and provides a potential answer based on the query. If an answerer of a group selects a potential answer, a group may be able to provide a message with the answer. Should the potential answer be reused, the responder or group may be able to provide a message with an answer. In at least one embodiment, a group may not be identified in an answer, but may receive a message from an advertiser and/or sponsor, who may bid based on factors such as reputation of the responder, or group, subject matter of answers provided by the group, etc. In this way, a group may act as an agent for advertisers.

A group manager may determine other aspects of a group and/or abilities of group members. A group manager may determine whether a responder may create a response. A group manager may determine which resources may be used by a group member. A group manager may determine whether a member may rate responses by members. A group manager may determine whether a member may select previous responses of group members for purposes such as responding to future queries. A group manager may determine whether a responder may select advertisements. A group manager may determine whether a responder may be compensated for an answer. A group manager may designate a condition and/or time period during which a responder is acting on behalf of the group.

Management of a group may be determined based on actions of members of a group. For example, group members may be able to approve and/or reject members. Group members may determine whether a response of a member will be presented and/or conditions associated with presentation of a response. For example, an answer may require a minimum number of group members to accept an answer in order that an answer will be provided. Management of a group may be based on business rules, rather than actions based on an individual judgment of a group manager. A group manager may be a person, an automated system, and/or both. A member of a group may be required to meet quality, speed, activity, etc. criteria in order to maintain membership, receive compensation, etc.

A group manager may control information used to match a request or other items to a group. For example, a group manager may select and/or edit categories, keywords, named entities, etc. which may be associated with a group. A group manager may control advertising messages provided in conjunction with a response. For example, a group manager may elect to exclude certain types of advertisements if a response identifying a group is presented. If an advertisement or other message is blocked for a group a response which does not identify a group may be provided in conjunction with the advertisement. A group manager may determine criteria for rating and/or ranking advertisements.

A system is provided which includes a user system for submitting a query and receiving a response, a search server receiving the query, a database storing information of queries, search results, searchers, users, resources and other information, a guide system receiving a query and providing a search result, and a message system providing sponsored content.

A system is implemented to allow a user to submit a query and receive a response. A query and/or a response may include any type of media such as text, URL's, audio, video, etc. A response may be produced automatically and/or using the assistance of a person. A query may be submitted using any suitable device and/or communication service such as SMS, MMS, voice, Instant Messaging, VoIP, internet packet communication, email, etc.

Processing of a query may be divided into various layers. A first layer may consist of automated processing of a query. Automated processing of a query may include comparison of a query to a database, analysis of a query using semantic techniques, pattern matching, etc. which may be used to determine a response to the query. Results of automated processing such as categorization, spelling correction, named entity extraction, location association, etc. may be stored for later use.

A second layer of processing of a query may include a human assistant who analyzes the query or “expediter”. An expediter uses the human ability to recognize context in order to determine a response to a query. An expediter may be provided with relevant context of a query, and offered various options for responding to the query. In its simplest form, an expediter might be presented with a question and two or more options for responding to the question. An expediter may be provided with a rich toolset which provides a greater depth and breadth of responses which may be interactive. In at least one embodiment, an expediter may be provided with responses from a predetermined set of resources.

A third layer of processing of a query may include a human assistant who responds to the query or “searcher”. A searcher may receive an interpreted query, information of a source of the query, and be provided with resources for performing a search responsive to a query. A searcher may formulate a response based on an interpreted query, and submit the response for delivery to a user responsive to the query. In at least one embodiment, a searcher may receive information of resources which may be used to provide a response, and/or resources which are excluded from providing a response.

A resource may be characterized according to various parameters. A resource may be evaluated based on a number of responses obtained from and/or using the resource. A resource may be evaluated based on a number of times that a response obtained from the resource is reused. A resource may be evaluated based on an affiliate relationship between a provider of the resource and a provider of search services and/or a responder.

As used herein, a “request” means a request for information, products, and/or services. A request or search request or query may include various types of media, and may be provided by any user system which may establish communication with a server and/or other devices associated with a search service. A request may be referred to as a “search request”, “search query”, or “query”.

A “user” is a person who submits a request and may receive any type of information responsive to a request. A user may be any person or entity. A “guide” is a person who assists in processing a request. A guide may be referred to as a “provider”, “searcher”, “human searcher”, “human assistant”, “expediter”, “transcriber”, “specialist” or “generalist”. Guides may be assigned various roles. A guide who transcribes a user request from one form to another may be referred to as a transcriber. A guide who reviews a query, determines a most likely response, and may modify a query may be referred to as an expediter or “ambassador”. A guide who performs a search for queries associated with a specific category may be referred to as a specialist. A guide who performs a search for queries regardless of category may be referred to as a generalist. Any guide may perform any role.

An “advertiser” is any person and/or entity which may provide promotional information or “advertisements” to be delivered to a user. An advertisement may take various forms and/or may include media of any sort which can be delivered to a user device. A “result”, “response”, “answer”, or “search result” is any information which has been determined to be a response to a request. A result may include an advertisement. A result may be any information which is provided as a response to a request. A “resource” or “search resource” may be any source of information which may provide a search result and/or other information. A resource may include a search engine, a web server, a software application, an API, printed media, an RSS feed, streaming media, a web page, a database, etc. A “profile” may be any information associated with a person such as demographic data, geographic data, personality data, affiliations, etc. A result may be an “organic” result which is produced by a search which has no intentional bias applied. A result may be a “sponsored” result which is provided and/or approved by a provider with a commercial interest in the response and/or providing the response to a user based on a request for information associated with the sponsored answer or sponsored result.

A “responder” is a person or entity that responds to a request. A responder may be referred to as an “answerer”. A responder may be a user who has elected to act in any guide role such as searcher, generalist, expediter, etc. A responder may perform any task which a guide may perform. A responder may be a person or an entity such as an organization, business, etc. A human assistant such as an expediter may select a search result associated with a previous query and/or an automated resource. A search result selected by a human assistant may be indicated as a sponsored result and/or an organic result. A human assistant may be presented with sponsored results, organic results, and/or a mixture of organic and sponsored results. An expediter may be associated with a sponsor, and may be presented with sponsored results associated with the sponsor.

The terms voice and speech are used interchangeably herein. A user, a guide and/or a search system may establish a communication session using a voice service, a messaging service such as Short Messaging Service (SMS), Enhanced Messaging Service (EMS), Multi-media Messaging Service (MMS), Instant Messaging (IM), email, an internet portal or web page, an application, regular mail and/or any other suitable type of communication. A connection or communication session may be established using any device which is capable of utilizing a communication service. For example, a wireless device such as a cell phone, PDA, smart phone, etc., might be used to establish a communication session using voice, SMS, IM, email and/or internet protocols. A desktop, laptop or server system might be used to establish a communication session using IM, email, SMS, MMS, etc. A landline phone, a specialized communication terminal, and/or any other communication device might be used to establish a communication session.

Communication between a user, a guide and/or a search system may include conversion of text to speech and speech to text. Any type of media which can be sent and/or received using a communication system may be part of a communication session. A communication session may be conducted using any or all communication services associated with a user, a guide, and/or a search system. Any communication session may include communication via multiple services and/or devices. For example, a request may be submitted as a voice query, which might indicate an image located on a resource accessible to a user. A voice query might be converted to a text message, the image might be processed in order to associate a tag and/or other images with the image, and a response might be provided as a spoken reply to a mobile phone associated with a user, and a video presentation which is accessible via a high-speed connection that might be delivered to a browser functionality of a different user device.

An advertisement may be transmitted, including during any or all communication sessions. A guide, a user, a search result, a resource, a responder, an advertiser and/or a request may be rated. Rating information may be obtained from a user, a guide, an advertiser and/or an administrator of a search system. Rating information may be used to select a user, a guide, a request, a result, a responder, an advertiser, and/or any item based on information associated with an item indicated in a database. A search service may be compensated by advertising revenue. Advertising and/or content may be delivered to a user and/or a guide using any communication service associated with a user and/or a guide. An advertiser may request and obtain information regarding usage, users, demographics, affiliations, etc. associated with queries, keywords, categories, resources etc. and may submit sponsored answers and associate sponsored answers with queries based on information provided.

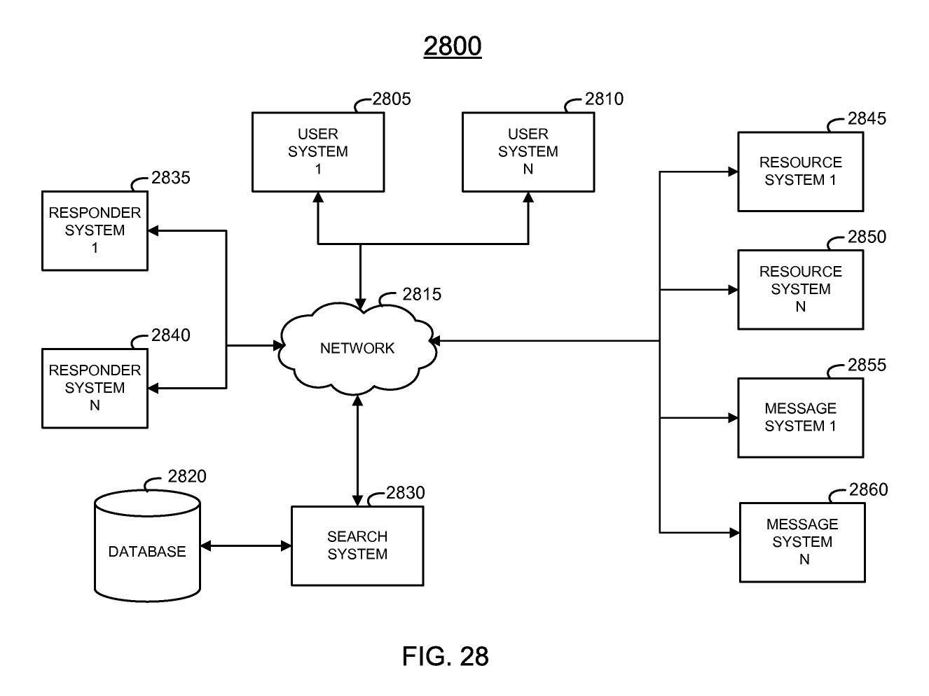

As illustrated in FIG. 28, system 2800 includes user systems 2805, 2810, a network 2815 such as the Internet, a search system 2830, a database 2820, which may comprise various records, responder systems 2835, 2840, resource systems 2845, 2850, and message systems 2855, 2860.

While only a few systems associated with a user, a resource, a message source and a responder are depicted in FIG. 28 it is within the scope of the disclosure for multiple systems for a user, resource, message and guide to be utilized. In particular it is envisioned that many users, resource, message and guide systems may be implemented. The search system 2830 may be a composed of many components as described further herein.

Any user system (e.g. the user system 2805) may be used, to submit a request to the search system 2830 and/or receive a result and/or other information. Any user system may receive a response, and/or may provide compensation to the search system 2830.

The network 2815 may be a global public network of networks (i.e., the Internet) and/or may consist in whole or in part of one or more private networks and communicatively couples the user systems 2805, 2810, the responder systems 2835, 2840, the resource systems 2845, 2850 and the message systems 2855, 2860 with the other components of the system such as the search system 2830, and the database 2820. The network 2815 may include one or more wireless networks which may enable wireless communication between the various elements of the system 2800. For example, the search system 2830 may receive messages which may be routed via a wireless network controlled by a wireless service to the user systems 2805, 2810. A wireless service may receive messages from the responder systems 2835, 2840 via a wireless network which is a part of the network 2815, and provide the messages to the search system 2830 via an internet connection which is part of the network 2815. Similarly a voice communication via wired and/or wireless communication might be established between any elements of the system 2800.

The search system 2830 allows interaction to occur among the user systems 2805, 2810, the responder systems 2835, 2840, the resource systems 2845, 2850 and the message systems 2855, 2860. For example, a request can be transmitted from the user system 2805 to the search system 2830, which may provide information obtained from the database 2820, which may include an advertisement provided by the message system 2855 to the user system 2805. Similarly, a search result from a searcher operating the responder system 2835 and/or the resource system 2845 might be routed to the search system 2830, which might process the search result, formulate a response and provide a message to the user system 2805. Any type of communication between users, resources, sponsors and/or guides may be mediated and/or facilitated by the search system 2830, and/or other elements of the system 2800.

The search system 2830 is communicatively coupled with the database 2820. As will be described herein in further detail below, the database 2820 includes data that is processed in association with operation of the embodiments. Although FIG. 28 illustrates the database 2820 as a separate component of the system 2800, the database 2820 may be integrated with the search system 2830. Further, the records maintained in the database 2820 may be stored in any typical manner, including in a Network Attached Storage (NAS), a Storage Area Network (SAN), RAID, etc., using any typical or proprietary database software such as DB2®, Informix®, Microsoft® SQLServer™, MySQL®, Oracle®, etc., and may also be a distributed database on more than one server. Elements of the database 2820 may reside in any suitable elements of the system 2800. Any or all elements of the system 2800 may include any or the entirety of the database 2820.

The user systems 2805, 2810, the responder systems 2835, 2840, the resource systems 2845, 2850, the message systems 2855, 2860 and the search system 2830 may include equipment, software, systems and personnel required to send and/or receive messages between a user system 2805, 2810, the responder systems 2835, 2840, the resource systems 2845, 2850, the message systems 2855, 2860 and/or the search system 2830 using the network 2815. The database 2820 includes information which may allow the search system 2830 to establish communication between any or all of the elements of the system 2800.

A user system, a responder system, a resource system, a message system and/or a search system may be a desktop, portable, or tablet PC or Mace, a mobile phone, a smart phone, a PDA, a server system, a landline phone, a specialized communication terminal, a terminal connected to a mainframe, or any other communication hardware and/or system. The search system 2830 may include one or more servers, computers, etc. For example, servers such as the PowerEdge® 2900 by Dell, or the BladeCenterJS22 by IBM, or equivalent systems might be used to implement elements of the search system 2830. The search system 2830 may utilize an operating system (OS) such as Microsoft Windows XP, or Linux, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, responder systems, and message systems and/or to implement the search system 2830.

A user may be identified by the search system 2830. When a user system, such as the user system 2805, establishes a communication session with the search system 2830, an identifier of a user system is determined. An identifier of a user system may be associated with other information regarding a user. A user system may be identified using an email address, a telephone number, an IM credential, a username, and/or any other identifier which may be used to associate information with a user. Multiple identifiers of a user may be associated with each other. Using information of communication services associated with a user, a communication session may be established between a user system such as the user system 2805 and a resource system, a responder system, a message system and/or the search system 2830. Information such as a keyword, a category, a user profile, a request, a result, etc., may be associated with a user. A user may be required to provide profile information to the search system 2830. A user may elect to receive requests from the search system 2830. Parameters and/or attributes may be associated with a user and/or a resource as will be further described herein below. Information of a user may be stored in the database 2820.

A responder and/or a user may be required to register with the search system 2830. As part of a registration process, at least one communication method is associated with a responder. In at least one embodiment, a responder may register with the search system 2830 and establish a username and password which are associated with the responder. A responder may login to the search system 2830 using a web browser functionality of the responder system 2835 in order to communicate with the search system 2830. Multiple communication services may be associated with a guide and may allow a communication session to be established between a responder system such as the responder system 2835 and a user system, a resource system, a message system, and/or the search system 2830. Multiple identifiers of a responder may be associated with each other. Information such as IM credentials, an email address, a phone number, a URL, a username, etc., of a responder may be identified which may allow the search system 2830 to establish a communication session between a responder system and a user system, a resource system, a message system and/or the search system 2830.

When a responder registers with the search system 2830 the responder may be associated with one or more keywords, categories, profiles, and/or other information. Information associated with a responder may be stored in the database 2820 and may be used for various purposes. Information associated with a responder may be used to rank requests, resources, results, advertisements, sponsors and/or other information which may be presented to the responder. In at least one embodiment, payment information is associated with a responder. In at least one embodiment, a responder may be required to undergo testing to determine whether a responder is able to perform any tasks which may be required by the search system 2830. For example, a responder may be assigned to a role such as translator, transcriber, expediter, generalist, specialist, auditor, etc. A responder may be registered by a sponsor. A sponsor may provide compensation to a sponsored guide.

A sponsor or advertiser controlling a message system may be required to register with the search system 2830. As part of a registration process, at least one communication method is associated with a sponsor. In at least one embodiment, a sponsor may register with the search system 2830 and establish a username and password which are associated with the sponsor. A sponsor may login to the search system 2830 using a web browser functionality of the message system 2855 in order to communicate with the search system 2830. Multiple communication services may be associated with a sponsor and may allow a communication session to be established between a sponsor system such as the message system 2855 and a user system, a resource system, a guide system, and/or the search system 2830. Multiple identifiers of a sponsor may be associated with each other. Information such as IM credentials, an email address, a phone number, a URL, a username, etc., of a sponsor may be identified which may allow the search system 2830 to establish a communication session between a sponsor system and a user system, a guide system, a resource system and/or the search system 2830.

When a sponsor registers with the search system 2830 the sponsor may be associated with one or more keywords, categories, profiles, and/or other information. Information associated with a sponsor may be stored in the database 2820 and may be used for various purposes. Information associated with a sponsor may be used to rank requests, resources, results, advertisements, guides and/or other information which may be presented to the sponsor and/or others. In at least one embodiment, payment information is associated with a sponsor. A sponsor may provide payment information which may be used to compensate the search system 2830 for services such as advertisements and/or sponsored answers provided to a user. A sponsor may designate a guide or responder associated with a sponsor, and may provide registration information associated with the sponsored guide. A sponsor may provide information associated with a resource. A sponsor may designate conditions for accessing a resource provided by a sponsor.

Records may be maintained in the database 2820 which may be used to record the status of various items. Such records may be used to aid the processing of requests and production of responses or answers. For example, a user may submit a request, which may describe a desired response, and provide access to information and/or materials needed to produce the response. Information indicated in a record may be combined with information in other records, and may be used to produce tables, as further described herein.

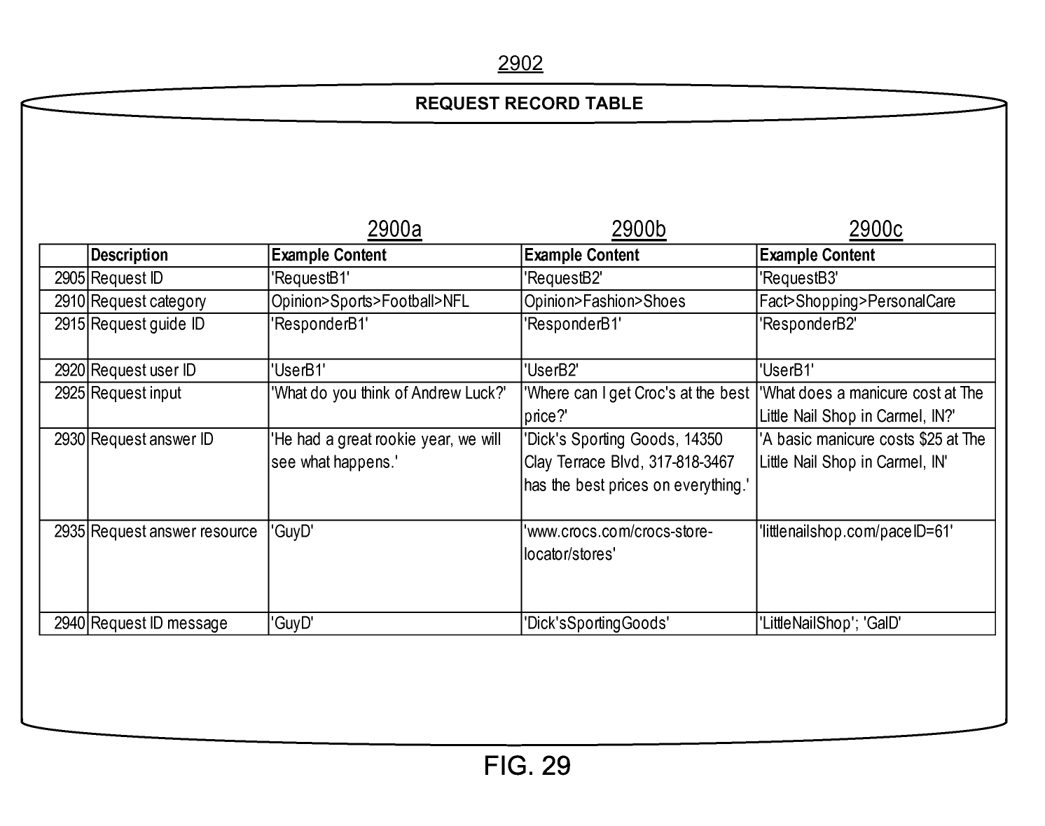

As illustrated in FIG. 29 an exemplary request record table 2902 which may comprise a number of request records is provided. One or more request records may be associated with or resident in the database 2820 (FIG. 28). The request record table 2902 may include information of requests which may be processed. Request records 2900 may include a request ID field 2905, a request category field 2910, a request guide ID field 2915, a request user ID field 2920, a request input field 2925, a request answer ID field 2930, a request answer resource field 2935, and a request ID message field 2940.

The request ID field 2905 includes an identifier of a request which is preferably unique and is preferably used consistently. A request ID serves to distinguish a request record associated with a request from a request record associated with other requests. Any number of characters, numbers, and/or other indicators may be used to indicate a request ID. In at least one embodiment, a request ID associated with a request is included in the request ID field 2905. In at least one embodiment, a random number is indicated in the request ID field 2905. Using the example in FIG. 29, ‘RequestB1’ is the request ID associated with the request record 2900a.

The request category field 2910 may include information of a category associated with a request. Information indicated in the request category field 2910 may be used to select an item associated with a request. For example, a category associated with a request may be used to rank guides who may be associated with the type of request. Likewise, a category associated with a request may be used to rank requests and/or other items which may be presented to a guide or responder. A category or type associated with a request may be determined based on factors such as keywords of a query, a profile of a user, a selection of a guide, a user history, etc. A category associated with a system taxonomy may be indicated in the request category field 2910. A category may be associated with a request automatically and/or using the assistance of a person. Using the example in FIG. 29, ‘RequestB2’ may be categorized as ‘Opinion>Fashion>Shoes’ as indicated in the request record 2900b. This may indicate that a person or item associated with the category ‘Opinion>Fashion>Shoes’ may have a higher ranking for responding to ‘RequestB2’. A category of a request may be associated with a user submitting the request. Content of a request such as a keyword, named entity, etc. may be used to assign a category or type to a request.

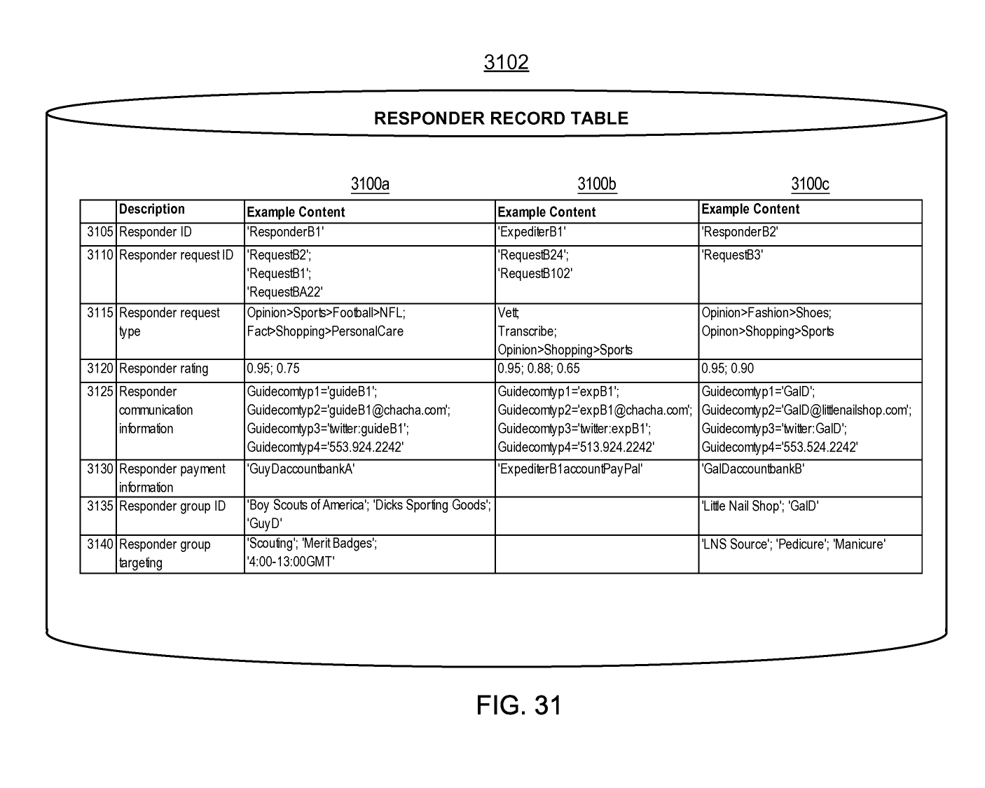

The request guide ID field 2915 may include information of a number of guides or responders associated with a request. Content of the request guide ID field 2915 may be used to obtain information of a guide or responder using a record such as the responder record depicted in FIG. 31. If a person is selected for a request, elects to receive a request, provides a response to a request, reviews a result of a request and/or completes a request, an identifier of the person may be indicated in the request guide ID field 2915. Using the example in FIG. 29, ‘ResponderB2’ is associated with ‘RequestB3’. This may for example indicate that ‘RequestB3’ has been responded to by ‘ResponderB2’.

The request user ID field 2920 may include information of a number of users associated with a request. Content of the request user ID field 2920 may be used to obtain information of a user associated with a request. For example, if a request is submitted by a user, an identifier of the user may be indicated in the request user ID field 2920. A request may not be associated with a user request. For example, the search system 2830 (FIG. 28) may provide requests to persons which are not directly related to a user request. The search system 2830 may provide a request to a searcher based on a selection of the request by a sponsor. Using the example in FIG. 29, ‘UserB1’ is associated with ‘RequestB1’ and ‘RequestB3’ and ‘UserB2’ is associated with ‘RequestB2’. This may indicate that ‘RequestB1’ and ‘RequestB3’ were submitted by ‘UserB1’ while ‘RequestB2’ was submitted by ‘UserB2’.

The request input field 2925 may include information of a request. Content of the request input field 2925 may be provided to a person who accepts a request. Content of the request input field 2925 may include any type of information. For example, a pointer to audio, video, text, and/or other media may be indicated in the request input field 2925. As illustrated in FIG. 29, the query ‘What does a manicure cost at The Little Nail Shop in Carmel, IN?’ is the request input associated with ‘RequestB3’, as indicated in the request record 2900c. In at least one embodiment, the request input field 2925 may indicate an original user request, a categorization, and a rewritten user request.

The request answer ID field 2930 may include information of a response associated with a request. Content of the request answer ID field 2930 may be provided responsive to a request. Content of the request answer ID field 2930 may be stored in the database 2820 (FIG. 28). Content of the request answer ID field 2930 may be reviewed and/or rated by a user, a guide, a responder and/or an administrator. As illustrated in FIG. 29, the response ‘A basic manicure costs $25 at The Little Nail Shop in Carmel, IN’ is associated with ‘RequestB3’ as illustrated in the request record 2900c. While a text response to a query is used for the purposes of illustration, any type of media may be indicated in the request answer ID field 2930. In at least one embodiment, a text response and a URL associated with a source of the text response may be indicated in the request answer ID field 2930.

The request answer resource field 2935 may include information of a search resource associated with a request. Content of the request answer resource field 2935 may be used to provide a search result. For example, a guide may cut a snippet of text from a web page in order to create a response to a request. A resource used by a responder and/or other information relating to a source of a response may be indicated in the request answer resource field 2935. Content of the request answer resource field 2935 may be produced automatically and/or using the assistance of a person. Using the example in FIG. 29, the resource<<www.crocs.com/crocs-store-locator/stores>> is associated with ‘RequestB2’. This may indicate that the answer indicated in the request answer ID field 2930 was produced using that resource.

The request ID message field 2940 may include information of an identifier provided with a response. For example, an identifier of a responder who has provided a response may be indicated in the request ID message field 2940. Content of the request ID message field 2940 may indicate an identifier of an entity such as a trademark, trade name, etc. Content of the request ID message field 2940 may indicate information of an individual such as an avatar, a photograph, a name, etc. which may identify a responder. As illustrated in FIG. 29, a response to ‘RequestB1’ may indicate that ‘GuyD’ responded, while a response to ‘RequestB2’ may indicate that Dick'sSportingGoods' responded, even though ‘ResponderB1’ may have produced a response for both ‘RequestB1’ and ‘RequestB2’.

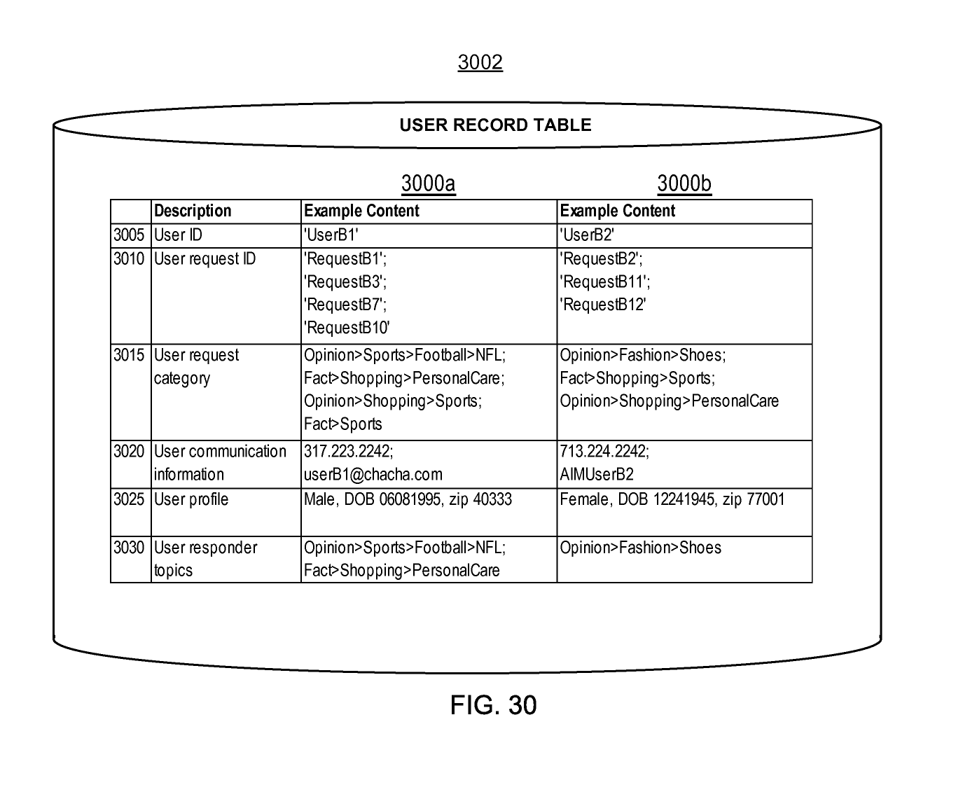

As illustrated in FIG. 30 an exemplary user record table 3002, which may comprise a number of user records is provided. One or more user records may be associated with or resident in the database 2820 (FIG. 28). The user record table 3002 may include information of users. User records 3000 may include a user ID field 3005, a user request ID field 3010, a user request category field 3015, a user communication information field 3020, a user profile field 3025, and a user responder topics field 3030.

The user ID field 3005 includes an identifier of a user which is preferably unique and is preferably used consistently. A user ID serves to distinguish a user record associated with a user from a user record associated with other users. Any number of characters, numbers, and/or other indicators may be used to indicate a user ID. In at least one embodiment, a random number is indicated in the user ID field 3005. Using the example in FIG. 30, ‘UserB1’ is the user ID associated with the user record 3000a.

The user request ID field 3010 may include information of a number of requests associated with a user. A user request ID may be for example a pointer to a request record associated with a request submitted by a user. If a user submits a request, a request ID may be added to the user request ID field 3010. Using the example illustrated in FIG. 30, ‘RequestB2’, ‘RequestB11’ and ‘RequestB12’ are associated with ‘UserB2’ as indicated in the user record 3000b. This may indicate that ‘UserB2’ has submitted ‘RequestB2’, ‘RequestB11’ and ‘RequestB12’.

The user request category field 3015 may include information regarding a category or type associated with a user request. For example, if a request is directed to a type of processing or a category, etc., a type and/or category associated with the processing may be indicated in the user request category field 3015. In at least one embodiment, the user request ID field 3010 and the user request category field 3015 are linked by for example a pointer. In at least one embodiment, a category associated with a request of a user may affect whether a message will be provided. An affiliation of a user may affect a category associated with a request of a user.

The user communication information field 3020 may include information of a number of communication services associated with a user. Any information which may be used to establish communication with a user may be indicated in the user communication information field 3020. For example, a telephone number, an email address, an IM credential, a URL, a username, a password, and/or other communication information may be indicated in the user communication information field 3020. Using the example in FIG. 30, the phone number ‘317.223.2242’ and the email ‘userB1@chacha.com’ are associated with ‘UserB1’.

The user profile field 3025 may include information of a profile associated with a user. For example, demographic, geographic, affiliation, personality, and/or other types of anthropic and/or other characteristic information may be associated with a user. A user may provide profile information as part of a registration process. User profile information may be obtained from a database provided by a third party. User profile information may be determined based on a test, polling, query history, peer review, and/or other information associated with a user. Using the example illustrated in FIG. 30, ‘Female, DOB 12241945, zip 77001’ are associated with ‘UserB2’. Profile information may be used to match information provided by a user to other information. For example, a ranking of a guide for a query of a user may be adjusted based on a profile associated with the user. An answer and/or a message might be modified based on geographic, demographic, etc., profile information of a user.

The user responder topics field 3030 may include information of responder topics associated with a user. The user responder topics field 3030 may include information of topics, types, keywords, categories, etc., which may be used to direct a request or task to a user. For example the user responder topics associated with ‘UserB1’ in the user record 3000a are ‘Opinion>Sports>Football>NFL’ and ‘Fact>Shopping>PersonalCare’; This may indicate that ‘UserB1’ has responded to and/or may be interested in responding to requests and/or items associated with those topics.

As illustrated in FIG. 31 an exemplary responder record table 3102 which may comprise a number of responder records is provided. One or more responder records may be associated with or resident in the database 2820 (FIG. 28). The responder record table 3102 (FIG. 31) may include information of responders. Responder records 3100 may include a responder ID field 3105, a responder request ID field 3110, a responder request type field 3115, a responder rating field 3120, a responder communication information field 3125, a responder payment information field 3130, a responder group ID field 3135, and a responder group targeting field 3140.

The responder ID field 3105 includes an identifier of a responder which is preferably unique and is preferably used consistently. A responder ID serves to distinguish a responder record associated with a responder from a responder record associated with other responders. Any number of characters, numbers, and/or other indicators may be used to indicate a responder ID. In at least one embodiment, a random number is indicated in the responder ID field 3105. In at least one embodiment, a pseudonym selected by a responder may be indicated in the responder ID field 3105. Using the example in FIG. 31, ‘ResponderB1’ is the responder ID associated with the responder record 3100a. A responder ID may be a user ID. The responder ID field 3105 may include information of an identifier of a responder which may be displayed when a response produced by a responder is presented.

The responder request ID field 3110 may include information of a number of requests associated with a responder. Content of the responder request ID field 3110 may be used to obtain information of a request. For example, if a user request has been determined to require a number of requests to be performed, the search system 2830 (FIG. 28) may assign a unique ID to the requests and may distribute information of the requests to responders. Using the example in FIG. 31, ‘RequestB2’, ‘RequestB1’, and ‘RequestBA22’ are associated with ‘ResponderB1’ as indicated in the responder record 3100a. This may indicate that ‘ResponderB1’ has responded to or handled ‘RequestB2’, ‘RequestB1’ and ‘RequestBA22’.

The responder request type field 3115 may include information of a number of types of requests which may be processed by a responder. For example, a category and/or keyword associated with a request, a type of request, temporal information associated with a request, etc., which may be used to determine if a responder is to be presented with a request may be indicated in the responder request type field 3115. In at least one embodiment, a responder may be assigned to a particular type of request as part of a registration process. A responder may select a type of request which the responder may perform. A responder may be required to pass a test in order to be associated with a type of request. A responder may be assigned to a role such as expediter, searcher, etc., which may be indicated in the responder request type field 3115. A request indicating a keyword may be directed to a responder. Using the example in FIG. 31, ‘ExpediterB1’ is associated with the types ‘Vett’, ‘Transcribe’, and ‘Opinion>Shopping>Sports’. This may for example indicate that ‘ExpediterB1’ may be presented with and/or selected to respond to requests indicating those categories and/or types.

The responder rating field 3120 may include information of a number of ratings associated with a responder. For example, quality, speed, peer review, etc., may be used to determine a rating of a responder. A rating of a responder may be used for purposes such as determining compensation for the responder, selecting a responder to respond to a request, matching a request to a responder, etc. In at least one embodiment, the responder request type field 3115 and the responder rating field 3120 may be linked by, for example, a pointer. Using the example in FIG. 31, ‘ResponderB2’ has a rating of ‘0.95’ associated with ‘Opinion>Fashion>Shoes’, and a rating of ‘0.90’ associated with ‘Opinion>Shopping>Sports’ which may be used to rank ‘ResponderB2’ versus other responders associated with the request types ‘Opinion>Fashion>Shoes’, and ‘Opinion>Shopping>Sports’. For example, ‘ResponderB2’ might be more likely to be selected to respond to a request associated with ‘Opinion>Shopping>Sports’ than ‘ExpediterB1’.

The responder communication information field 3125 may include information of a number of communication services associated with a responder. For example, a user name and password, an email address, an IM credential, a phone number, a web page, a physical address, etc., may be indicated in the responder communication information field 3125. Using the example illustrated in FIG. 31, ‘ResponderB2’ is associated with the login ID ‘GaID’, the email ‘GaID@littlenailshop.com’, the Twitter account ‘twitter.GaID’, and the phone number ‘553.524.2242’. This may indicate that ‘ResponderB2’ may be contacted using the associated communication services.

The responder payment information field 3130 may include information of a payment method associated with a responder. For example, banking information, a PayPal® account, a Western Union® account, etc., may be indicated in the responder payment information field 3130. Content of the responder payment information field 3130 may be used to provide compensation to a responder. For example, payment may be made by Automated Clearing House (ACH), wire transfer, etc., using information indicated in the responder payment information field 3130. As indicated in FIG. 31, the responder ‘ResponderB2’ is associated with ‘GaIDaccountbankB’.

The responder group ID field 3135 may include information of groups associated with a responder. A responder group may be a company, an organization and/or any collection of responders. For example ‘Boy Scouts of America’; ‘Dick's Sporting Goods’ and ‘GuyD’ are all responder groups associated with ‘ResponderB1’ as indicated by the responder group ID field 3135 of the responder record 3100a. This may indicate that ‘ResponderB1’ is associated with ‘Boy Scouts of America’ and ‘Dick's Sporting Goods’ and may respond to queries directed towards these groups, and may provide a response which is indicated as originating from those groups. For example, if a rating of an answer produced by ‘ResponderB1’ associated with a query directed to ‘Boy Scouts of America’ is greater than a predetermined value an indicator of ‘Boy Scouts of America’ may be provided with a response.

The responder group targeting field 3140 may include information of targeting data associated with a responder and/or a responder group. For example, ‘ResponderB1’ is associated with ‘Boy Scouts of America’, ‘Dick's Sporting Goods’ and ‘GuyD’ as indicated by the responder record 3100a. This may indicate that ‘ResponderB1’ may be eligible to respond to request directed to ‘Scouting’ and ‘Merit Badges’ as a member of ‘Boy Scouts of America’ at any time and as a member of ‘Dick's Sporting Goods’ between the hours of ‘04:00-13:00GMT’ and as ‘GuyD’ at any time on any basis.

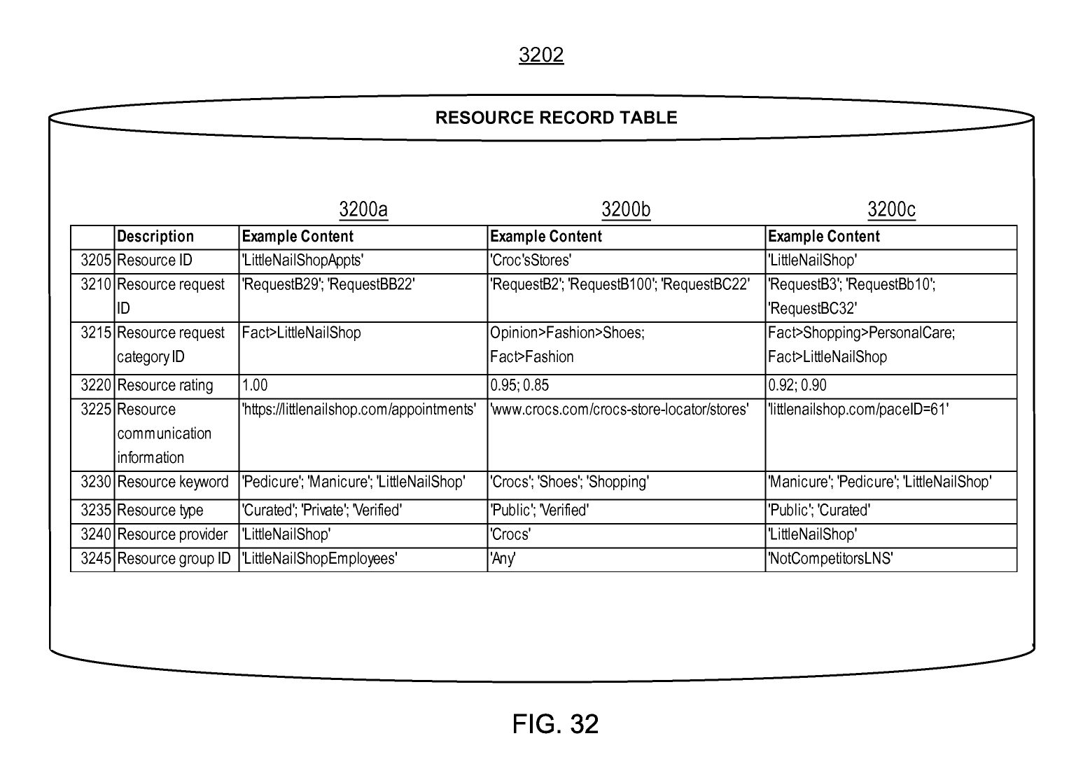

As illustrated in FIG. 32 an exemplary resource record table 3202 which may comprise a number of resource records Is provided. One or more resource records may be associated with or resident in the database 2820 (FIG. 28). The resource record table 3202 (FIG. 32) may include information of resources. Resource records 3200 may include a resource ID field 3205, a resource request ID field 3210, a resource request category ID field 3215, a resource rating field 3220, a resource communication information field 3225, a resource keyword field 3230, a resource type field 3235, a resource provider field 3240, and a resource group ID field 3245.

The resource ID field 3205 includes an identifier of a resource which is preferably unique and is preferably used consistently. A resource ID serves to distinguish a resource record associated with a resource from a resource record associated with other resources. Any number of characters, numbers, and/or other indicators may be used to indicate a resource ID. Using the example in FIG. 32, ‘LittleNailShopAppts’ is the resource ID associated with the resource record 3200a.

The resource request ID field 3210 may include information of a number of requests associated with a resource. Content of the resource request ID field 3210 may be used to obtain information of a request. For example, if a resource has been used to respond to a request, an identifier of the request may be indicated in the resource request ID field 3210. Using the example in FIG. 32, ‘RequestB2’, ‘RequestB100’ and ‘RequestBC22’ are associated with the resource ‘Croc'sStores’ as indicated in the resource record 3200b. This may indicate that ‘Croc'sStores’ has been utilized to respond to ‘RequestB2’, ‘RequestB100’ and ‘RequestBC22’.

The resource request category ID field 3215 may include information of a number of categories of requests which may be processed by a resource. For example, a category and/or keyword associated with a request, a type of request, profile, etc., which may be used to determine if a resource is to be presented to a guide or responder for a request may be indicated in the resource request category ID field 3215. In at least one embodiment, a resource may be assigned to a category of request as part of a registration process. A resource may be associated with a user, a group of users, an access right, an advertiser or sponsor, etc. A provider of a resource may select a type and/or category of request for which a resource may be used and/or required. A resource may be associated with a category based on a selection by an administrator, based on success rates of obtaining or providing answers, etc. Using the example in FIG. 32, ‘LittleNailShop’ is associated with the categories ‘Fact>Shopping>PersonalCare’ and ‘Fact>LittleNailShop’ as indicated by the resource record 3200c.

The resource rating field 3220 may include information of a number of ratings associated with a resource. For example, a rating of a resource may be based on ratings of answers produced using the resource, a contractual agreement, an affiliation, temporal information such as time spent by guides, etc. A rating of a resource may be used to select a resource which is provided to a searcher or guide or responder, to rank a response associated with a resource, etc. In at least one embodiment, the resource request category ID field 3215 and the resource rating field 3220 may be linked by, for example, a pointer. Using the example in FIG. 32, ‘Croc'sStores’ has a rating of ‘0.95’ associated with ‘Opinion>Fashion>Shoes’, and a rating of ‘0.85’, associated with ‘Fact>Fashion’ which may indicate a probability that ‘Croc'sStores’ may produce an acceptable response for those categories. A resource may have a rating corresponding to various categories, types of information, types of tasks, keywords, etc.

The resource communication information field 3225 may include information of a number of communication services associated with a resource. For example, a user name and password, an email address, an IM credential, a phone number, a web page, a physical address, etc., may be indicated in the resource communication information field 3225. A communication service indicated in the resource communication information field 3225 may for example be used to indicate a service by which a resource may be accessed. Using the example illustrated in FIG. 32, the URL <<littlenailshop.com/paceID=61>> is associated with ‘LittleNailShop’. This may indicate that a query associated with ‘Fact>Shopping>PersonalCare’ may be submitted to that URL by for example an API and/or that the resource may be processed to obtain an answer and/or presented to a responder.

The resource keyword field 3230 may include information of a number of keywords associated with a resource. A match to a keyword indicated in the resource keyword field 3230 may affect a probability that a request will receive a response associated with a resource. For example, a match may prohibit a query from receiving a result from a resource, may increase a ranking of a resource, may be used to associate a category with a request, may identify a resource to be provided to a guide, etc. In at least one embodiment, keywords included in requests for which a resource has provided an answer may be more highly ranked for a category associated with the query and the resource. A responder may select keywords associated with a resource provided by the responder.

The resource type field 3235 may include information of a number of types or characteristics associated with a resource. A type may include an indication of an access right, a commercial arrangement, a preference, quality of content, source of content, etc. A searcher or responder may elect to associate a resource with a type. A system administrator may associate a type with a resource. A provider of a resource may designate a type associated with the resource for example as part of a registration process. Using the example in FIG. 32, ‘LittleNailShopAppts’ is a ‘Verified’, ‘Private’, ‘Curated’ resource. This may indicate that content of the resource is controlled, that the resource is not accessible to the general public, and that the content of the resource is verified to be correct.

The resource provider field 3240 may include information of a provider of a resource. A resource may be provided by any number of advertisers and/or responders. As illustrated in FIG. 32, ‘Crocs’ is the resource provider associated with ‘Croc'sStores’ as indicated by the resource record 3200b.

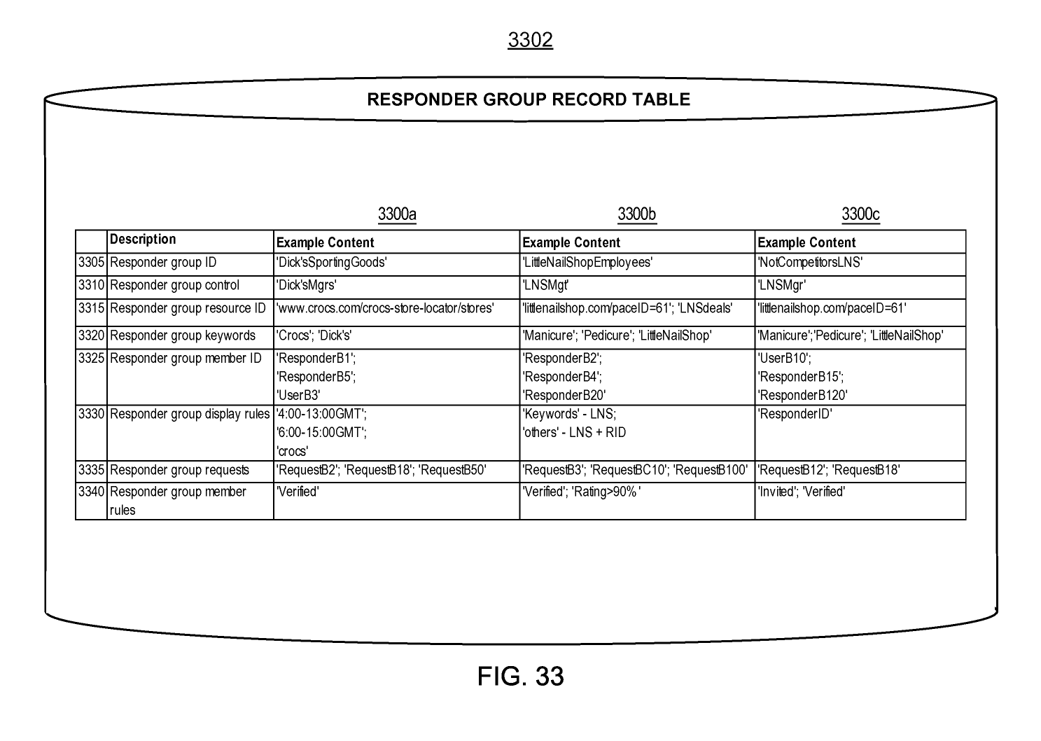

The resource group ID field 3245 may include information of a responder group. A responder group may have an identifier as illustrated in FIG. 33, which may appear in the resource group ID field 3245. ‘NotCompetitorsLNS’ is the resource group ID associated with resource record 3200c. This may indicate that members of the group ‘NotCompetitorsLNS’ may be able to access, may be provided with access to, may be more likely to be presented with, etc. the resource ‘LittleNailShop’. This may be used to limit whether a resource is presented to a predetermined group of users and/or responders.

As illustrated in FIG. 33, an exemplary responder group record table 3302 which may comprise a number of responder group records is provided. One or more responder group records may be associated with or resident in the database 2820 (FIG. 28). The responder group record table 3302 (FIG. 33) may include information of responder groups. Responder group records 3300 may include a responder group ID field 3305, a responder group control field 3310, a responder group resource ID field 3315, a responder group keywords field 3320, a responder group member ID field 3325, a responder group display rules field 3330, a responder group requests field 3335, and a responder group member rules field 3340.

The responder group ID field 3305 includes an identifier of a responder group which is preferably unique and is preferably used consistently. A responder group ID serves to distinguish a responder group record associated with a responder group from a responder group record associated with other responder groups. Any number of characters, numbers, and/or other indicators may be used to indicate a responder group ID. In at least one embodiment, a random number is indicated in the responder group ID field 3305. In at least one embodiment, a pseudonym selected by a responder group may be indicated in the responder group ID field 3305. Using the example in FIG. 33, ‘Dick'sSportingGoods’ is the responder group ID associated with the responder group record 3300a.

The responder group control field 3310 may include information of a control for a responder group. A control for a responder group may be a person, a group, a corporation, an agency, etc. A responder group control may indicate a person, a type of person, a set of rules, etc., which may control parameters such as membership, topics, categories, resources, display rules, etc. which may be associated with a responder group. As illustrated in FIG. 33, INSMgr is the responder group control associated with ‘LittleNailShopEmployees’ as indicated by the responder group record 3300b. This may indicate that a member of the group INSMgr may have various access rights for the group ‘LittleNailShopEmployees’. A responder group may be controlled by a set of rules. A responder may belong to a group via a hashtag, QR code or other mechanism of showing interest in a group. A responder may respond for the group immediately, after showing competency, and/or after a specified amount of time or questions have been answered according to group rules. A responder may be associated with a group by a “hashtag” or other means of identifying with a group. For example, if a responder includes a hashtag within an answer, if the answer is redistributed in some manner, a responder may be determined to be a member of a group associated with the hashtag. Redistribution of an answer may be done according to various services such as email, Twitter (“re-Tweeting”), FaceBook “likes”, etc. which may indicate approval and/or interest in an answer of a responder by peers or experts. For example, if a person or entity with a large number of followers or a high level of reputation redistributes an answer that action may have a higher impact than the same action by a person and/or entity with a lower reputation. In this way, a group may be created without use of an individual or group of managers of a group.

The responder group resource ID field 3315 may include information concerning a resource of a responder group. A responder group may use any number of resources to answer a query. A responder group may include members of a company and/or entity and a resource may be provided by the company. For example, the responder group resource ID for ‘NotCompetitorsLNS’ is ‘littlenailshop.com/paceID=61’. This may indicate responses from ‘NotCompetitorsLNS’ may be required to come from the resource ‘littlenailshop.com/paceID=61’, that the resource ‘littlenailshop.com/paceID=61’ may be referred to as a source for a response only if a responder is a member of ‘NotCompetitorsLNS’, etc.

The responder group keywords field 3320 may include information of keywords of a responder group. A responder group may, at any time, select keywords which may be of interest to a responder group in order to receive queries or requests. A responder group may be interested in keywords which may correspond to a business of a responder. As illustrated in FIG. 33, the keywords ‘Manicure’; ‘Pedicure’ and ‘LittleNailShop’ are associated with the responder groups ‘LittleNailShopEmployees’ and ‘NotCompetitorsLNS’, as indicated in the responder group table 3302. This may indicate that a member of ‘LittleNailShopEmployees’ might be provided with access to the resource ‘LNSdeals’ which might not be accessible to responders associated with ‘NotCompetitorsLNS’.

The responder group member ID field 3325 may include information of group members of a responder group. A responder group may comprise any number of members which may be identified by a user ID, a guide ID, etc. A responder group may identify members of a group in order to determine which responder may perform various activities. The responder group ‘LittleNailShopEmployees’ is associated with ‘ResponderB2’, ‘ResponderB4’ and ‘ResponderB20’ as indicated in the responder group record 3300b. This may indicate that a responder of the group may have an indicator selected by “LNSMgt” associated with a response provided by a group member.

The responder group display rules field 3330 may include information concerning rules of a responder group. A responder group may respond to a query containing keywords, but may not be required to respond. A responder group may have rules pertaining to how, where, and when a response may be provided. A responder may be associated with a group and the identifier of a group response may be a trademark or other identifier of a group. A responder group may have a preapproved answer that may be provided responsive to a request. A responder of a group may be used to provide a response when an answer is unavailable. As illustrated in FIG. 33, ‘ResponderB1’ may respond for the group ‘Dick'sSportingGoods’ during the hours of 4:00-13:00GMT. Thus during the designated time interval a response of ‘ResponderB1’ may be accompanied by the ‘Dick'sSportingGoods’ logo or trademark. Outside of these times ‘ResponderB1’ may respond to queries, but may not be permitted to use the ‘Dick'sSportingGoods’ logo. Instead a response of ‘ResponderB1’ may indicate a different logo, or may simply be identified by an identifier such as a logo or avatar which indicates ‘ResponderB1’. Content of the responder group display rules field 3330 may be linked with content of the responder group member ID field 3325. For example, as indicated in the responder record 3300a, ‘UserB3’ as indicated in the responder group member ID field 3325 may respond to a request directed to ‘Dick'sSportingGoods’ if the request is associated with the keyword ‘crocs’ as indicated in the responder display rules field 3330. Any type of rules may be implemented based on information indicated in the responder group rules field 3330. For example, a rating of responses by a responder may be used to determine whether a responder may be associated with an identifier of a group, similarly, a number of responses, a number of accepted responses, etc. may be used to determine whether a response of a responder may be identified as a response of a responder group.

The responder group requests ID field 3335 may include information of a number of requests associated with a responder group. Content of the responder group requests ID field 3335 may be used to obtain information of a request. For example, if a user request has been determined to require a number of requests to be performed, the search system 2830 (FIG. 28) may assign a unique ID to the requests and may distribute information of the requests to responders. Using the example in FIG. 33, ‘RequestB12’ and ‘RequestB18’ are associated with ‘NotCompetitorsLNS’ as indicated in the responder record 3300c. This may indicate that ‘NotCompetitorsLNS’ has expedited, handled, responded to, been selected to receive, etc., ‘RequestB12’, and ‘RequestB18’.

The responder group member rules field 3340 may include information of a number of rules associated with a responder group. Rules associated with a responder group may determine membership of a responder group. In one embodiment, a group may not have a manager and/or group controller and membership may be subject to member rules. As illustrated in FIG. 33, in order to be a responder group member and respond for ‘NotCompetitorsLNS’ a responder must be ‘Invited’ and ‘Verified’. This may indicate that a member of the group must be invited by INSMgr as indicated in the responder group control field 3310. A responder may need to be verified as to identity and/or other information in order to be a member of a responder group. This may allow a selected group of responders to access non-public information provided by a responder, such as a resource indicated in the responder group resource ID field 3315. A membership of a responder group may be determined by rules membership rules of a responder group and may determine whether and which responders may utilize a responder group identifier such as a trademark, logo, etc.

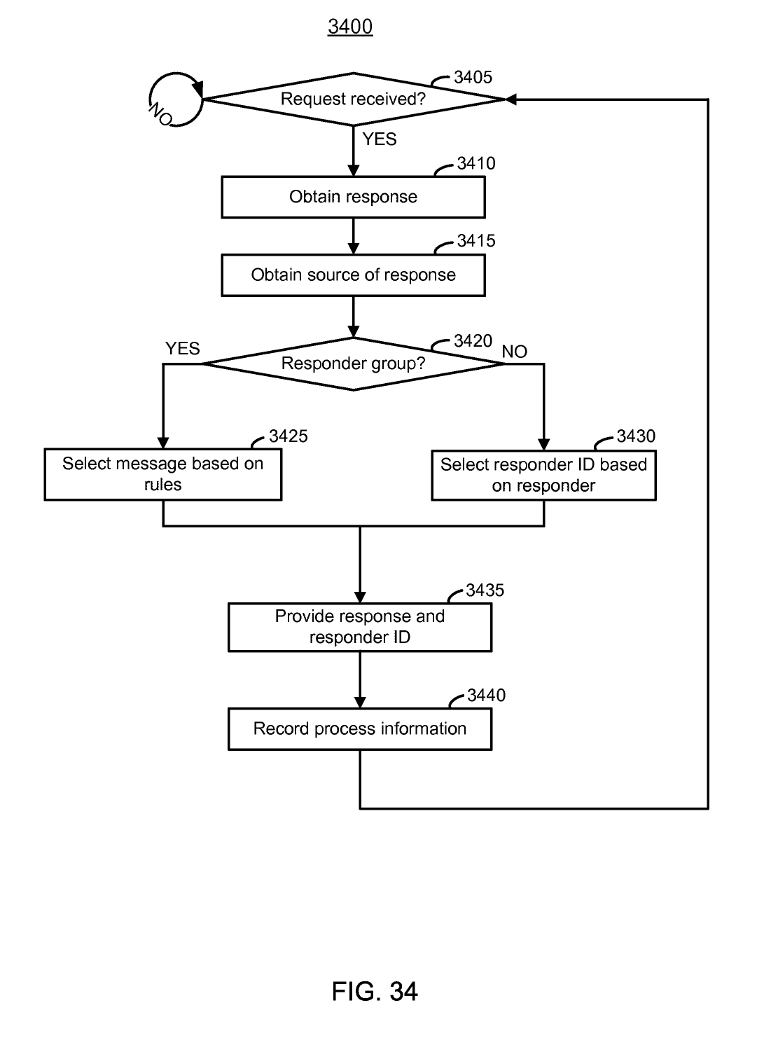

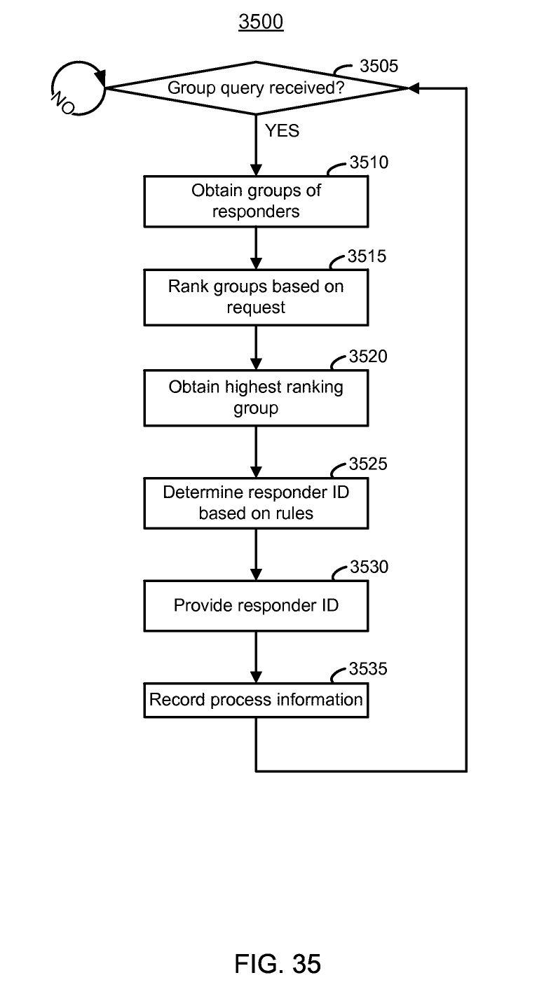

As illustrated in FIG. 34, a process 3400 for responding to a request is provided. The process 3400 may be performed in whole or in part by any suitable element of the system 2800 (FIG. 28). In at least one embodiment, the process 3400 is operative on a server associated with the search system 2830. A request may be a request for an automated answer, a human assisted answer and/or a combination thereof. The process 3400 may be incorporated with a process such as the process 3500 (FIG. 35).

In operation 3405 (FIG. 34), a determination is made as to whether a request is received. If it is determined in operation 3405 that a request is not received, control remains at operation 3405 and process 3400 continues. If it is determined in operation 3405 that a request is received, control is passed to operation 3410 and process 3400 continues.

The determination in operation 3405 may be made using various criteria. In at least one embodiment, if a message is received at a system associated with the search system 2830 (FIG. 1), it may be determined that a request is received. For example, if an email message, an SMS, EMS, and/or MMS message, an IM, an IP message, and/or a voice message is received at an address associated with the search system 2830, it may be determined that a request is received. If a message is received at a server associated with the search system 2830, it may be determined that a request is received.

In operation 3410 a response is obtained. A response may be obtained programmatically using a database, software application, stored information, etc. A response may be obtained from a resource. For example, a query may be submitted to a resource, a responder and/or a responder group may select media provided by a resource and may obtain a response from a resource, etc. An answer or response may be obtained by directing a task to a guide. Any number of responses may be obtained. Control is passed to operation 3415 and process 3400 continues.

In operation 3415 a source of a response is obtained. For example, a responder providing a response, a resource associated with a response, a guide, a user, an advertiser or sponsor, a group, etc., that has provided an answer may be determined. Stored information regarding a response may be used to obtain a source of a response. Any number of sources may be associated with a response. Control is passed to operation 3420 and process 3400 continues.

In operation 3420 (FIG. 34) a determination is made as to whether a responder group produced a response. If it is determined in operation 3420 that a responder group produced a response, control passes to operation 3425 and process 3400 continues. If it is determined in operation 3420 that a responder group did not produced a response, control is passed to operation 3430 and process 3400 continues.

The determination in operation 3420 may be made using various criteria. If a responder of a responder group has acted on a request, it may be determined that a responder group has produced a response. If a response is produced using a resource provided by a responder group, it may be determined that a responder group has produced a response. If a responder group has verified a response, it may be determined that a responder group has produced a response. If a response of a responder group is a highest ranking response for a request, it may be determined that a responder group has produced a response. Any suitable criteria may be used to determine whether a responder group has produced a response.

In operation 3425 a message is selected based on rules. A group may be associated with various rules such as only accepting a request during certain time periods, and/or only accepting a request containing a keyword. A responder group may limit queries to topics, keywords, named entities etc. that are of interest or designated by a responder group. Responders within a group may respond to questions during certain times or only queries which indicate a keyword. A group may be associated with any number of rules which may be used in selecting a message or identifier of a responder group which is provided with a response associated with a responder group. Rules may determine whether an identifier of a responder group is to be used as a responder ID and/or whether an identifier of a responder is to be used as a responder ID. Control is passed to operation 3435 and process 3400 continues.

In operation 3430 a responder ID based on a responder is selected. A responder ID may be selected based on a responder. Each responder may have a preferably unique and preferably consistently used ID to differentiate themselves from another responder. A responder may be selected based on an ID, because a responder ID may be associated with a type or category of a request. A responder may use a responder group ID if a request is recognized by a responder and/or a responder may use a personal responder ID to respond to a query. For example, a responder may be an employee of Little Shop of Nails, but may not be able to responder to queries after a certain time, and may instead respond as an individual. As a default, an identifier of a responder assigned during a registration process may be a responder ID. Control is passed to operation 3435 and process 3400 continues.

In operation 3435 a response and responder ID are provided. Any number of responses and/or responder IDs may be provided. A response and/or a responder ID may be provided in any suitable form. For example, a responder ID and a response may be provided as a pointer to a location from which the response and the responder ID may be obtained. A number of responses and/or responder IDs may be presented in any order and/or may be ranked and provided in an order based on rank. A responder ID may include an identifier of a responder group and/or an individual responder. A responder group ID may vary based on a source of a response. For example, if a responder group member has a higher rating, a responder ID of a group may be different than a responder ID of the group presented when a lower rated group member has provided a response. Similarly, if multiple responses of a responder are provided, identifiers associated with responders and/or responder groups associated with the responses may be provided. A responder group ID may comprise an advertisement. Control is passed to operation 3440 and process 3400 continues.

In operation 3440 process information is recorded. Information of a request, an advertisement, an answer, a resource, a user, a sponsor, an advertiser, a guide, a rating, a ranking, a responder group, etc. may be recorded. A response may be rated, ranked, or deleted. Usage and compensation associated with an answer, and advertisement, a responder, etc. may be recorded. In at least one embodiment, process information is recorded in the database 2820 (FIG. 28). Control is passed to operation 3405 and process 3400 continues.

As illustrated in FIG. 35, a process 3500 for receiving a group query is received. The process 3500 may be performed in whole or in part by any suitable element of the system 2800 (FIG. 28). In at least one embodiment, the process 3500 is operative on a server associated with the search system 2830. A request may be a request for any group to respond which may include various media. A group query may be a query which is provided or directed to a group, rather than an individual.

In operation 3505 (FIG. 35) a determination is made as to whether a group query is received. If it is determined in operation 3505 that a group query is not received, control remains at operation 3505 and process 3500 continues. If it is determined in operation 3505 that a group query is received, control is passed to operation 3510 and process 3500 continues.

The determination in operation 3505 may be made using various criteria. In at least one embodiment, if a group query is received at a system associated with the search system 2830 (FIG. 1), it may be determined that a request is received. For example, if an email message, an SMS, EMS, and/or MMS message, an IM, an IP message, and/or a voice message is received at an address associated with the search system 2830, it may be determined that a request is received. If a message is received at a server associated with the search system 2830, it may be determined that a group request is received.

In operation 3510 groups of responders are obtained. Groups of responders may be obtained based on keywords, named entities, topics, categories, resources, etc., associated with a group of responders. A responder may be associated with a single group and/or multiple groups. A responder may be associated with a group by a hashtag and/or other means and may be a member of a group. A responder may be associated with a group and may not necessarily be a member of a group. For example, a responder may have been invited to a group but has not accepted an invitation, included a hashtag or equivalent in a response, but not met rules of the group, etc. Control is passed to operation 3515 and process 3500 continues.

In operation 3515 groups are ranked based on a request. Groups of responders may be ranked based on various items associated with a responder group. A group may have a higher rating than another group and may be ranked higher. A group may have chosen to respond to keywords in a query while another group did not which may affect a ranking of a responder group. A responder group may be ranked higher based on another group being blocked by a requester. Any factor available for ranking a group may be used. For example, if a responder group has a high ranking for queries associated with NCAA football, a group might be more highly ranked for queries which may relate to sports than queries related to dining. A ranking of a responder group may be based on ratings and/or rankings of members of a responder group. For example, a highest ranking responder may determine a ranking of a responder group of which the responder is a member. A ranking of a responder group may be based on a mathematical formula such as an average, maximum, minimum, etc., rating of answers by a responder of a group. If a responder is a member of multiple groups, ratings of other responders may influence a ranking of a responder group. Control is passed to operation 3520 and process 3500 continues.

In operation 3520 a highest ranking group is obtained. Any number of groups may be considered a highest ranking group. A responder group may rank higher than another based on responses to a query, keywords, topics, categories, resources, bidding, business rules, etc. Control is passed to operation 3525 and process 3500 continues.

In operation 3525 a responder ID is determined based on rules. A responder ID may be determined based on rules set by a responder group. A responder group may select a responder ID based on time, keywords of a query, resources used to respond, etc., which are part of a set of rules of a responder group. A responder ID may be an identifier of a group, a responder, and/or both. A responder ID may include any identifier associated with a group and/or a responder. For example, a store of a national chain associated with a location might have a different identifier than a store of the same chain associated with a different location. Control is passed to operation 3530 and process 3500 continues.

In operation 3530 a responder ID is provided. A responder ID may be provided in any number of ways. A responder ID may be provided from a server and/or may include text, images, and/or any suitable media which may be delivered to a device associated with a user. A responder ID may be a trademark or logo of a responder group and/or a personal logo for a responder. A responder ID may be associated with a responder group and/or may be provided as an individual depending on association with the group, rules of the group, etc. Control is passed to operation 3535 and process 3500 continues.

In operation 3535 process information is recorded. Information of a request, an advertisement, an answer, a resource, a user, a sponsor, an advertiser, a group, a guide, a rating, a ranking, etc., may be recorded. A response may be rated, ranked, or deleted. Usage and compensation associated with an answer, and advertisement, a responder, etc. may be recorded. In at least one embodiment, process information is recorded in the database 2820 (FIG. 28). Control is passed to operation 3505 and process 3500 continues.

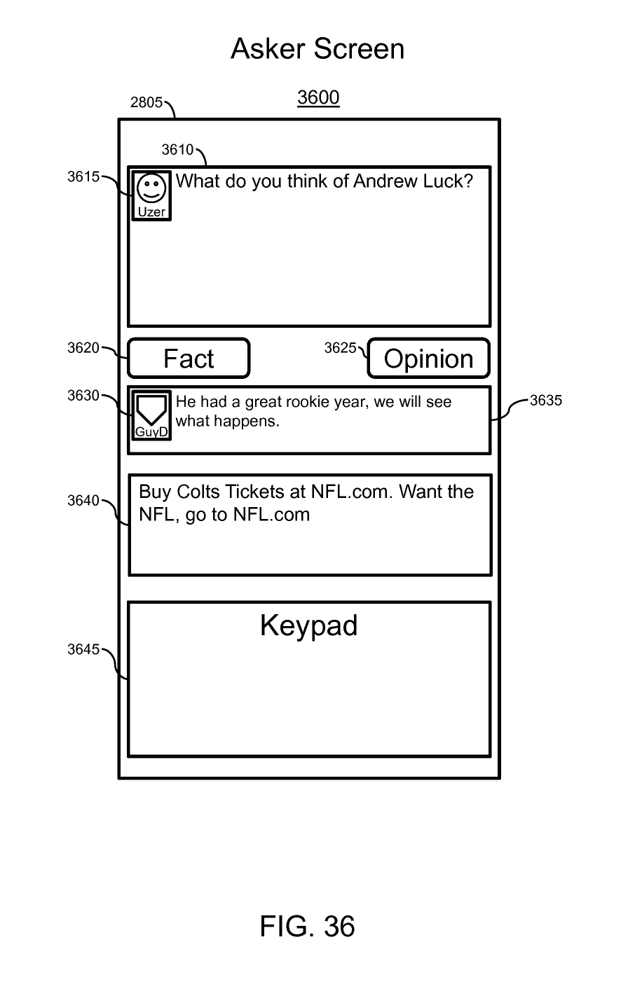

As illustrated in FIG. 36 an exemplary GUI 3600 is provided. The query submission GUI 3600 may be provided to a user. The GUI 3600 may be presented using a system such as the user system 2805 (FIG. 28). The GUI 3600 may be used to submit any type of request. The GUI 3600 may include a query entry area 3610, a user identifier 3615, a factual query indicator 3620, an opinion query indicator 3625, a responder indicator 3630, a response indicator 3635, an advertisement field 3640 and user controls 3645.

The request entry area 3610 may be used to indicate information of a request. The user identifier 3615 may be used to indicate information of a user submitting a request. The factual query indicator 3620 may be used to indicate that a request is a request for factual information. The opinion query indicator 3625 may be used to indicate that a request is a request for subjective information. The responder indicator 3630 may be used to indicate a source of a response. The response indicator 3635 may be used to indicate a response associated with a request indicated in the request indicator 3610. The advertisement field 3640 may be used to provide an advertisement or responder message related to the query in request entry area 3610. For example, the advertisement field 3640 may include a message selected based on ‘GuyD’ as indicated in the responder indicator 3630. The user controls 3645 may be used to submit a request. While a keypad is used for purposes of illustration, any user input device which is well known in the art may be used to implement the user controls 3645.

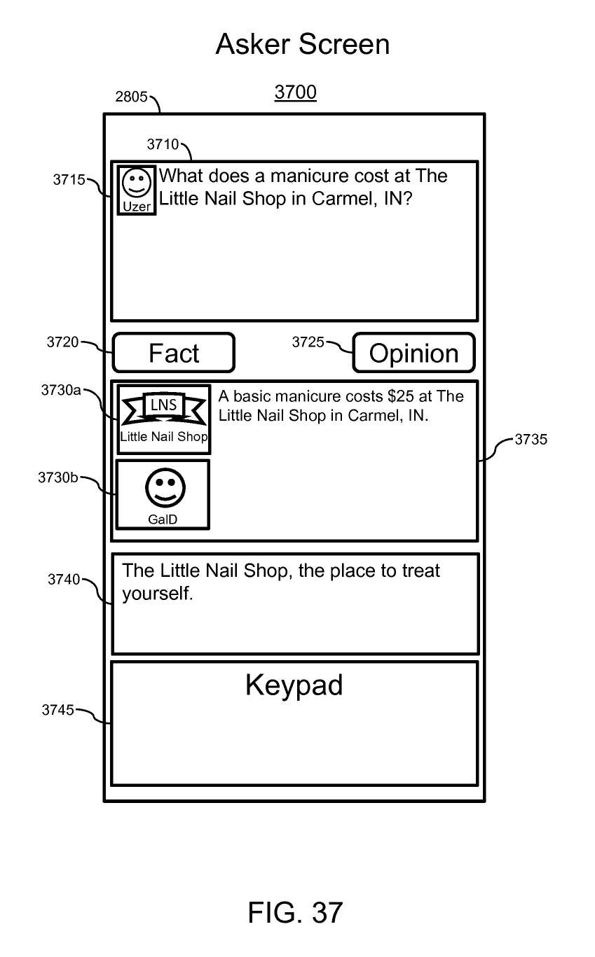

As illustrated in FIG. 37 an exemplary GUI 3700 is provided. The query submission GUI 3700 may be provided to a user. The GUI 3700 may be presented using a system such as the user system 2805 (FIG. 28). The GUI 3700 may be used to submit any type of request. The GUI 3700 may include a query entry area 3710, a user identifier 3715, a factual query indicator 3720, an opinion query indicator 3725, responder indicators 3730, a response indicator 3735, an advertisement field 3740 and user controls 3745.

The request entry area 3710 may be used to indicate information of a request. The user identifier 3715 may be used to indicate information of a user submitting a request. The factual query indicator 3720 may be used to indicate that a request is a request for factual information. The opinion query indicator 3725 may be used to indicate that a request is a request for subjective information. The responder indicators 3730a, 3730b may be used to indicate a source of a response, which may be a group as indicated by the ‘LittleNailShop’ responder indicator 3730a or an individual as indicated by the ‘GaID’ responder indicator 3730b, which may collectively indicate that ‘GaID’ is a member of the responder group ‘LittleNailShop’. The response indicator 3735 may be used to indicate a response associated with a request indicated in the request indicator 3710. The advertisement field 3740 may be used to provide an advertisement or responder message related to the query in request entry area 3710. For example, the advertisement field 3740 may include a message selected based on the responder group ‘LittleNailShop GaID’. A responder group may be permitted to choose an advertisement which may be related to their product or business as an incentive to answer a query. The user input control 3745 may be used to submit a request. While a keypad is used for purposes of illustration, any user input device which is well known in the art may be used to implement the user input control 3745.

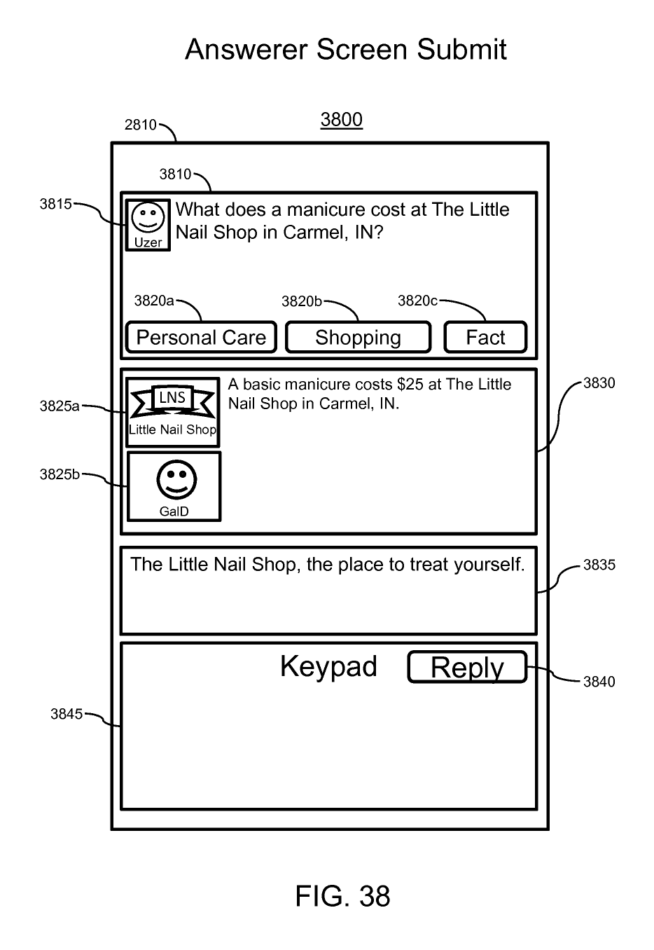

An exemplary GUI 3800 for providing a response to a request is illustrated in FIG. 38. The GUI 3800 may be presented using a device such as the user system 2810 and/or the responder system 2835 (FIG. 28). A responder may be provided with the GUI 3800 at any time. If a responder group is provided with a request and/or accepts to respond, the GUI 3800 may be provided. The GUI 3800 may include a query indicator 3810, a user indicator 3815, category indicators 3820a-3820c, responder indicators 3825, an answer indicator 3830, an advertisement field 3835, an action control 3840 and input controls 3845.

The query indicator 3810 may be used to indicate information of a query to which a responder group and/or member of a responder has chosen to respond. The user indicator 3815 may be used to indicate information of a user associated with a request. The category indicators 3820a-3820c may be used to indicate information associated with a request, which may be used to select requests, messages and/or advertisements. The responder group indicator 3825a may indicate information of a responder group submitting a response. The answer indicator 3830 may be used to indicate a response provided by a responder indicated by the responder indicator 3825b. The advertisement field 3835 may indicate an advertisement and/or responder group message which may be presented if a responder group activates the answer indicator 3830. The action control 3840 may be used to indicate that a response indicated in the response indicator 3830 is to be provided as a response to the query indicated in the query indicator 3810. Any number of answer indicators and/or advertisement indicators may be provided in the GUI 3800. A responder may select and/or may reject an advertisement provided in the advertisement indicator 3835. The input controls 3845 may be used to submit a response. While a keypad is used for purposes of illustration, any user input device which is well known in the art may be used to implement the input controls 3845. For example, a responder of a responder group may use a keypad, voice, etc. to indicate a response.

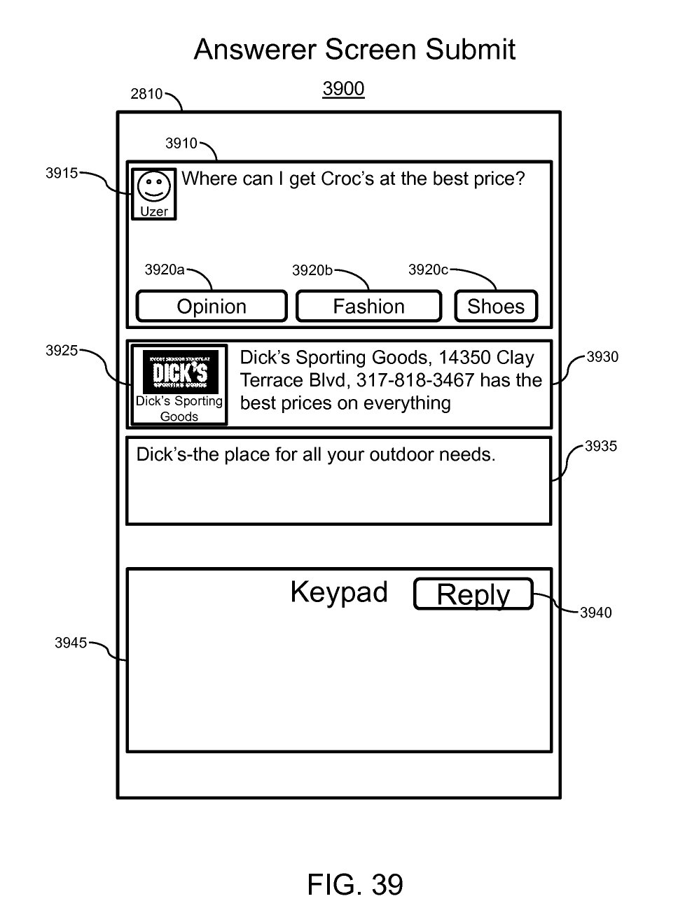

An exemplary GUI 3900 for providing a response to a request is illustrated in FIG. 39. The GUI 3900 may be presented using a device such as the user device 2810 (FIG. 28). A responder may be provided with the GUI 3900 at any time. If a responder group is provided with a request and accepts to respond, the GUI 3900 may be provided. The GUI 3900 may include a query indicator 3910, a user indicator 3915, category indicators 3920a-3920c, a responder group indicator 3925, an answer indicator 3930, an advertisement field 3935, an action control 3940 and input controls 3945.

The query indicator 3910 may be used to indicate information of a query to which a responder group has chosen to respond. The user indicator 3915 may be used to indicate information of a user associated with a request. The category indicators 3920a-3920c may be used to indicate information associated with a request, which may be used to select requests, messages and/or advertisements. The responder group indicator 3925 may indicate information of a responder group submitting a response. The responder group indicator 3925 may provide visual feedback to a responder regarding a responder group rule which is applied to a response. The answer indicator 3930 may be used to indicate a respond provided by a responder member of a group indicated by the responder indicator 3925 The advertisement field 3935 may indicate an advertisement and/or responder group message which may be presented if a responder group activates the answer indicator 3930. The action control 3940 may be used to indicate that a response indicated in the response indicator 3930 is to be provided as a response to the query indicated in the query indicator 3910. Any number of answer indicators and/or advertisement indicators may be provided in the GUI 3900. A responder may select and/or may reject an advertisement provided in the advertisement indicator 3935. The input controls 3945 may be used to submit a response. While a keypad is used for purposes of illustration, any user input device which is well known in the art may be used to implement the input controls 3945. For example, a responder group may use a keypad, voice, etc. to indicate a response.

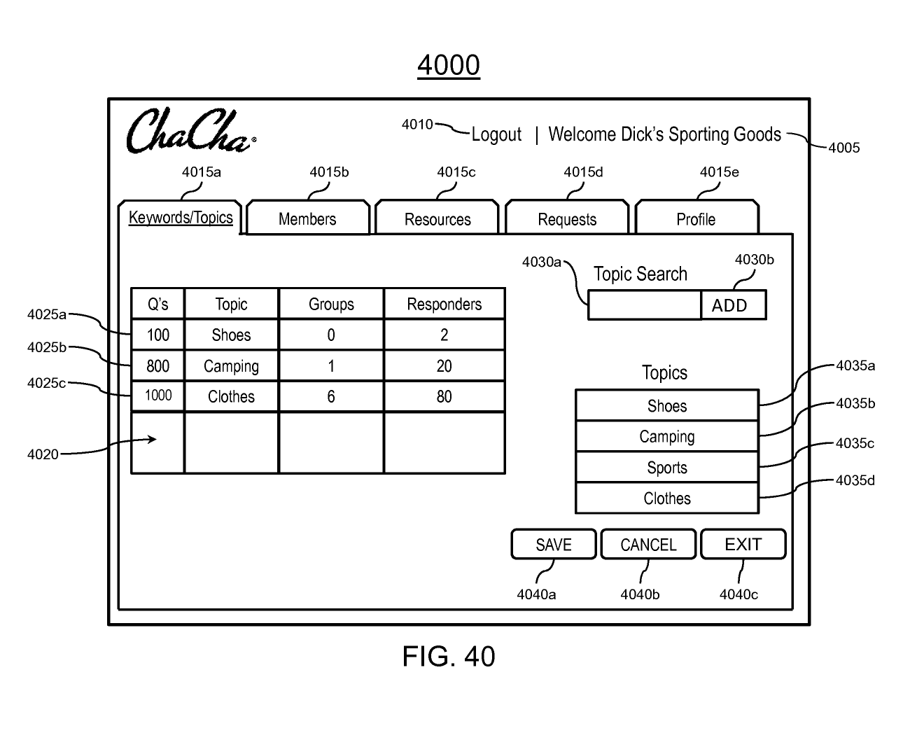

As illustrated in FIG. 40 an exemplary GUI 4000 is provided. The GUI 4000 may be presented using a device such as the responder device 2840 (FIG. 28). The GUI 4000 may be used by a responder group to select information which may be used to direct a query to a responder group. For example, a person with management rights associated with a responder group might select, approve, review and/or otherwise manage targeting information of a responder group using the GUI 4000. The GUI 4000 may include a user indicator 4005, a login control 4010, selection tabs 4015a-4015e, a targeting information window 4020, target information indicators 4025a-4025c, topic filtering controls 4030a, 4030b, topic indicators 4035a-4035d, and action controls 4040a-4040c.

The user indicator 4005 may indicate information of an operator of the GUI 4000. The login control 4010 may be used to login or log out. The selection tabs 4015a-4015e may be used to view various types of targeting information which may be used to direct a query to a responder group. For example, the ‘Keywords/Topics’ selection tab 4015a may be used to manage information of topics and/or keywords of a responder group. The ‘Members’ selection tab 4015b may be used to manage information concerning members of a responder group. The ‘Resources’ selection tab 4015c may be used to manage information of resources of a responder group. The ‘Requests’ selection tab 4015d may be used to manage information of requests of a responder group. The ‘Profile’ selection tab 4015e may be used to manage demographic, geographic, etc. information associated with a responder group. An active tab may be indicated in any typical manner such as color, font, etc. The ‘Keywords/Topics’ selection tab 4015a is active as indicated by the underlining in FIG. 40.

The targeting information window 4020 may be used to present information indicated by an active selection tab. For example, the number of questions (Q's) relating to a topic, groups for responding to a topic, and responders within a group who may be members of a group and may respond to a topic may be indicated. The targeting information indicator 4025a may present information regarding the topic ‘Shoes’, which may be more attractive to a responder since comparatively few groups are registered for ‘Shoes’ versus the number of groups signed up for ‘Clothes’ 4025c. Content of the targeting information window 4020 may be sorted according to any of the displayed fields in order to assist a responder group in selecting targeting information. The topic filtering control 4030a may be used to enter information of a desired topic, which may affect content of the targeting information window 4020. The ‘ADD’ topic filtering control 4030b may be used to add a topic to the current topic indicators 4035a-4035d. The current topic indicators 4035a-4035d may be used to indicate topics and/or targeting information for which a responder group has elected to receive requests. A topic may be removed by for example a ‘right click’ or ‘dragging’ a topic from a current topic indicator. The ‘SAVE’ action control 4040a may be used to store information obtained using the GUI 4000. The ‘CANCEL’ action control 4040b may be used to cancel any changes made using the GUI 4000. The ‘EXIT’ action control 4040c may be used to close the GUI 4000 without saving information obtained. While a limited number of target information indicators and topic indicators have been used for purposes of illustration, any number of target information indicators and topic indicators might be presented in the GUI 4000.

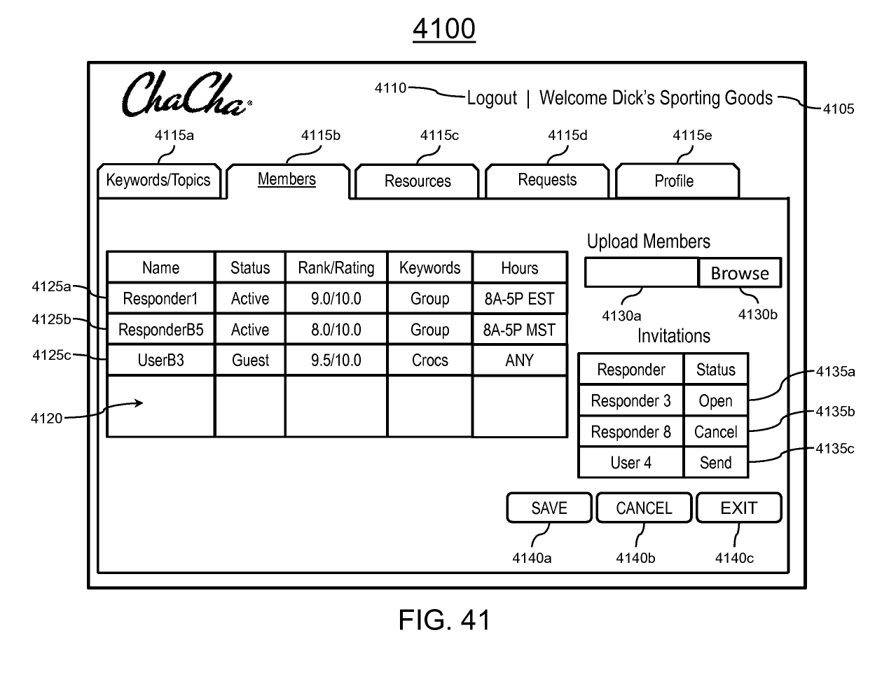

As illustrated in FIG. 41 an exemplary GUI 4100 is provided. The GUI 4100 may be presented using a device such as the responder system 2835 (FIG. 28). The GUI 4100 may be used by a responder group to select information which may be used to determine membership of a responder group. For example, a person with management rights associated with a responder group might select, approve, review, create a rule, modify a rule, and/or otherwise manage membership information of a responder group using the GUI 4100. The GUI 4100 may include a user indicator 4105, a login control 4110, selection tabs 4115a-4115e, a member information window 4120, member information indicators 4125a-4125c, member upload controls 4130a, 4130b, invitation indicators 4135a-4135c, and action controls 4140a-4140c.

The user indicator 4105 may indicate information of an operator of the GUI 4100. The login control 4110 may be used to login or log out. The selection tabs 4115a-4115e may be used to view various types of information of a responder group. For example, the ‘Keywords/Topics’ selection tab 4115a may be used to manage information of topics and/or keywords of a responder group. The ‘Members’ selection tab 4115b may be used to manage information concerning members of a responder group. The ‘Resources’ selection tab 4115c may be used to manage information of resources of a responder group. The ‘Requests’ selection tab 4115d may be used to manage requests received by a responder group. The ‘Profile’ selection tab 4115e may be used to manage demographic, geographic, etc. information associated with a responder group. An active tab may be indicated in any typical manner. The ‘Members’ selection tab 4115b is active as indicated by the underlining in FIG. 41.

The member information window 4120 may be used to present information of members as indicated by an active selection tab. For example, name, status, rank/rating, keyword and hours may be represented in the member information window 4120. The member information indicator 4125a may indicate that ‘ResponderB1’ is active. This may indicate ‘ResponderB1’ is an active member of a responder group indicated in the user indicator 4105, unlike ‘UserB3’ who is a Guest member as indicated by the member information indicator 4125c. Similarly, ‘ResponderB1’ may have a higher rank than ‘ResponderB5’ and thus may be more likely to receive a request targeted to ‘Dick's Sporting Goods’ than ‘ResponderB5’. The member information window 4120 may indicate that ‘ResponderB1’ is available from 8A-5P EST, whereas ‘ResponderB5’ is available 8A-5P MST which may affect a ranking of a responder, as well as whether a response of a responder is associated with a responder group indicated in the user indicator 4105. The keywords field of the member information window 4120 may indicate that a responder may take questions containing keywords of a group or may be restricted to specific keywords of interest. For example, if a query includes the keyword ‘Crocs’ as indicated by the member information indicator 4125c, it may be that a response of ‘UserB3’ may be presented with an identifier of a responder group indicated in the user indicator 4105 if a request indicates the keyword ‘Crocs’. The member upload control 4130a may be used to indicate a file from which member information may be obtained. For example, a database, spreadsheet, mailing list, etc. may be identified using the member upload control 4130a. The ‘Browse’ member upload control 4130b may be used to locate a membership file from any available media using well known browsing techniques. Use of the member upload controls 4130a, 4130b may add an invitation indicator to the invitation indicators 4135a-4135c. The invitation indicators 4135a-4135c may be used to indicate status of responders who have been invited to join, may be invited to join, have requested to join, or otherwise are associated with a responder group. An invitation may be removed from an invitation indicator by for example a ‘right click’ or ‘dragging’ a topic from an invitation list. Likewise, activation of an invitation indicator may cause a status of an invitation to be modified. Activation of an invitation indicator may provide information of a responder associated with an invitation indicator. The ‘SAVE’ action control 4140a may be used to store information obtained using the GUI 4100. The ‘CANCEL’ action control 4140b may be used to cancel any changes made using the GUI 4100. The ‘EXIT’ action control 4140c may be used to close the GUI 4100 without saving information obtained. While a limited number of member information indicators and invitation indicators have been used for purposes of illustration, any number of member information indicators and invitation indicators might be presented in the GUI 4100.

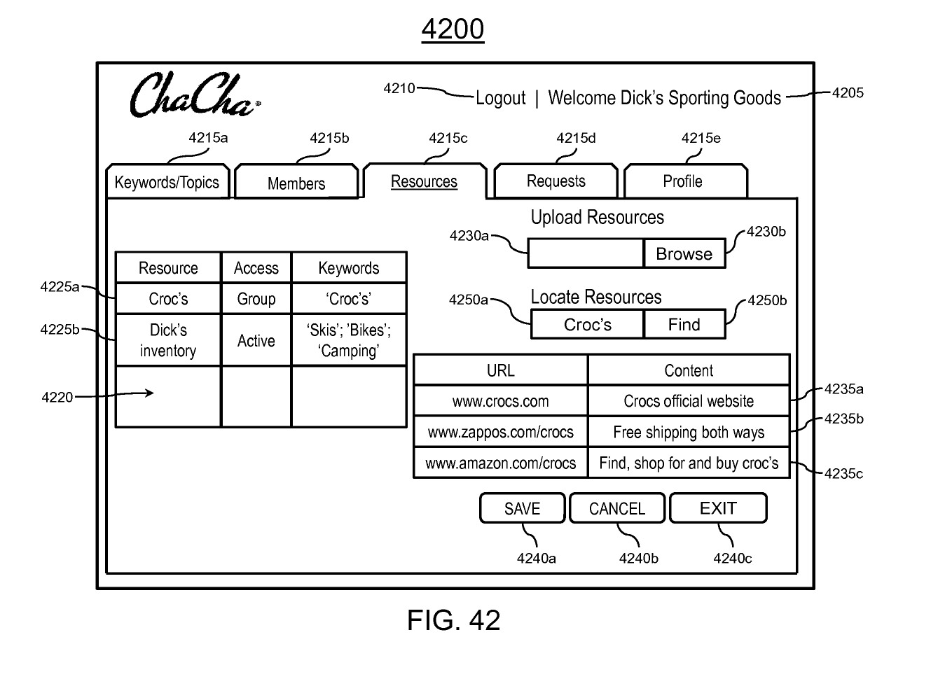

As illustrated in FIG. 42 an exemplary GUI 4200 is provided. The GUI 4200 may be presented using a device such as the responder system 2835 (FIG. 28). The GUI 4200 may be used by a member of a responder group to select information which may be used by a responder when a query is directed to a responder group. For example, a person with management rights for a responder group may manage information of resources associated with a responder group using the GUI 4200. The GUI 4200 may include a user indicator 4205, a login control 4210, selection tabs 4215a-4215e, a resource information window 4220, resource information indicators 4225a-4225b, resource upload controls 4230a, 4230b, resource selection indicators 4235a-4235c, action controls 4240a-4240c, and resource locator controls 4250a, 4250b.

The user indicator 4205 may indicate information of an operator of the GUI 4200. The login control 4210 may be used to login or log out. The selection tabs 4215a-4215e may be used to view various types of information which may be associated with a responder group. For example, the ‘Keywords/Topics’ selection tab 4215a may be used to view information of queries and/or advertisements associated with topics or keywords. The ‘Members’ selection tab 4215b may be used to view information concerning members of a responder group. The ‘Resources’ selection tab 4215c may be used to view information of resources of a responder group. The ‘Requests’ selection tab 4215d may be used to obtain information of requests of a responder group. The ‘Profile’ selection tab 4215e may be used to manage demographic, geographic, etc. information associated with a responder group. An active tab may be indicated in any typical manner. The ‘Resources’ selection tab 4215c is active as indicated by the underlining in FIG. 42.

The resource information window 4220 may be used to present information of resources indicated by an active selection tab. For example, a resource, access information of a resource and keywords associated with a resource may be presented. The resource information indicator 4225a indicates the resource ‘Croc's’ requires group membership to be accessed and the resource Dick's Inventory 4225b is available solely to ‘Active’ responders. The resource ‘Croc's’ may be used when a query indicates the keyword ‘Croc's’ which may not be associated with the resource Dick's Inventory. Therefore, if a request tagged with the topic ‘Croc's’ may cause the resource ‘Croc's’ to be provided to members of the group ‘Dick's Sporting Goods’ as indicated in the resource information indicator 4225a. Thus members of a responder group may be provided with a set of resources which are selected, rated and distributed according to rules established for a responder group. The resource upload controls 4230a may be used to provide access to resource information, which may affect content of the resource information window 4220. For example, a list of URLS, ranking information, keywords, topics, etc., may be uploaded to assist in management of resources for a responder group. The ‘Browse’ resource filtering control 4230b may be used to select files using a browse functionality of an application such as a browser to add a resource to the current resource information indicators 4225a, 4225b. A resource may be located using the resource locators 4250a, 4250b. The resource locator 4250a may be used to input a query using which a search for resources may be performed. The ‘Find’ resource locator 4250b may be used to execute a search for a resource based on a query indicated in the resource locator 4250a. A resource located using the resource locator controls 4250a, 4250b may be included in the resource content indicators 4235a-4235c. The resource content indicators 4235a-4235c may be used to indicate content such as a URL, which may be used as a resource. A resource may be added to the resource information window 4220 by for example a ‘right click’ or ‘dragging’ a resource from a resource content indicator to the resource information window 4220. The resource selection indicators 4235a-4235c may include information of content of a resource, keywords associated with a resource, a ranking of resources, etc. The ‘SAVE’ action control 4240a may be used to store information obtained using the GUI 4200. The ‘CANCEL’ action control 4240b may be used to cancel any changes made using the GUI 4200. The ‘EXIT’ action control 4240c may be used to close the GUI 4200 without saving information obtained. While a limited number of resource indicators and resource locator controls have been used for purposes of illustration, any number of resource indicators and resource locator controls might be presented in the GUI 4200.

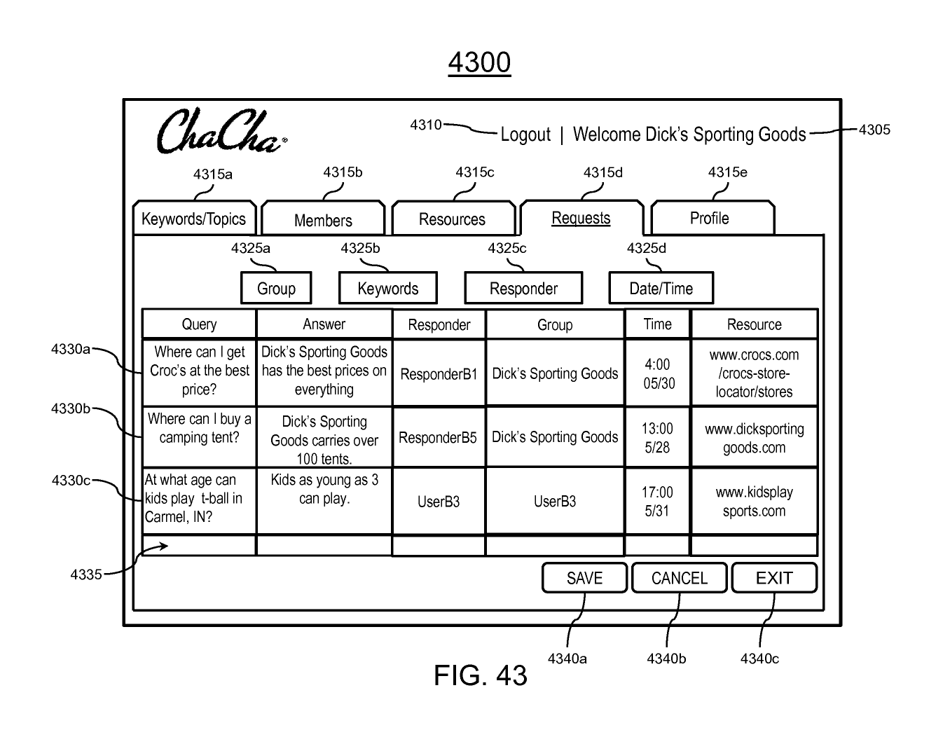

As illustrated in FIG. 43 an exemplary GUI 4300 is provided. The GUI 4300 may be presented using a device such as the responder system 2835 (FIG. 28). The GUI 4300 may be used by a member of a responder group to select and/or review information of a query of a responder group. The GUI 4300 may include a user indicator 4305, a login control 4310, selection tabs 4315a-4315e, request selection indicators 4325a-4325d, request information indicators 4330a-4330c, a request information window 4335, and action controls 4340a-4340c.

The user indicator 4305 may indicate information of an operator of the GUI 4300. The login control 4310 may be used to login or log out. The selection tabs 4315a-4315e may be used to view various types of information of a responder group. For example, the ‘Keywords/Topics’ selection tab 4315a may be used to manage information of topics and/or keywords of a responder group. The ‘Members’ selection tab 4315b may be used to manage information concerning members of a responder group. The ‘Resources’ selection tab 4315c may be used to manage information of resources of a responder group. The ‘Requests’ selection tab 4315d may be used to manage requests of a responder group. The ‘Profile’ selection tab 4315e may be used to manage demographic, geographic, etc. information associated with a responder group. An active tab may be indicated in any typical manner. The ‘Requests’ selection tab 4315d is active as indicated by the underlining in FIG. 43.

The request information window 4335 may be used to present information of requests as indicated by an active selection tab. For example, a query, an answer, a responder, a group to which a responder belongs, temporal information of a response and a resource associated with a request may be presented in the request information window 4335. A member of a responder group may use the request selection indicators 4325a-4325d to determine information provided in the request information window 4335. For example, a responder group name indicated in the ‘Group’ request selection indicator 4325a may cause requests associated with a group to be presented in the request information window 4335. Similarly requests associated with a responder of a group might be provided when the responder name is indicated in the request selection indicator 4325c. The request selection indicators 4325 may be used alone or in any combination to select information presented in the request information window 4335. The request selection indicators 4325 may include a list of options which may be selected.

The request information indicator 4330a indicates the request ‘Where can I get Croc's at the best price?’ which may have been answered by ‘ResponderB1’ with the group ID ‘Dick's Sporting Goods’ at four AM on May 30 using the resource <<www.crocs.com/crocs-store-locator/stores>>. Content of the request information window 4335 may be sorted based on any field of the request information window 4335. The ‘SAVE’ action control 4340a may be used to store information obtained using the GUI 4300. The ‘CANCEL’ action control 4340b may be used to cancel any changes made using the GUI 4300. The ‘EXIT’ action control 4340c may be used to close the GUI 4300 without saving information obtained. While a limited number of request indicators and request selection indicators have been used for purposes of illustration, any number of request indicators might be presented in the GUI 4300.

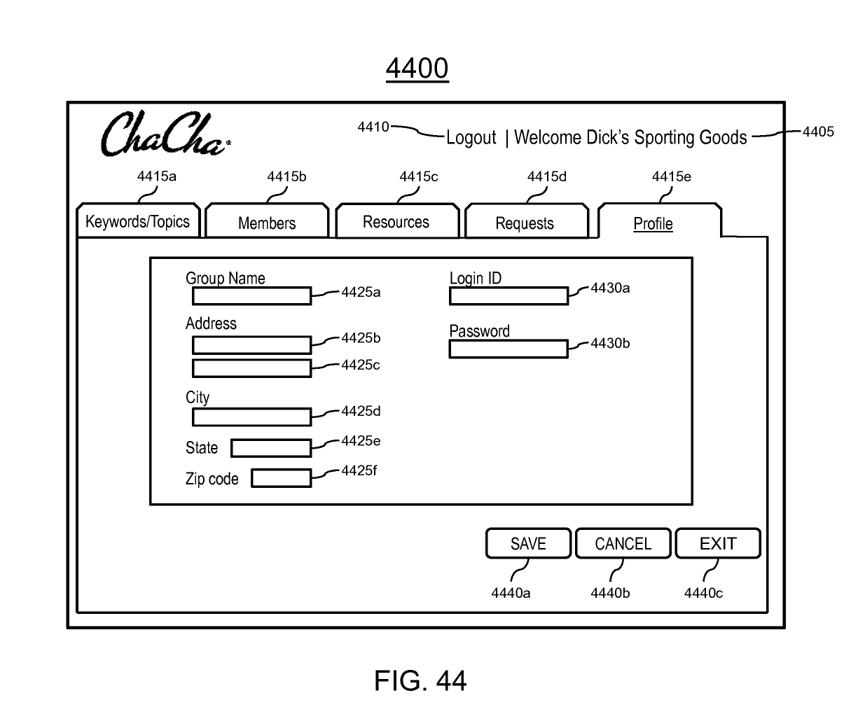

As illustrated in FIG. 44 an exemplary GUI 4400 is provided. The GUI 4400 may be presented using a device such as the user device 2810 (FIG. 28). The GUI 4400 may be used to manage information of a profile of a responder group. For example, a person with management rights associated with a responder group might select, approve, review and/or otherwise manage profile information of a responder group using the GUI 4400. The GUI 4400 may include a user indicator 4405, a login control 4410, selection tabs 4415a-4415e, responder group information indicators 4425a-4425f, login information indicators 4430a, 4430b, and action controls 4440a-4440c.

The user indicator 4405 may indicate information of an operator of the GUI 4400. The login control 4410 may be used to login or log out. The selection tabs 4415a-4415e may be used to view various types of information of a responder group. For example, the ‘Keywords/Topics’ selection tab 4415a may be used to manage information of topics and/or keywords of a responder group. The ‘Members’ selection tab 4415b may be used to manage information concerning members of a responder group. The ‘Resources’ selection tab 4415c may be used to manage information of resources of a responder group. The ‘Requests’ selection tab 4415d may be used to manage requests of a responder group. The ‘Profile’ selection tab 4415e may be used to manage demographic, geographic, etc. information associated with a responder group. An active tab may be indicated in any typical manner. The ‘Profile’ selection tab 4415e is active as indicated by the underlining in FIG. 44.

The responder group information indicators 4425a-4425f may be used to provide information of a responder group. For example, a responder group may provide name, address, city, state and zip code when updating and/or registering a profile. A responder group may also indicate a login ID in the login information indicator 4430a and a password associated with the unique Login ID in the login information indicator 4430b which may be used to update a password. Changes to a profile may be made by for example overtyping information indicated in the responder group information indicators 4425a-4425f. The ‘SAVE’ action control 4440a may be used to store information obtained using the GUI 4400. The ‘CANCEL’ action control 4440b may be used to cancel any changes made using the GUI 4400. The ‘EXIT’ action control 4440c may be used to close the GUI 4400 without saving information obtained. While a limited number and type of responder group information indicators have been used for the purposes of illustration in FIG. 44, any type of profile information of a responder group may be provided using the GUI 4400, such as information of organizational elements of an entity, geographic, demographic, psychographic, affiliation, etc.

Using the methods and systems described herein a method and system for management of a group of responders is described. An identifier of a responder group which may appear with a response associated with a responder group may be determined based on various factors. A responder group may be determined on any basis. Rules for membership of a responder group may be established. An identifier of a responder group may be presented in conjunction with an identifier of a responder providing an answer. An identifier of a responder group may be suppressed based on a keyword of a query for which a response is provided. An identifier of a responder group may be suppressed if a rating or ranking of a responder does not meet a criterion. An identifier of a responder and/or a responder group may be suppressed based on factors such as a keyword, temporal information, a location, a user, etc.

A responder group may be managed by a person. A responder group may be managed based on a set of rules. A responder group may be created based on a meme such as a hashtag, etc. For example, if a responder includes a hashtag in a response, a response of a responder may include an identifier of a group associated with the hashtag based on rules associated with the group. An identifier of a group may be provided with a response of a responder based on a rating. A rating may be determined based on actions such as acceptance of answers, sharing or republication of content or a responder, and/or a ranking or reputation of a person who may redistribute content of a responder.

While the embodiments herein are described with respect to a peer-to-peer answering system, other types of systems might benefit from the system and methods described herein. For example, systems in which responses are provided to customer inquiries such as an auction website, a services directory, a discussion forum, etc., might employ the system and methods to enhance service, provide reputation monitoring, promote greater usage and transparency and better utilize assets and staffing.

A system and method for managing responder groups is described. A responder group identifier may be presented when a response of a member of a responder group is provided based on content of request, response, and/or a ranking of a responder and/or responder group. An identifier of a responder may be presented in conjunction with an identifier of a responder group based on membership, keywords and/or metadata associated with a request.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal. Further, according to an aspect of the embodiments, any combinations of the described features, functions and/or operations can be provided.

The many features and advantages of the claimed invention are apparent from the detailed specification and thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”

What is claimed is:

1. A computer-implemented process comprising:
receiving a request;
obtaining a response;
selecting an advertisement based on a source of the response; and
providing the response and the advertisement.

2. The method of claim 1 further comprising:
receiving the response from a resource provided by a sponsor; and
selecting the advertisement based on the sponsor.

3. The method of claim 1 further comprising:
receiving an answer from a resource provided by a sponsor; and
selecting the advertisement based on the sponsor when a human assistant selects the answer as the response.

4. The method of claim 1 further comprising:
receiving an answer from a human assistant provided by a sponsor; and
selecting the advertisement based on the sponsor and time information associated with the request.

5. The method of claim 1 further comprising:
selecting the advertisement based on a provider of the response and a demographic specified by the provider.

6. The method of claim 1 further comprising:
selecting the advertisement based on a provider of the response and a geographic location specified by the provider.

7. The method of claim 1 further comprising:
selecting the advertisement based on a provider of the response and a category of the response specified by the provider.

8. The method of claim 1 further comprising:
ranking advertisements based a provider of the response; and
selecting a highest ranking advertisement as the advertisement.

9. The method of claim 1 further comprising:
selecting the source of the response based on a ranking of a human assistant for the request.

10. The method of claim 1 further comprising:
selecting the source of the response based on a ranking of the response among responses provided for the request.

11. The method of claim 1 further comprising:
receiving approval of human assistants from sources; and
selecting the source of the response based on a ranking of the human assistants for the request.

12. The method of claim 1 further comprising:
receiving the advertisement from the source; and
presenting the advertisement when an originator of the request accepts the response.

13. The method of claim 1 further comprising:
procuring responses for the request; and
providing the advertisement when a human assistant selects the response from a group comprising the responses.

14. The method of claim 1 further comprising:
procuring responses for the request; and
providing the advertisement when a query associated with the response matches the request.

15. The method of claim 1 further comprising:
receiving the response from a sponsor;
receiving advertisements from the sponsor; and
selecting the advertisement based on a ranking of the advertisements by the sponsor.

16. A system comprising:
a user device submitting a request; and
a search system device receiving the request, obtaining a response, selecting an advertisement based on a source of the response and providing the response and the advertisement.

17. A non-transitory computer readable storage medium storing therein an instruction for causing a computer to execute an operation, comprising:
receiving a request;
obtaining a response;
selecting an advertisement based on a source of the response; and
providing the response and the advertisement.

18. The computer readable storage medium of claim 17 wherein the operation further comprises:
ranking advertisements based on targeting information associated with the advertisements and the request;
modifying the ranking based on the source of the response; and
selecting a highest ranking advertisement as the advertisement.

19. The computer readable storage medium of claim 17 wherein the operation further comprises:
selecting a responder associated with the response;
identifying a group of which the responder is a member; and
providing the response and an identifier of the group based on the request and the responder.

20. The computer readable storage medium of claim 17 wherein the operation further comprises:
providing the identifier of the group when the request indicates a keyword.
